(19) United States
(12) Patent Application Publication
(10) Pub. No.: US 2019/0324796 A1
(43) Pub. Date: Oct. 24, 2019

(54) System And Method For Providing Real Time Redundancy For A Configurable Software Platform

(71) Applicant: n.lo Innovation, LLC, Broomfield, CO (US)

(72) Inventors: Douglas A. STANDLEY, Boulder, CO (US); Matthew R. DODGE, Dana Point, CA (US); Randall E. BYE, Louisville, CO (US); Christopher H. BRACKETT, Torrance, CA (US)

(21) Appl. No.: 16/096,815

(22) PCT Filed: May 1, 2017
(86) PCT No.: PCT/IB2017/000671

§ 371 Date: Oct. 26, 2018

Related U.S. Application Data
(60) Provisional application No. 62/329,623, filed on Apr. 29, 2016.

(51) Int. Cl. G06F 9/48; G06F 11/30; G06F 11/34

(52) U.S. Cl. CPC G06F 9/4843; G06F 11/3495; G06F 11/3024

(57) ABSTRACT

An improved system and method for providing real time redundancy for a configurable software platform are disclosed. In one example, two platforms each include a core configured to interact with an operating system of a device, a service that is run by the core, and a set of blocks that are configured to be run by the service using a defined order of execution of the blocks. The service is identical on the two platforms. Each of the sets of blocks includes a relay block that can switch between first and second states. The first state allows the blocks following the relay block in the order of execution to receive information to be processed and the second state does not allow the blocks following the relay block to receive such information. A relay block's state depends on whether the platform running the service is designated as active or passive.

### CROSS-REFERENCE TO RELATED APPLICATIONS

This application claims benefit of PCT Application No. PCT/IB2017/030423, filed on May 1, 2017, entitled “SYSTEM AND METHOD FOR PROVIDING REAL TIME REDUNDANCY FOR A CONFIGURABLE SOFTWARE PLATFORM,” which claims priority to U.S. Provisional Application No. 62/329,623, filed on Apr. 29, 2016, entitled “SYSTEM AND METHOD FOR PROVIDING REAL TIME REDUNDANCY FOR A CONFIGURABLE SOFTWARE PLATFORM,” both of which are incorporated by reference in their entirety.

### BACKGROUND

The proliferation of devices has resulted in the production of a tremendous amount of data that is continuously increasing. Current processing methods are unsuitable for processing this data. Accordingly, what is needed are systems and methods that address this issue.

### BRIEF DESCRIPTION OF THE DRAWINGS

For a more complete understanding, reference is now made to the following description taken in conjunction with the accompanying Drawings in which:

FIG. 1A illustrates one embodiment of a neutral input/output (NIO) platform with customizable and configurable processing functionality and configurable support functionality;

FIG. 1B illustrates one embodiment of a data path that may exist within a NIO platform instance based on the NIO platform of FIG. 1A;

FIGS. 1C and 1D illustrate embodiments of the NIO platform of FIG. 1A as part of a stack;

FIG. 1E illustrates one embodiment of a system on which the NIO platform of FIG. 1A may be run;

FIG. 2 illustrates a more detailed embodiment of the NIO platform of FIG. 1A;

FIG. 3A illustrates another embodiment of the NIO platform of FIG. 2;

FIG. 3B illustrates one embodiment of a NIO platform instance based on the NIO platform of FIG. 3A;

FIG. 4 illustrates one embodiment of a workflow that may be used to create and configure a NIO platform;

FIGS. 5-7 illustrate embodiments of systems formed by interconnected NIO platforms;

FIGS. 8A-8C illustrate embodiments of how a service or set of services may be distributed across multiple NIO platforms;

FIG. 9 illustrates one embodiment of NIO platforms from the system of FIG. 7 arranged in a hierarchy of a mother node, a supervisor node, and an edge node;

FIG. 10 illustrates one embodiment of a method that may be used to define and create a system of NIO platforms;

FIG. 11 illustrates another embodiment of a system formed by interconnected NIO platforms;

FIG. 12 illustrates one embodiment of the system of FIG. 11 with some of the NIO platforms grouped into communication clusters;

FIG. 13 illustrates one embodiment of a service that may be configured with various input and output blocks;

FIGS. 14-16 illustrate different embodiments of systems of NIO platforms configured with input and output blocks for communication;

FIG. 17 illustrates one embodiment of a method that may be executed to configure a service for communication;

FIG. 18 illustrates one embodiment of a method that may be executed by a NIO platform;

FIG. 19 illustrates one embodiment of a method that may be executed by a service;

FIG. 20 illustrates one embodiment of an environment in which a NIO platform may monitor one or more electrical components;

FIG. 21 illustrates one embodiment of a method that may be executed by the NIO platform of FIG. 20;

FIG. 22 illustrates one embodiment of an electrical component monitoring and actuation system that uses a single NIO platform;

FIGS. 23-25 illustrate embodiments of services that may be used by the NIO platform of FIG. 22;

FIGS. 26A and 26B illustrate an alternate embodiment of the service of FIG. 25;

FIG. 27 illustrates one embodiment of an electrical component monitoring and actuation system that uses multiple NIO platforms;

FIG. 28 illustrates one embodiment of an electrical component monitoring system that uses at least one NIO platform to monitor a power panel;

FIG. 29 illustrates one embodiment of a service that may be used by the NIO platform of FIG. 28 to monitor device metrics of a device on which the NIO platform is running;

FIGS. 30A and 30B illustrate embodiments of a GUI that may be produced using real time data obtained by the NIO platform of FIG. 28;

FIGS. 31 and 32 illustrate embodiments of an industrial environment within which one or more NIO platforms may be used;

FIG. 33 illustrates an embodiment of various components of the industrial environment of FIGS. 31 and 32 coupled to NIO platforms configured with possible services;

FIG. 34 illustrates one embodiment of an architecture that may be used within an industrial environment to deploy multiple NIO platforms;

FIG. 35 illustrates one embodiment of a method that may be executed within the industrial environment of FIG. 31;

FIG. 36 illustrates one embodiment of an environment with active and passive NIO platforms;

FIG. 37 illustrates one embodiment of the environment of FIG. 36;

FIG. 38 illustrates one embodiment of a relay block that may be used within the environment of FIG. 36;

FIGS. 39-41 illustrate embodiments of the environment of FIG. 36;

FIGS. 42A-42D illustrate embodiments of services having a relay block placed in different positions;

FIG. 43A illustrates an embodiment of the environment of FIG. 36;

FIG. 43B illustrates an alternate embodiment of the environment of FIG. 36 with the supervisor node removed;

FIGS. 44-47 illustrate embodiments of sequence diagrams showing processes that may be executed within the environment of FIG. 36;

FIGS. 48 and 49 illustrate embodiments of sequence diagrams showing processes that may be executed within the environment of FIG. 43B;

FIGS. 50-52 illustrate embodiments of methods that may be executed within the environments of FIGS. 36 and 43B; and

FIG. 53 illustrates one embodiment of a method that may be used with the environments of FIGS. 36 and 43B.

### DETAILED DESCRIPTION

The present disclosure is directed to a system and method for providing real time redundancy for a configurable software platform. It is understood that the following disclosure provides many different embodiments or examples. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

This application refers to U.S. patent application Ser. No. 14/885,629, filed on Oct. 16, 2015, and entitled SYSTEM AND METHOD FOR FULLY CONFIGURABLE REAL TIME PROCESSING, which is a continuation of PCT/IB2015/001288, filed on May 21, 2015, both of which are incorporated by reference in their entirety.

The present disclosure describes various embodiments of a neutral input/output (NIO) platform that includes a core that supports one or more services. While the platform itself may technically be viewed as an executable application in some embodiments, the core may be thought of as an application engine that runs task specific applications called services. The services are constructed using defined templates that are recognized by the core, although the templates can be customized to a certain extent. The core is designed to manage and support the services, and the services in turn manage blocks that provide processing functionality to their respective service. Due to the structure and flexibility of the runtime environment provided by the NIO platform's core, services, and blocks, the platform is able to asynchronously process any input signal from one or more sources in real time.

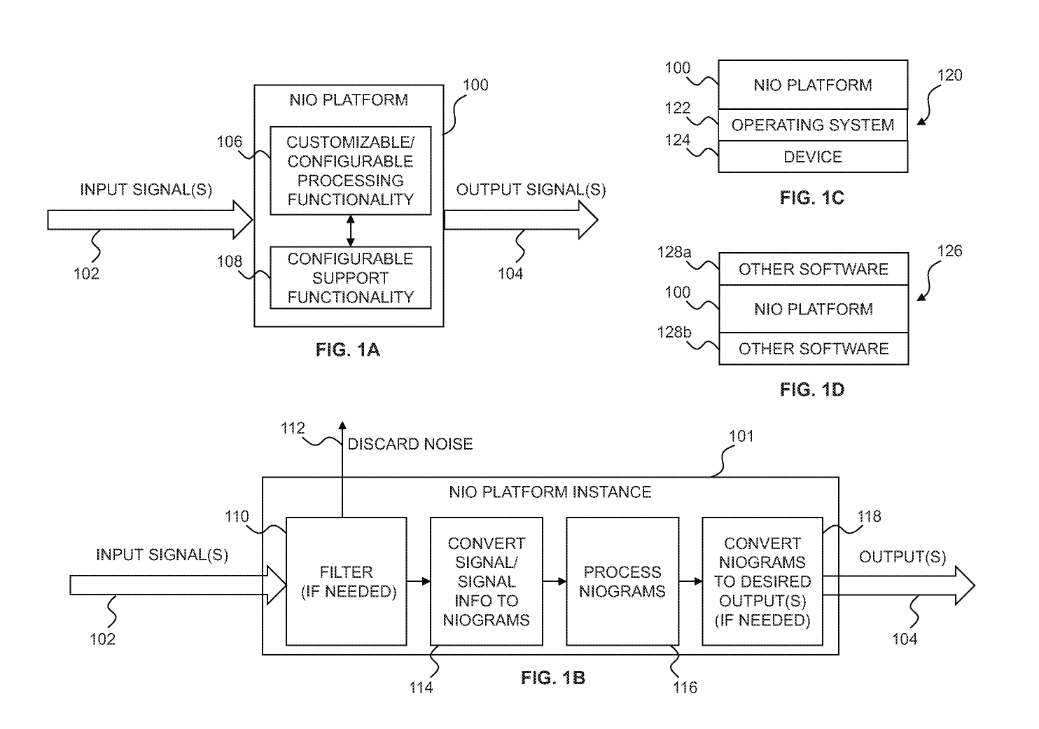

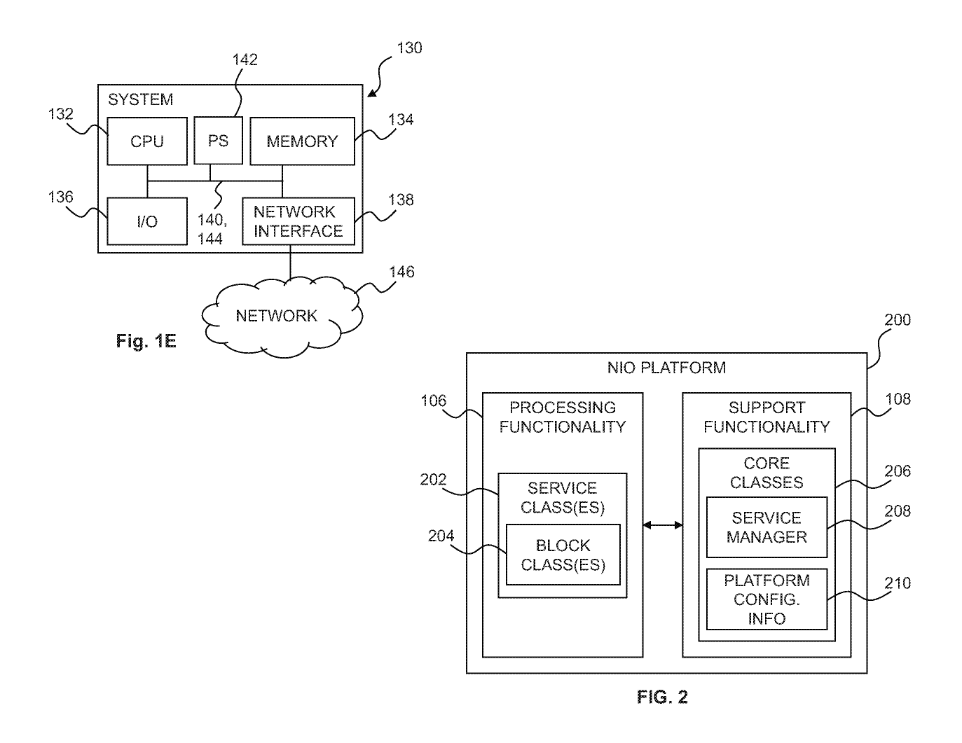

Referring to FIG. 1A, one embodiment of a NIO platform 100 is illustrated. The NIO platform 100 is configurable to receive any type of signal (including data) as input, process those signals, and produce any type of output. The NIO platform 100 is able to support this process of receiving, processing, and producing in real time or near real time. The input signals can be streaming or any other type of continuous or non-continuous input.

When referring to the NIO platform 100 as performing processing in real time and near real time, it means that there is no storage other than possible queuing between the NIO platform instance's input and output. In other words, only processing time exists between the NIO platform instance's input and output as there is no storage read and write time, even for streaming data entering the NIO platform 100.

It is noted that this means there is no way to recover an original signal that has entered the NIO platform 100 and been processed unless the original signal is part of the output or the NIO platform 100 has been configured to save the original signal. The original signal is received by the NIO platform 100, processed (which may involve changing and/or destroying the original signal), and output is generated. The receipt, processing, and generation of output occurs without any storage other than possible queuing. The original signal is not stored and deleted, it is simply never stored. The original signal generally becomes irrelevant as it is the output based on the original signal that is important, although the output may contain some or all of the original signal. The original signal may be available elsewhere (e.g., at the original signal's source), but it may not be recoverable from the NIO platform 100.

It is understood that the NIO platform 100 can be configured to store the original signal at receipt or during processing, but that is separate from the NIO platform's ability to perform real time and near real time processing. For example, although no long term (e.g., longer than any necessary buffering) memory storage is needed by the NIO platform 100 during real time and near real time processing, storage to and retrieval from memory (e.g., a hard drive, a removable memory, and/or a remote memory) is supported if required for particular applications.

The internal operation of the NIO platform 100 uses a NIO data object (referred to herein as a niogram). Incoming signals 102 are converted into niograms at the edge of the NIO platform 100 and used in intra-platform communications and processing. This allows the NIO platform 100 to handle any type of input signal without needing changes to the platform's core functionality. In embodiments where multiple NIO platforms are deployed, niograms may be used in inter-platform communications.

The use of niograms allows the core functionality of the NIO platform 100 to operate in a standardized manner regardless of the specific type of information contained in the niograms. From a general system perspective, the same core operations are executed in the same way regardless of the input data type. This means that the NIO platform 100 can be optimized for the niogram, which may itself be optimized for a particular type of input for a specific application.

The NIO platform 100 is designed to process niograms in a customizable and configurable manner using processing functionality 106 and support functionality 108. The processing functionality 106 is generally both customizable and configurable by a user. Customizable means that at least a portion of the source code providing the processing functionality 106 can be modified by a user. In other words, the task specific software instructions that determine how an input signal that has been converted into one or more niograms will be processed can be directly accessed at the code level and modified. Configurable means that the processing functionality 106 can be modified by such actions as selecting or deselecting functionality and/or defining values for configuration parameters. These modifications do not require direct access or changes to the underlying source code and may be performed at different times (e.g., before runtime or at runtime) using configuration files, commands issued through an interface, and/or in other defined ways.

The support functionality 108 is generally only configurable by a user, with modifications limited to such actions as selecting or deselecting functionality and/or defining values for configuration parameters. In other embodiments, the support functionality 108 may also be customizable. It is understood that the ability to modify the processing functionality 106 and/or the support functionality 108 may be limited or non-existent in some embodiments.

The support functionality 108 supports the processing functionality 106 by handling general configuration of the NIO platform 100 at runtime and providing management functions for starting and stopping the processing functionality. The resulting niograms can be converted into any signal type(s) for output(s) 104.

Referring to FIG. 1B, one embodiment of a NIO platform instance 101 illustrates a data path that starts when the input signal(s) 102 are received and continues through the generation of the output(s) 104. The NIO platform instance 101 is created when the NIO platform 100 of FIG. 1A is launched. A NIO platform may be referred to herein as a “NIO platform” before being launched and as a “NIO platform instance” after being launched, although the terms may be used interchangeably for the NIO platform after launch. As described above, niograms are used internally by the NIO platform instance 101 along the data path.

In the present example, the input signal(s) 102 may be filtered in block 110 to remove noise, which can include irrelevant data, undesirable characteristics in a signal (e.g., ambient noise or interference), and/or any other unwanted part of an input signal. Filtered noise may be discarded at the edge of the NIO platform instance 101 (as indicated by arrow 112) and not introduced into the more complex processing functionality of the NIO platform instance 101. The filtering may also be used to discard some of the signal's information while keeping other information from the signal. The filtering saves processing time because core functionality of the NIO platform instance 101 can be focused on relevant data having a known structure for post-filtering processing. In embodiments where the entire input signal is processed, such filtering may not occur. In addition to or as alternative to filtering occurring at the edge, filtering may occur inside the NIO platform instance 101 after the signal is converted to a niogram.

Non-discarded signals and/or the remaining signal information are converted into niograms for internal use in block 114 and the niograms are processed in block 116. The niograms may be converted into one or more other formats for the output(s) 104 in block 118, including actions (e.g., actuation signals). In embodiments where niograms are the output, the conversion step of block 118 would not occur.

Referring to FIG. 1C, one embodiment of a stack 120 is illustrated. In the present example, the NIO platform 100 interacts with an operating system (OS) 122 that in turn interacts with a device 124. The interaction may be direct or may be through one or more other layers, such as an interpreter or a virtual machine. The device 124 can be a virtual device or a physical device, and may be standalone or coupled to a network.

Referring to FIG. 1D, another embodiment of a stack 126 is illustrated. In the present example, the NIO platform 100 interacts with a higher layer of software 128a and/or a lower layer of software 128b. In other words, the NIO platform 100 may provide part of the functionality of the stack 126, while the software layers 128a and/or 128b provide other parts of the stack's functionality. Although not shown, it is understood that the OS 122 and device 124 of FIG. 1C may be positioned under the software layer 128b if the software 128b is present or directly under the NIO platform 100 (as in FIG. 1C) if the software layer 128b is not present.

Referring to FIG. 1E, one embodiment of a system 130 is illustrated. The system 130 is one possible example of a portion or all of the device 124 of FIG. 1C. The system 130 may include a controller (e.g., a processor/central processing unit (“CPU”)) 132, a memory unit 134, an input/output (“I/O”) device 136, and a network interface 138. The components 132, 134, 136, and 138 are interconnected by a data transport system (e.g., a bus) 140. A power supply (PS) 142 may provide power to components of the system 130 via a power transport system 144 (shown with data transport system 140, although the power and data transport systems may be separate).

It is understood that the system 130 may be differently configured and that each of the listed components may actually represent several different components. For example, the CPU 132 may actually represent a multi-processor or a distributed processing system; the memory unit 134 may include different levels of cache memory, main memory, hard disks, and remote storage locations; the I/O device 136 may include monitors, keyboards, and the like; and the network interface 138 may include one or more network cards providing one or more wired and/or wireless connections to a network 146. Therefore, a wide range of flexibility is anticipated in the configuration of the system 130, which may range from a single physical platform configured primarily for a single user or autonomous operation to a distributed multi-user platform such as a cloud computing system.

The system 130 may use any operating system (or multiple operating systems), including various versions of operating systems provided by Microsoft (such as WINDOWS), Apple (such as Mac OS X), UNIX, and LINUX, and may include operating systems specifically developed for handheld devices (e.g., iOS, Android, Blackberry, and/or Windows Phone), personal computers, servers, and other computing platforms depending on the use of the system 130. The operating system, as well as other instructions (e.g., for telecommunications and/or other functions provided by the device 124), may be stored in the memory unit 134 and executed by the processor 132. For example, if the system 130 is the device 124, the memory unit 134 may include instructions for providing the NIO platform 100 and for performing some or all of the methods described herein.

The network 146 may be a single network or may represent multiple networks, including networks of different types, whether wireless or wireline. For example, the device 124 may be coupled to external devices via a network that includes a cellular link coupled to a data packet network, or may be coupled via a data packet link such as a wide local area network (WLAN) coupled to a data packet network or a Public Switched Telephone Network (PSTN). Accordingly, many different network types and configurations may be used to couple the device 124 with external devices.

Referring to FIG. 2, a NIO platform 200 illustrates a more detailed embodiment of the NIO platform 100 of FIG. 1A. In the present example, the NIO platform 200 includes two main components: service classes 202 for one or more services that are to provide the configurable processing functionality 106 and core classes 206 for a core that is to provide the support functionality 108 for the services. Each service corresponds to block classes 204 for one or more blocks that contain defined task specific functionality for processing niograms. The core includes a service manager 208 that will manage the services (e.g., starting and stopping a service) and platform configuration information 210 that defines how the NIO platform 200 is to be configured, such as what services are available when the instance is launched.

When the NIO platform 200 is launched, a core and the corresponding services form a single instance of the NIO platform 200. It is understood that multiple concurrent instances of the NIO platform 200 can run on a single device (e.g., the device 124 of FIG. 1C). Each NIO platform instance has its own core and services. The most basic NIO platform instance is a core with no services. The functionality provided by the core would exist, but there would be no services on which the functionality could operate. Because the processing functionality of a NIO platform instance is defined by the executable code present in the blocks and the services are configured as collections of one or more blocks, a single service containing a single block is the minimum configuration required for any processing of a niogram to occur.

It is understood that FIG. 2 illustrates the relationship between the various classes and other components. For example, the block classes are not actually part of the service classes, but the blocks are related to the services. Furthermore, while the service manager is considered to be part of the core for purposes of this example (and so created using the core classes), the core configuration information is not part of the core classes but is used to configure the core and other parts of the NIO platform 200.

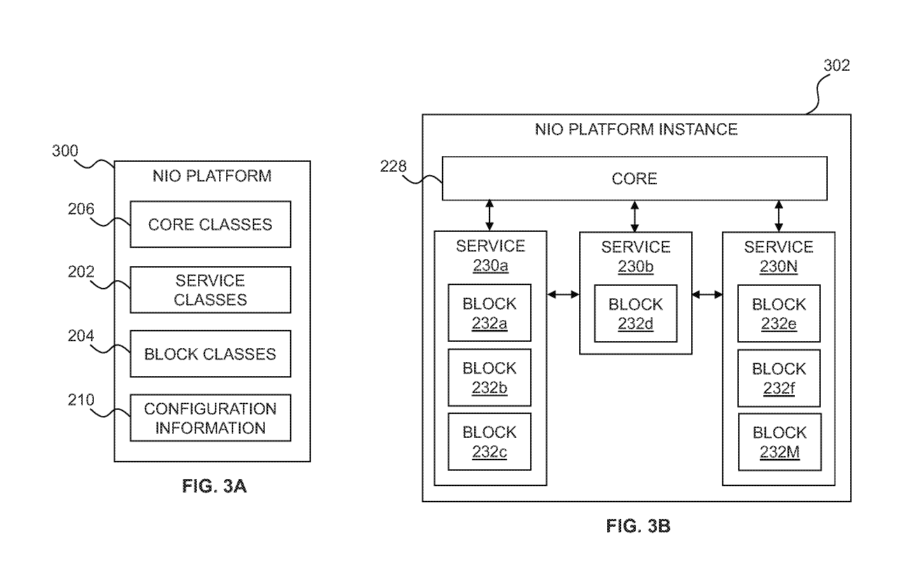

With additional reference to FIGS. 3A and 3B, another embodiment of the NIO platform 200 of FIG. 2 is illustrated as a NIO platform 300 prior to being launched (FIG. 3A) and as a NIO platform instance 302 after being launched (FIG. 3B). FIG. 3A illustrates the NIO platform 300 with core classes 206, service classes 202, block classes 204, and configuration information 210 that are used to create and configure a core 228, services 230a-230N, and blocks 232a-232M of the NIO platform instance 302. It is understood that, although not shown in FIG. 3B, the core classes 206, service classes 202, block classes 204, and configuration information 210 generally continue to exist as part of the NIO platform instance 402.

Referring specifically to FIG. 3B, the NIO platform instance 302 may be viewed as a runtime environment within which the core 228 creates and runs the services 230a, 230b, . . . , and 230N. Each service 230a-230N may have a different number of blocks. For example, service 230a includes blocks 232a, 232b, and 232c. Service 230b includes a single block 232d. Service 230N includes blocks 232e, 232f, . . . , and 232M.

One or more of the services 230a-230N may be stopped or started by the core 228. When stopped, the functionality provided by that service will not be available until the service is started by the core 228. Communication may occur between the core 228 and the services 230a-230N, as well as between the services 230a-230N themselves.

In the present example, the core 228 and each service 230a-230N is a separate process from an operating system/hardware perspective. Accordingly, the NIO platform instance 302 of FIG. 3B would have N+1 processes running, and the operating system may distribute those across multi-core devices as with any other processes. It is understood that the configuration of particular services may depend in part on a design decision that takes into account the number of processes that will be created. For example, it may be desirable from a process standpoint to have numerous but smaller services in some embodiments, while it may be desirable to have fewer but larger services in other embodiments. The configurability of the NIO platform 300 enables such decisions to be implemented relatively easily by modifying the functionality of each service 230a-230N.

In other embodiments, the NIO platform instance 302 may be structured to run the core 228 and/or services 230a-230N as threads rather than processes. For example, the core 228 may be a process and the services 230a-230N may run as threads of the core process.

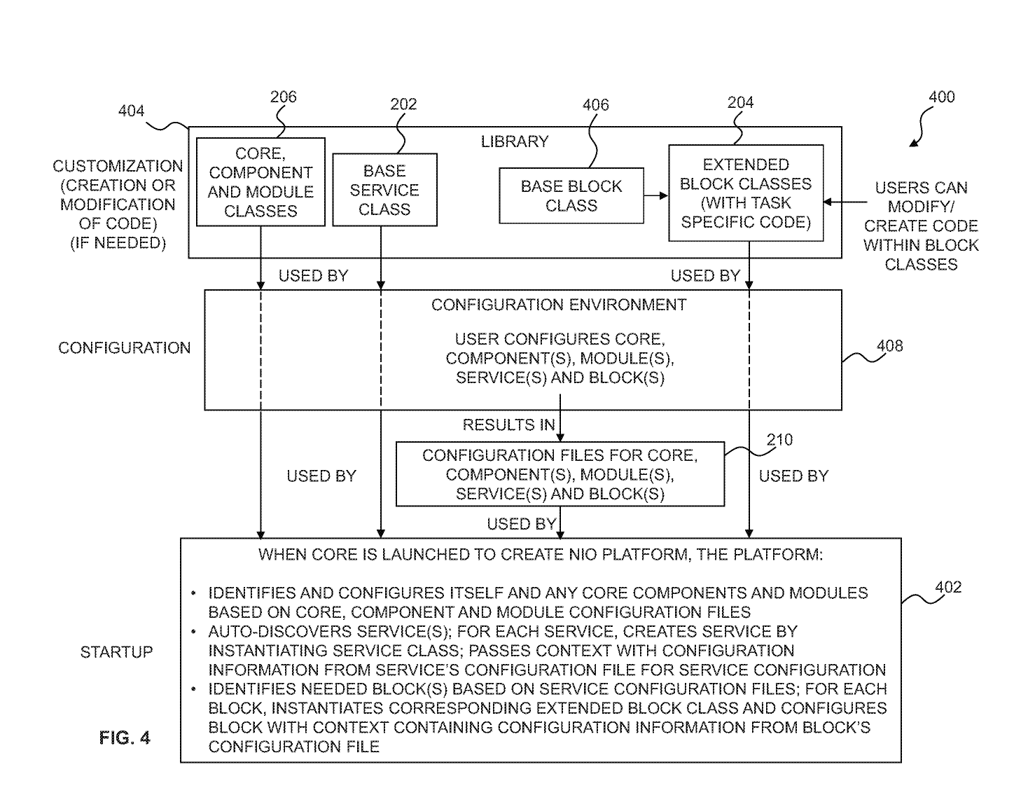

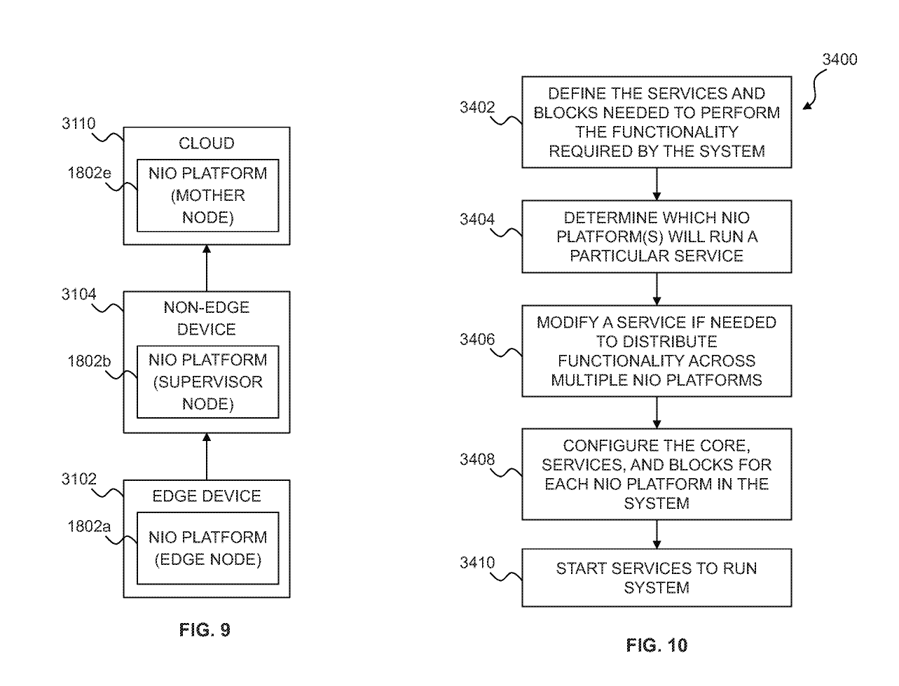

Referring to FIG. 4, a diagram 400 illustrates one embodiment of a workflow that runs from creation to launch of a NIO platform 402 (which may be similar or identical to the NIO platform 100 of FIG. 1A, 200 of FIG. 2A, 400 of FIG. 4A, and/or 900 of FIGS. 9A and 9B). The workflow begins with a library 404. The library 404 includes core classes 206 (that include the classes for any core components and modules in the present example), a base service class 202, a base block class 406, and block classes 204 that are extended from the base block class 406. Each extended block class 204 includes task specific code. A user can modify and/or create code for existing blocks classes 204 in the library 404 and/or create new block classes 204 with desired task specific functionality. Although not shown, the base service class 202 can also be customized and various extended service classes may exist in the library 404.

The configuration environment 408 enables a user to define configurations for the core classes 206, the service class 202, and the block classes 204 that have been selected from the library 404 in order to define the platform specific behavior of the objects that will be instantiated from the classes within the NIO platform 402. The NIO platform 402 will run the objects as defined by the architecture of the platform itself, but the configuration process enables the user to define various task specific operational aspects of the NIO platform 402. The operational aspects include which core components, modules, services and blocks will be run, what properties the core components, modules, services and blocks will have (as permitted by the architecture), and when the services will be run. This configuration process results in configuration files 210 that are used to configure the objects that will be instantiated from the core classes 206, the service class 202, and the block classes 204 by the NIO platform 402.

In some embodiments, the configuration environment 408 may be a graphical user interface environment that produces configuration files that are loaded into the NIO platform 402. In other embodiments, the configuration environment 408 may use a REST interface (such as the REST interface 908, 964 disclosed in FIGS. 9A and 9B of previously incorporated U.S. patent application Ser. No. 14/885,629) of the NIO platform 402 to issue configuration commands to the NIO platform 402. Accordingly, it is understood that there are various ways in which configuration information may be created and produced for use by the NIO platform 402.

When the NIO platform 402 is launched, each of the core classes 206 are identified and corresponding objects are instantiated and configured using the appropriate configuration files 210 for the core, core components, and modules. For each service that is to be run when the NIO platform 402 is started, the service class 202 and corresponding block classes 204 are identified and the services and blocks are instantiated and configured using the appropriate configuration files 210. The NIO platform 402 is then configured and begins running to perform the task specific functions provided by the services.

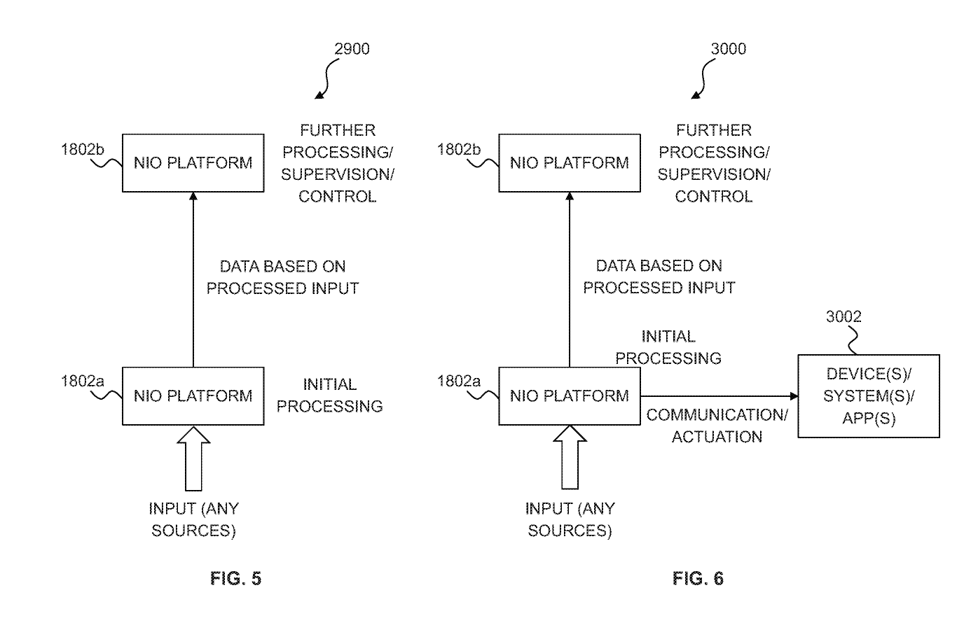

Referring to FIG. 5, one embodiment of a system 2900 illustrates two NIO platforms 1802a and 1802b organized in a tiered or hierarchical arrangement within which real time processing can be performed. Within the system 2900, the NIO platform 1802a feeds into the NIO platform 1802b. Although not shown, it is understood that the communications may be two way, with each of the NIO platforms 1802a and 1802b sending information (e.g., data and/or commands) to and receiving information from the other of the NIO platforms. For purposes of example, the NIO platform 1802a is on an edge device for the system 2900 and the NIO platform 1802b is not on an edge device.

As described in previous embodiments, each NIO platform 1802a and 1802b uses the same basic core 228, but can be configured with different core components 912, modules 904, and/or services 230 with corresponding blocks 232. This configurability enables the NIO platform to serve as a single platform solution for the system 2900 while supporting highly flexible distribution of the system's processing capabilities. For example, depending on which of the NIO platforms 1802a and 1802b is selected to run a particular service, particular processing functionality in the system 2900 can be moved out to the edge or moved away from the edge as desired. Accordingly, the NIO platform can be used in multiple locations of the system 2900 and the functionality of a particular one of the NIO platforms within the system 2900 can be configured as desired.

By deploying the NIO platform 1802a on an edge device, the fully configurable processing provided by the NIO platform 1802a can be used to reduce and/or eliminate the need to transfer data for decision making to another device (e.g., a device on which the NIO platform 1802b is running). This not only reduces network traffic, but also means that decisions can be made more quickly as the NIO platform 1802a operating at the edge can be configured to make decisions and act on those decisions without the additional temporal overhead that would be required for the round trip transmission time that would be imposed by communications with the NIO platform 1802b located on another device. If needed or desired, data can be transferred away from the edge and deeper into the system 2900.

The configurability of the NIO platforms 1802a and 1802b in the system 2900 may reduce and/or eliminate the need for customized hardware and/or software needed for particular tasks. The development of such hardware/software is often an expensive and time consuming task, and the development cycle may have to be repeated for each particular device that is to be integrated into or coupled to the system 2900. For example, a particular server application may need to interact with different interfaces and/or different operating system running on different devices, and so multiple versions of the same software may be created.

In contrast, because the NIO platform can be configured as desired, adapting a particular service to another interface may be as simple as exchanging one block for another block and setting some configuration values. Furthermore, even though the services can be completely different on different NIO platforms, the use of a standard interface across the NIO platforms provides a consistent environment to users regardless of the services to be run. This enables a user familiar with the interface to configure a NIO platform for its particular task or tasks relatively easily.

Furthermore, because blocks can be reused and existing blocks can be modified, creating a service for a particular task may leverage existing assets. If new blocks are created, they can be used in other instances of the NIO platform. Therefore, each deployment of a particular configuration of the NIO platform 1802 may result in a larger library of blocks, which in turn may lessen the amount of effort required for the next deployment. This is particularly true in cases where the next deployment has substantial similarities to the current deployment, such as deployments in different locations that perform similar or identical operations (e.g., manufacturing or agriculture operations).

Accordingly, the NIO platform 1802a receives external input that may be any type(s) of input for which the NIO platform 1802a is configured. The external input comes from one or more external devices, systems, and/or applications (not shown). As the NIO platform 1802a is an edge device in the present example, the input will not be exclusively from another NIO platform, although some of the input may be from another NIO platform. The NIO platform 1802a processes the input and then passes data based on the processed input to the NIO platform 1802b. Depending on the configuration of the NIO platform 1802a, the processing can range from simple (e.g., simply inserting the input into a niogram for forwarding) to complex (e.g., executing multiple related services with complex instructions). The NIO platform 1802b can then perform further processing if needed.

This tiered system enables the NIO platform 1802a to perform its functions at the point of input into the system 2900, rather than having to pass the input to the NIO platform 1802b for processing. When the NIO platform 1802a is located on an edge device, this means that the input can be processed at the edge based on the particular configuration of the NIO platform 1802a.

Referring to FIG. 6, one embodiment of a system 3000 illustrates the two NIO platforms 1802a and 1802b of FIG. 5 and one or more devices, systems, and/or applications 3002. As described with respect to FIG. 5, the NIO platforms 1802a and 1802b are organized in a tiered arrangement. As shown, the NIO platform 1802a is an edge device and can directly actuate the device 3002. This means that the processing performed on the input at the edge, which may include input from the device 3002, can be used to actuate the device 3002 or another device, system, or application. By configuring the services 230 on the NIO platform 1802a to handle whatever logic may be desired with respect to the device 3002, the actuation of the device 3002 directly from the NIO platform 1802a can occur in real time without introducing additional transmission time.

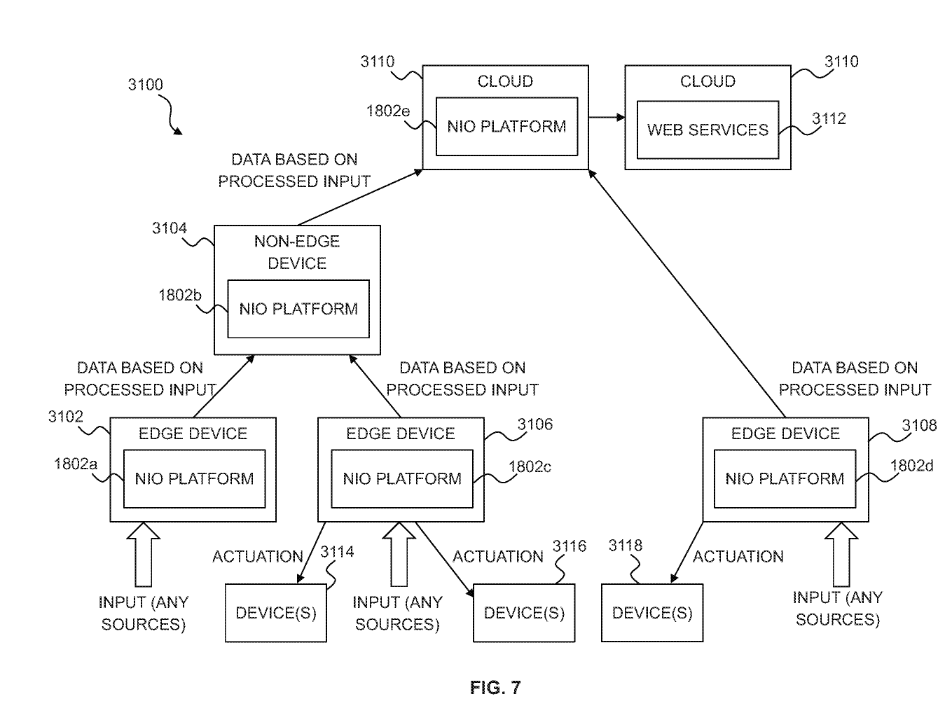

Referring to FIG. 7, one embodiment of a system 3100 illustrates the two NIO platforms 1802a and 1802b of FIG. 5. The system 3100 also includes additional NIO platforms 1802c, 1802d, and 1802e. The NIO platforms 1802a, 1802c, and 1802d are running on edge devices 3102, 3106, and 3108, respectively. The NIO platform 1802b is running on a non-edge device 3104. The NIO platform 1802e is running on a server/distributed server system (e.g., a cloud) 3110.

The system 3100 further includes devices 3114, 3116, and 3118 (which may represent one or more devices, systems, and/or applications as shown in FIG. 6), as well as web services 3112 running in the cloud, although these components may not be included in the system itself in embodiments where the NIO platforms are viewed as the system. In some embodiments, some or all of the web services 3112 may be provided by the NIO platform 1802e, while in other embodiments the web services 3112 may be separate from the NIO platform 1802e.

For purposes of example, the NIO platforms 1802a, 1802c, and 1802d are referred to as being located on edge devices. More specifically, any NIO platform in the present example that is positioned to directly interface with a device other than a NIO platform is referred to as an edge platform or running on an edge device, while any NIO platform that only interfaces with other NIO platforms or the web services 3112 for output is not an edge platform. Although not shown, it is understood that multiple instances of the NIO platform may be run on a single device. For example, the NIO platforms 1802a and 1802c may be run on one device, rather than on the two devices 3102 and 3106.

The NIO platforms 1802a and 1802c are configured to receive input from any source(s), process the input, and pass data based on the input to the NIO platform 1802b. The NIO platform 1802b is configured to process the received input and pass data based on the input to the NIO platform 1802e. The NIO platform 1802d is configured to receive input from any source(s), process the input, and pass data based on the input to the NIO platform 1802e. The NIO platform 1802e is configured to process the input and pass data based on the input to the web services 3112 for output as a message (e.g., an email, SMS, or voice message), to a display, a database, and/or any other destination. It is understood that additional NIO platforms may be present in the system 3100.

The arrows representing communication illustrate the general flow of data “up” through the tiers of the system 2900 and “down” to the devices 3114, 3116, and 3118 for actuation purposes. However, although the communications are illustrated as one way, it is understood that two way communications are likely to occur. For example, the NIO platforms will likely communicate with the NIO platforms at lower levels (e.g., the NIO platform 1802e with the NIO platform 1802b), and such communications may include configuration changes to the core 228, services 230, or blocks 232 of a particular NIO platform, commands to perform certain actions, actuation commands to be passed through to one of the devices 3114, 3116, or 3118, and/or requests for data. Accordingly, depending on how the NIO platforms 1802a-1802e are configured and the capabilities of the devices on which the NIO platforms 1802a-1802e are running, the communications used with the system 3100 may range from the simple to the complex.

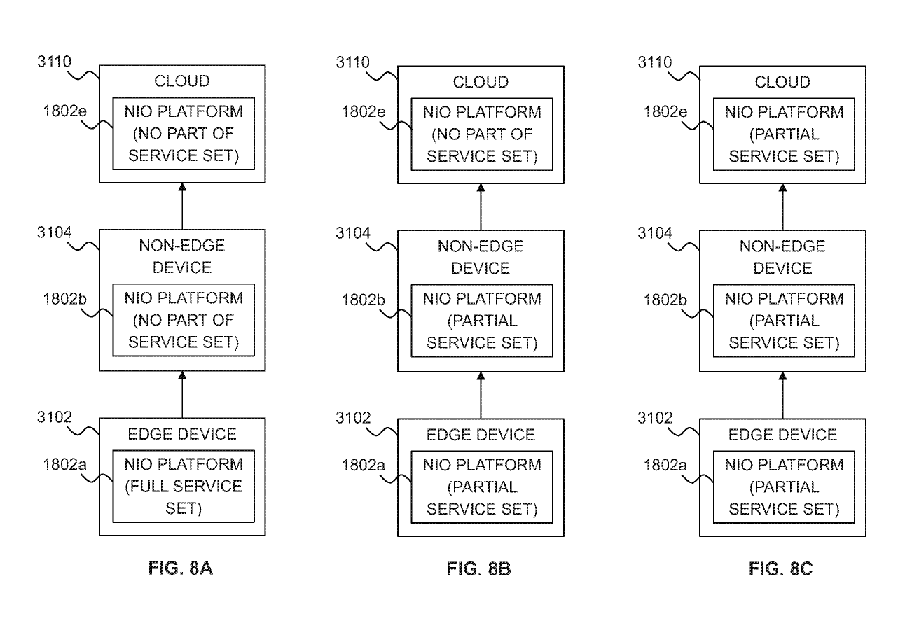

FIGS. 8A-8C illustrate embodiments of how a set of services 230 may be assigned to a single NIO platform or distributed among multiple NIO platforms. One advantage provided by using multiple instances of a single configurable platform to form a system such as the system 3100 of FIG. 7 is that the system's functionality may be distributed relatively easily in many different ways simply by configuring the various NIO platforms as desired. It is understood that the service set may actually be a single service, but will often include multiple services that work together to accomplish a particular task. Accordingly, the following examples apply equally to a single service that can be divided into multiple services. The NIO platforms 1802a, 1802b, and 1802e of FIG. 7 are used for purposes of example, with the set of services being responsible for receiving the input, performing defined processing tasks, and then producing a final output.

Referring specifically to FIG. 8A, the entire set of services is located on the NIO platform 1802a. In this embodiment, the NIO platform 1802a performs all the functions of receiving the input, performing the defined processing tasks, and producing the final output. The final output may include sending an actuation signal to a device, sending data to the NIO platform 1802b, or waiting for additional input (e.g., not sending anything out).

Referring specifically to FIG. 8B, the set of services is divided between the NIO platform 1802a and the NIO platform 1802b. In this embodiment, the NIO platform 1802a would be responsible for receiving input. The functions of performing the defined processing tasks and producing the final output may be split between the NIO platforms 1802a and 1802b in many different ways. For example, the NIO platform 1802a may perform part of the processing and send data to the NIO platform 1802b. The NIO platform 1802b may then perform additional processing and produce the final output.

In another example, the NIO platform 1802a would be responsible for receiving input and would simply forward the input data to the NIO platform 1802b. The NIO platform 1802b would then perform the defined processing tasks and produce the final output. In yet another example, the NIO platform 1802a would be responsible for receiving input and would forward the input data to the NIO platform 1802b. The NIO platform 1802b would then perform the defined processing tasks and send the processed data back to the NIO platform 1802a, which would produce the final output.

Referring specifically to FIG. 8C, the set of services is divided among the NIO platform 1802a, the NIO platform 1802b, and the NIO platform 1802e. In this embodiment, the NIO platform 1802a would be responsible for receiving input. The functions of performing the defined processing tasks and producing the final output may be split among the NIO platforms 1802a, 1802b, and 1802e in many different ways. For example, the NIO platform 1802a may perform part of the processing and send data to the NIO platform 1802b. The NIO platform 1802b may then perform additional processing and send the processed data to the NIO platform 1802e. The NIO platform 1802e may perform additional processing and produce the final output or may simply produce the final output with minimal processing.

In another example, the NIO platform 1802a would be responsible for receiving input and would forward the input data to the NIO platform 1802b. The NIO platform 1802b may be configured to process the data and then send the processed data to the NIO platform 1802e for the final output. In yet another example, the NIO platform 1802a would be responsible for receiving the input and performing initial processing, and would then send the processed data to the NIO platform 1802b. The NIO platform 1802b may be configured to simply pass the received data on to the NIO platform 1802e for further processing and the final output. It is understood that the final output may be produced by any of the NIO platforms 1802a, 1802b, and 1802e and sent to any of the other NIO platforms.

Accordingly, as illustrated by FIGS. 8A-8C, the use of the NIO platform in a multi-tiered arrangement enables services to be distributed as desired. For example, the device 3102 on which the NIO platform 1802a is running may have limited processing resources available (e.g., the device 3102 may have limited CPU and/or memory resources), while the device 3104 may have considerably more processing resources. In such an embodiment, the services may be divided so as much processing as possible is performed on the device 3102, and the remainder is moved to the device 3104. In another example, the device 3102 may be capable of performing all the needed processing, and so may be configured to provide all of the processing and the final output.

The interchangeability of the NIO platforms, where a primary NIO platform can be replaced by a backup NIO platform with the same configuration, also makes the provision of failover or backup platforms relatively simple. For example, referring again to FIG. 7, the NIO platform 1802a may be a backup or failover platform for the NIO platform 1802c. In this example, the NIO platform 1802a may not have any inputs or may have the exact same inputs as the NIO platform 1802c. The NIO platform 1802a or the NIO platform 1802b would monitor the NIO platform 1802c and, if the NIO platform 1802c fails or becomes unresponsive, the NIO platform 1802a would take over some or all of the functionality provided by the NIO platform 1802c.

In another example, the NIO platform 1802a may aid the NIO platform 1802c if the NIO platform 1802c receives an input data surge that it is unable to handle with its current processing capabilities. The NIO platform 1802a would handle the overflow processing in such cases. Once the surge subsides, the NIO platform 1802c would no longer need help handling the overflow processing and the NIO platform 1802a could return to a standby mode.

In another example, the NIO platform 1802a may be configured to run services that are also configured to be run on multiple other NIO platforms. This enables the single NIO platform 1802a to aid different NIO platforms as the need arises. For example, the NIO platform 1802a may be running on a relatively powerful device that matches the processing resources of the other devices on the NIO platforms are running, which in turn enables the NIO platform 1802a to aid multiple other NIO platforms simultaneously. This allows a relatively powerful device to be used to run a backup, failover, and/or overflow NIO platform for multiple other NIO platforms. As the NIO platform 1802a can be configured with whatever services are desired, this provides a very flexible solution that can be easily reconfigured to match changes in the configurations of the other NIO platforms and ensure continued support.

Referring to FIG. 9 and with continued reference to FIG. 7, one embodiment of the system 3100 organizes the various NIO platforms 1802a-1802e in an arrangement of edge nodes, a supervisor node, and a mother node. In this example, the NIO platforms 1802a, 1802c, and 1802d are edge nodes, the NIO platform 1802b is a supervisor node, and the NIO platform 1802e is a mother node. This hierarchy is shown in FIG. 9 for the NIO platforms 1802a, 1802b, and 1802e.

For purposes of example, the edge nodes provided by the NIO platforms 1802a, 1802c, and 1802d are distributed around a manufacturing facility. The NIO platforms 1802a, 1802c, and 1802d connect to sensors, process all sensor data, and perform any local actuations (e.g., turning an LED on or off, or actuating a motor). The edge nodes are generally located out in the facility and so may be distributed based on logical locations for edge nodes within that facility.

The supervisor node provided by the NIO platform 1802b monitors some or all of the edge nodes (only the NIO platforms 1802a and 1802c in FIG. 7) and their services. The NIO platform 1802b detects when a primary node goes down and commands a backup node to take over. The supervisor node may also aggregate data from the NIO platforms being supervised, as well as make decisions that require data from multiple NIO platforms. The supervisor node may also handle any internet actuations (e.g., publish to a socket or save data to a cloud or local database). In some embodiments, the supervisor node may perform its actuations directly, while in other embodiments the supervisor node may perform its actuations via the mother node. The supervisor node may be located in different places, such as on a server local to the manufacturing facility or in the cloud.

The mother node provided by the NIO platform 1802e monitors external access to the supervisor node and monitors that the supervisor node is running. The mother node is generally located in the cloud, although on site placement is also possible.

This arrangement of NIO platforms enables the formation of tiered systems where higher level NIO platforms can monitor lower level NIO platforms. The lowest level NIO platforms are edge nodes that interface with the devices, systems, and/or applications that are outside of the NIO platform network. Adding additional tiers of NIO platforms may enable the control structure to be extended with additional granularity. It is understood that the processing described in the preceding examples, as well as the communications between NIO platforms, may occur in real time. A real time system created using NIO platforms arranged in a tiered fashion as described herein is highly adaptable.

Referring to FIG. 10, a method 3400 illustrates one embodiment of a process that may be executed to create a system of NIO platforms, such as the system 3100 of FIG. 7. It is understood that the method 3400 may be executed over a period of time and may be iterative in nature, with steps being repeated as needed until the overall method has been performed.

In step 3402, the services 230 and blocks 232 that are needed to perform the system's functionality are defined. The particular services 230 and blocks 232 may vary widely across different systems due to the various requirements of a particular system. For example, a system for process control in a manufacturing facility will have very different requirements compared to an agricultural control system or a point of sale/inventory system. While many systems will have similar high level requirements (e.g., the need for real time processing, communication, and actuation) and will use the same basic NIO platform architecture to meet those requirements, the particular services 230 and blocks 232 will likely be significantly different for each system.

In step 3404, a determination is made as to which NIO platform in the system 3100 will run a particular service. This step may include an analysis of the processing capabilities of various devices on which the NIO platforms are to be run. This allows the services 230 to be distributed to take advantage of available processing resources. Alternatively, devices may be selected for particular NIO platforms based on the processing requirements imposed by the services 230 assigned to that particular NIO platform. Accordingly, step 3404 may be approached in different ways depending on such factors as whether the devices to be used can be selected or whether already installed devices must be used.

In step 3406, one or more of the services 230 may be modified if needed. For example, if a service 230 defined in step 3402 would be more efficient if distributed across multiple NIO platforms or if the service 230 as originally designed is too resource intensive for a particular device, the service 230 may be redesigned as multiple separate but connected services. Step 3406 may be omitted if not needed. In step 3408, the core 228, services 230, and blocks 232 for each NIO platform within the system 3100 are configured. In step 3410, the service 230 are started to run the system 3100.

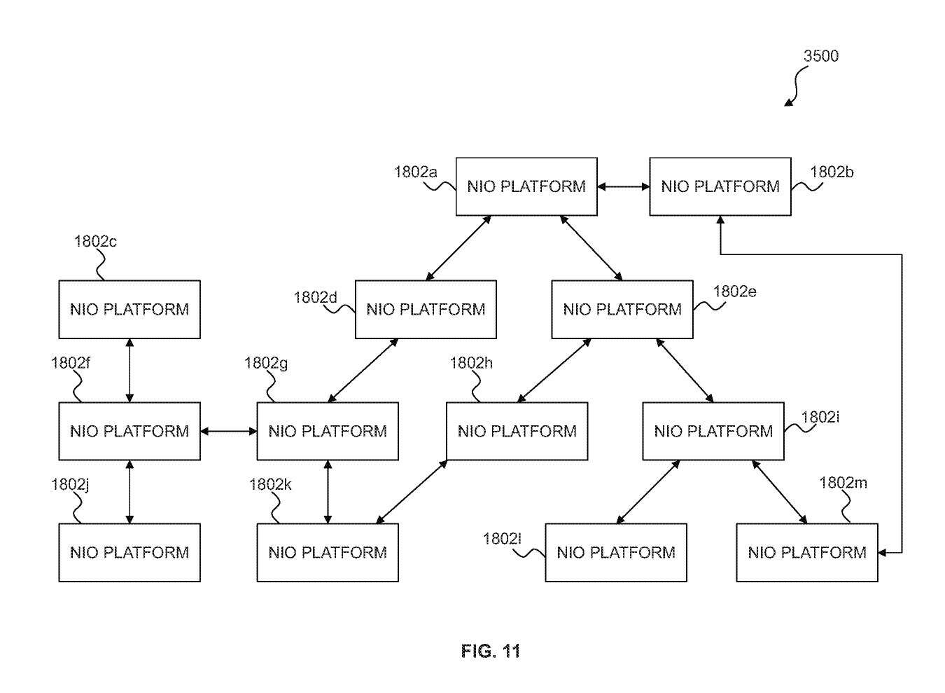

Referring to FIG. 11, one embodiment of a system 3500 includes NIO platforms 1802a-1802m. The various NIO platforms 1802a-1802m may be configured identically or each of the NIO platforms 1802a-1802m may have a different configuration. As shown in FIG. 11, there are many possible connections between NIO platforms in the tiered system 3400, including vertical connections between higher/lower tiered NIO platforms and horizontal connections between NIO platforms in the same tier. As shown by the direct connection between NIO platforms 1802b and 1802m, intermediate tiers may be bypassed if desired.

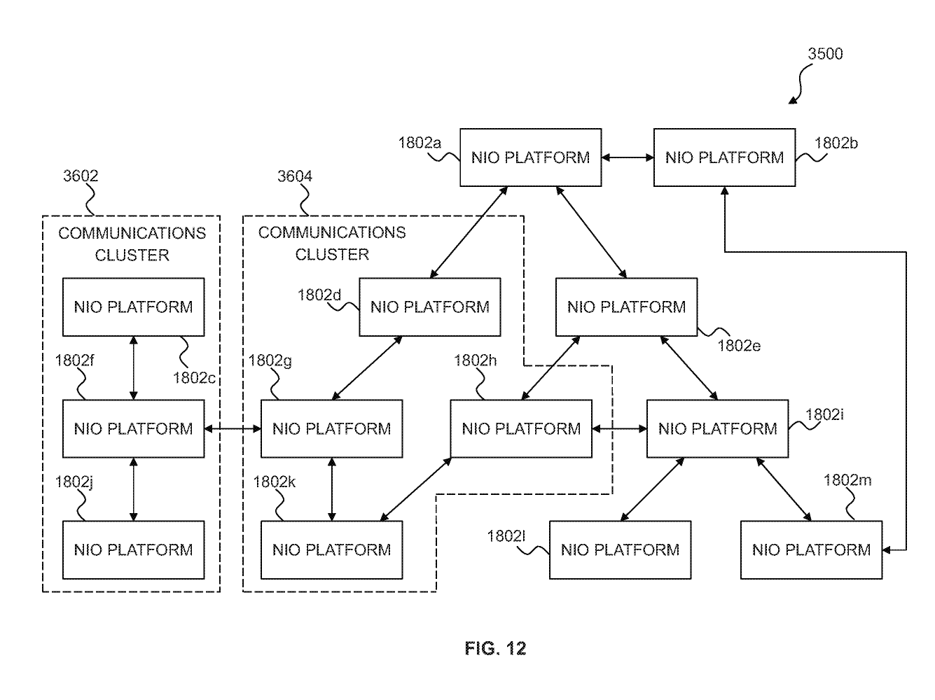

Referring to FIG. 12, another embodiment of the system 3500 of FIG. 11 illustrates how various NIO platforms 1802a-1802m may be grouped for communication purposes. The types of input(s) and output(s) for a specific NIO platform 1802a-1802m can be configured by modifying the services and their blocks as needed. It is understood that such configurations may include the use of modules 904 and/or core components 912 (FIG. 9B) as previously described.

The ability to configure communication capabilities for a NIO platform at the service level provides flexibility by enabling the selection of communication types within a single NIO platform (e.g., between services), between two or more NIO platforms, and between a NIO platform and non-NIO enabled devices and software. Such selections may be used to account for particular network configurations, software and hardware requirements, protocol requirements, a particular distribution of services within a NIO platform and/or across multiple NIO platforms, and similar issues without requiring that the underlying NIO platform be changed. For example, the input and/or output communications for a particular service may be configured to use a publication/subscription model, a direct model (e.g., a TCP/IP connection), and/or another communication model as needed, and the input(s)/output(s) can use the same or different communication models. It is understood that a communication model may use one or more different communication protocols, standards, specifications, and/or implementations, and the particular model used may vary depending on the defined communication needs of a NIO platform or a group of NIO platforms.

In the present example, the options for communications between NIO platforms vary based on whether the particular NIO platforms 1802a-1802m are in a communications cluster. More specifically, the system 3500 includes a communication cluster 3602 and a communications cluster 3604. Communications among the NIO platforms within a communications cluster are handled by a single communications broker using a publication/subscription model. Any NIO platform that is configured to use the broker and is able to do so (e.g., is on a device that has the correct permissions for the network) is part of the communications cluster and can publish and subscribe to channels within that communications cluster. Any NIO platforms that are not configured to use that broker or are unable to do so are outside of the communications cluster and cannot publish and subscribe to those channels.

While a communications cluster can extend over multiple networks (e.g., may simultaneously include both LAN and cloud based NIO platforms), it is often located on a single network. The broker is typically located on one of the NIO platforms within the communications cluster, but may be located elsewhere (e.g., on a server) in other embodiments. It is noted that communications between NIO platforms within a communications cluster may use other communication models in addition to, or as an alternative to, the publication/subscription model.

Accordingly, the NIO platforms 1802c, 1802f, and 1802j are configured to use the same broker within the communications cluster 3602. The NIO platforms 1802d, 1802g, 1802h, and 1802k are configured to use the same broker within the communications cluster 3604. The remaining NIO platforms 1802a, 1802b, 1802e, 1802i, 1802l, and 1802m are not part of a communications cluster.

Communications can occur between NIO platforms in different communication clusters, as illustrated by the line between the NIO platform 1802f of the communications cluster 3602 and the NIO platform 1802g of the communications cluster 3604. Such communications may be based on TCP/IP, UDP, or another suitable communication protocol. Communications can also occur between a NIO platform within a communication cluster and a NIO platform outside of a communication cluster. This is illustrated by the line between the NIO platform 1802d of the communications cluster 3604 and the NIO platform 1802a that is not in a communications cluster 3604, and by the lines between the NIO platform 1802h of the communications cluster 3604 and the NIO platforms 1802e and 1802i that are not in a communications cluster 3604. Such communications may be based on TCP/IP, UDP, or another suitable communication protocol.

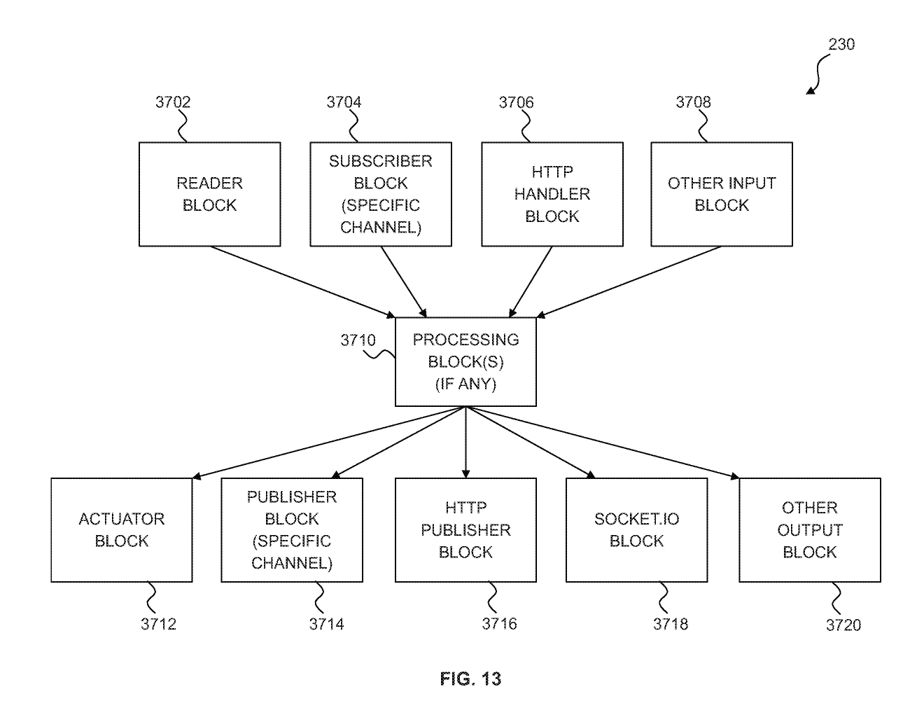

Referring to FIG. 13, one embodiment of a service 230 is illustrated with various blocks 3702-3720 that may be used to provide input and output functionality to the service 230. It is understood that not all services may be configured with input and output blocks as shown, and that some services may have input and/or output blocks located at positions within the service (e.g., not as the first or last block to be executed). However, the service 230 of the present example provides an illustration of the different ways in which a service may receive input from one or more sources and send output to one or more destinations, regardless of where the particular blocks are located in the service.

The service 230 may be configured with one or more input blocks, such as a reader block 3702 to receive data from an analog or digital device (e.g., by polling a pin or a port), a subscriber block 3704 that is configured to receive data from a particular publication channel, an HTTP handler block 3706 to receive HTTP formatted data via a TCP/IP connection, and an “other input” block 3708 that may receive data via any type of communications channel for which the block is configured. The input is passed to one or more processing blocks 3710 if such blocks are present and the service 230 is configured to do so.

The service 230 may be configured with one or more output blocks, such as an actuator block 3712 to perform an actuation, a publisher block 3714 that is configured to send data to a particular publication channel, an HTTP publisher block 3716 to send HTTP formatted data via a TCP/IP connection, a socket.io block 3718 that is configured to send data directly to a socket server, and an “other output” block 3720 that may send data via any type of communications channel for which the block is configured.

The “other” input block 3708 and “other” output block 3720 may be customized for use with any desired communication protocol, standard, specification, and/or implementation. For example, one or both of the blocks may be configured for communications based on Global System for Mobile Communications (GSM), Enhanced Data rates for GSM Evolution (EDGE), Universal Mobile Telecommunications System (UMTS), High Speed Packet Access (HSPA), Long-Term Evolution (i.e., 4G LTE), Bluetooth, Wi-Fi, RuBee, Z-Wave, near field communication (NFC), iBeacon, Eddystone, radio frequency identification (RFID), open systems interconnection (OSI), secure socket layer (SSL), point to point protocol (PPP), IPv6 over Low power Wireless Personal Area Networks (6LoWPAN), IEEE 802.11, IEEE 802.15.4, and implementations based on such standards, such as Thread and Zigbee.

It is understood that each particular customization of an input block or an output block may be directed to one or more such protocols, standards, specifications, and/or implementations, and may include configuration options that are used to configure the block for use with a particular service on a particular NIO platform. For example, the blocks 3704 and 3714 include a configurable parameter for the channel to which the block 3704 is to publish and the channel to which the block 3714 is to subscribe. The same base publisher and subscriber blocks can then be used by different services with the configurable parameters differing based on the channel to be used by the corresponding service. In another example, the block 3718 contains the task specific functionality to send content to a socket.io server room. To accomplish this, the block 3718 includes configurable parameters for a host (e.g., a location of a Socket.IO server), a port (e.g., a port of the Socket.IO server), a room (e.g., a room on the Socket.IO to which the content should be sent), and an option to configure the block 3718 to listen for messages from the socket.io room.

In other embodiments, an input block or an output block may not handle such protocols, standards, specifications, and/or implementations directly. In such embodiments, the block may communicate with the operating system and/or device on which the NIO platform is running, and the operating system or device may then handle the actual formatting of the data as required by the particular protocol, standard, specification, and/or implementation.

It is further understood that the ease with which changes to communications can be made depends somewhat on the design of the input blocks 3702-3708, the output blocks 3712-3720, and the processing blocks 3710. For example, if the processing block 3710 that receives the input from one of the input blocks 3702-3708 is able to handle input from any of the input blocks, then modifying the service 230 to receive a different type of input may be accomplished by simply replacing the current input block with a different input block. This scenario may occur, for example, if the task specific functionality of the input blocks 3702-3708 is customized to produce a similar or identical output, or the task specific functionality of the processing block 3710 is customized to handle different types of information to account for differences between the input blocks 3702-3708. However, if the processing block 3710 is only able to receive input from a particular one of the input blocks 3702-3708, then the processing block 3710 may also need to be replaced or modified for compatibility if the input block is changed.

The same issue exists with the processing blocks 3710 and the output blocks 3712-3720, with the ease of change depending on how the processing block 3710 formats and presents information to the output blocks 3712-3720 and how the output blocks 3712-3720 handle the information received from the processing block 3710. In the present example, the input blocks 3702-3708 and output blocks 3712-3720 are designed to be swappable without requiring any changes to the processing blocks 3710. In other embodiments, one or more of the processing blocks 3710 may require changes when one of the input blocks 3702-3708 or output blocks 3712-3720 is changed.

Accordingly, the service 230 can be configured to receive and send data as desired by selecting and configuring the appropriate input and output blocks for the service 230 to use. Multiple input blocks and output blocks can be used to configure the service 230 with alternate or additional receive and send functionality. This means that a single service 230 can handle multiple types of inputs and outputs, either simultaneously or as alternatives based on defined criteria, which provides a great deal of flexibility. As each service 230 on a NIO platform can be configured individually, the communications capability of the NIO platform can be modified simply by adding, removing, and/or changing the input and/or output blocks used by a service. This flexibility is extremely useful when the NIO platform is being configured for use as part of a tiered structure of NIO platforms, as the services can be configured for whatever communications are desired simply by configuring each service to use the desired input and output blocks.

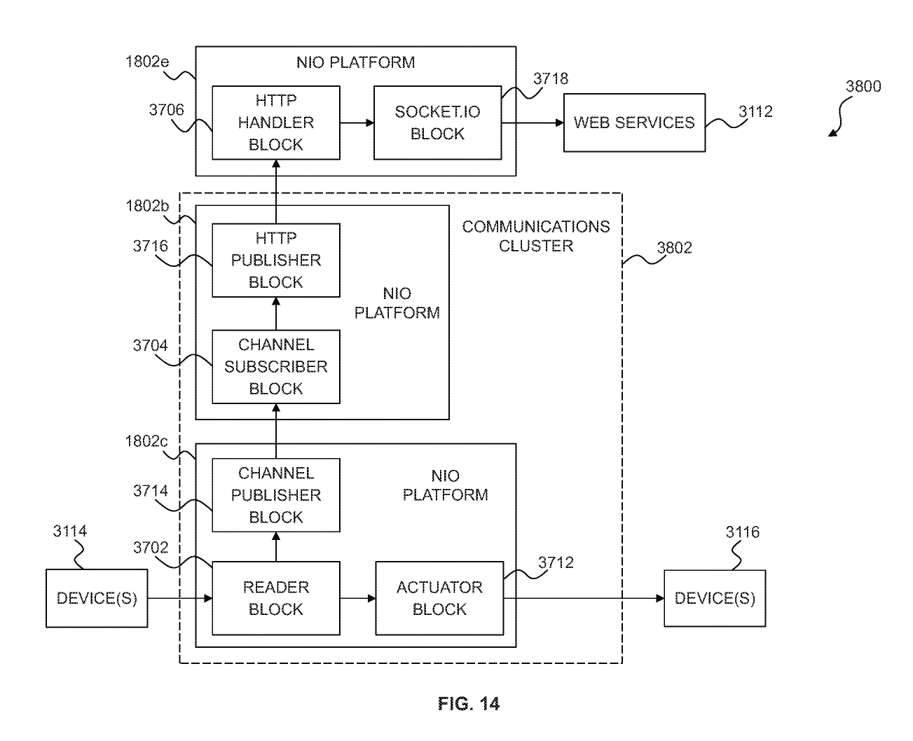

Referring to FIG. 14, one embodiment of a system 3800 is illustrated with the NIO platforms 1802b, 1802c, and 1802e, and the devices 3114 and 3116 of FIG. 7. In the present example, the NIO platform 1802c receives input from the device 3114 and actuates the device 3116. It is understood that the devices 3114 and 3116 may be the same device in some embodiments. The NIO platforms 1802b and 1802c are in a communications cluster 3802, and the NIO platform 1802e is not in the communications cluster 3802.

The system 3800 is illustrated with only input and output blocks present for each NIO platform 1802b, 1802c, and 1802e in order to illustrate how the NIO platforms may communicate. The services and other processing blocks are omitted, as are any intra-platform input and output blocks that may be used between services on a single NIO platform.

The NIO platform 1802c receives input from the device 3114 using a reader block 3702. The NIO platform 1802c sends output as an actuation to device 3116 using an actuator block 3712 and as a publication to a specific channel using channel publisher block 3714. The outputs may be sent by a single service or by different services. If different services are used, the inter-service communications may be accomplished via a publication/subscription model or in a different way.

The NIO platform 1802b receives input from the NIO platform 1802c using a channel subscriber block 3704, and sends HTTP compliant output to the NIO platform 1802e using an HTTP publisher block 3716. The NIO platform 1802e receives input from the NIO platform 1802b using an HTTP handler block 3706, and sends an output to the web services 3112 using a socket.io block 3718.

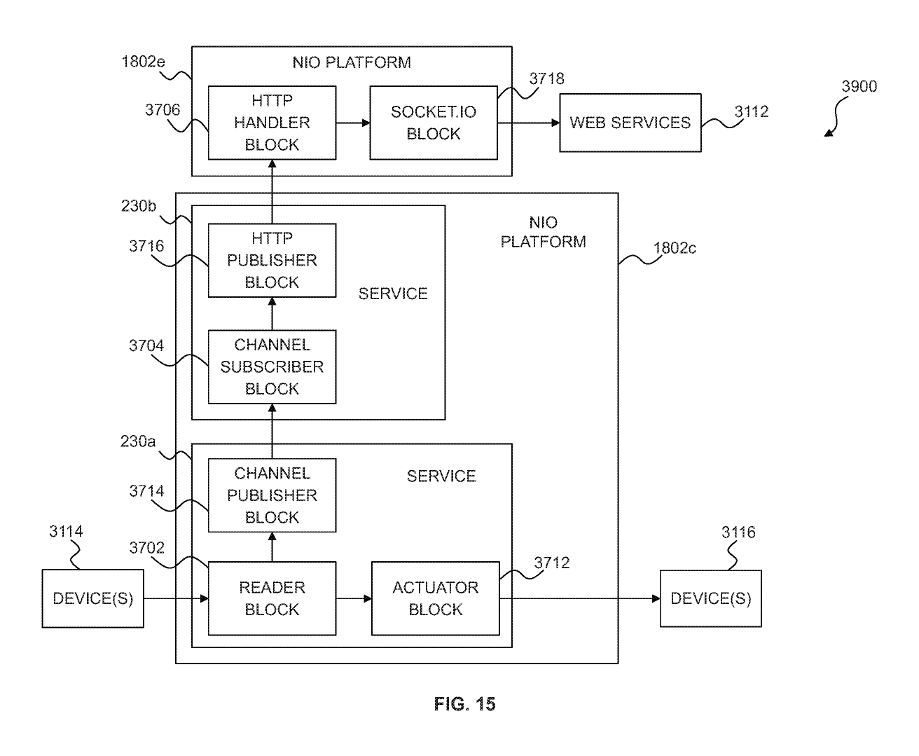

Referring to FIG. 15, one embodiment of a system 3900 is illustrated with the NIO platforms 1802c and 1802e and the devices 3114 and 3116 of FIG. 14. In the present example, the NIO platform 1802c includes services 230a and 230b that provide the functionality that was previously divided between the NIO platforms 1802b and 1802c in FIG. 14. The channel publisher block 3714 and channel subscriber block 3704 are now used to route information from the service 230a to the service 230b on the single NIO platform 1802c, rather than between two different NIO platforms as illustrated in FIG. 14. This illustrates the ease with which services can be distributed or consolidated on a per platform basis, and also illustrates the usefulness of being able to configure communications on a per service basis.

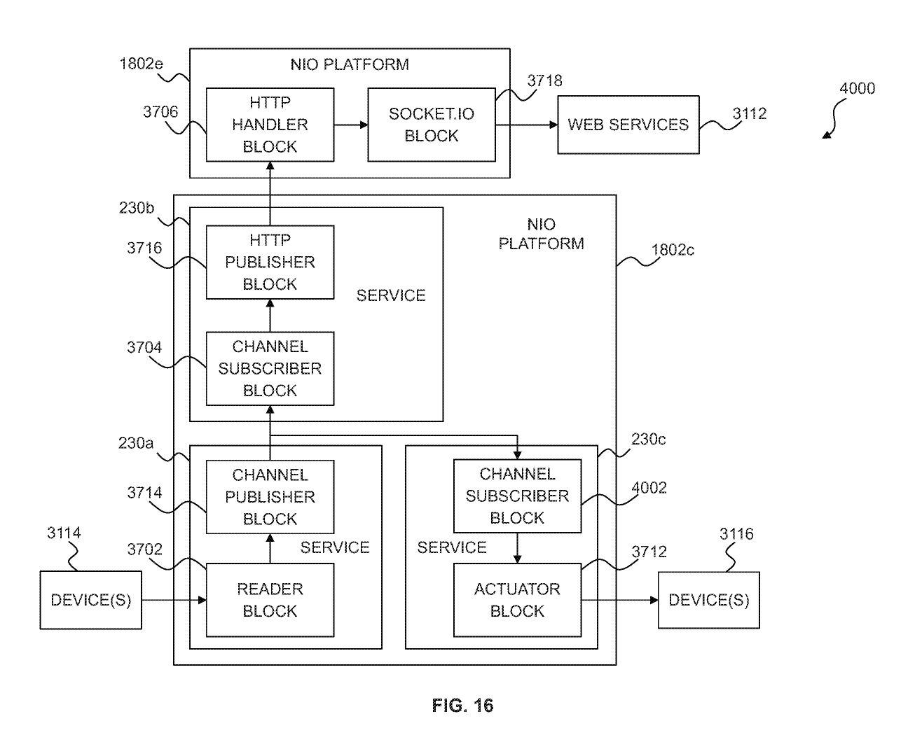

Referring to FIG. 16, one embodiment of a system 4000 is illustrated with the NIO platforms 1802c and 1802e and the devices 3114 and 3116 of FIG. 15. In the present example, the NIO platform 1802c includes services 230a and 230c that provide the functionality that was previously contained in the service 230a in FIG. 15. The channel publisher block 3714 and a channel subscriber block 4002 in the service 230c are now used to route information from the service 230a to the service 230c. This illustrates the ease with which services can be distributed or consolidated on a per platform basis, and also illustrates the usefulness of being able to configure communications on a per service basis.

It is understood that the embodiments of FIGS. 14-16 may be provided using multiple NIO platform instances running on a single device. Some or all of the NIO platform instances on the device may be part of a communications cluster and/or may use other communication channels to communicate with each other, to communicate with NIO platforms external to the device, and to communicate with devices that do not use NIO platforms. For example, the services 230a-230c of FIG. 16 may be run by separate NIO platform instances, rather than the single NIO platform instance 1802c, and those NIO platform instances may be running on a single device. In some embodiments, the NIO platform 1802e may also be running on the same device as the other NIO platforms. In some embodiments, different NIO instances on the same device may be part of different communications clusters.

Accordingly, the various communication channels described herein may be used between NIO platform instances on a single device, as well as between NIO platform instances on different devices. In addition, a NIO platform instance may use one or more of the communication channels described herein to communicate with the device or a part of the device (e.g., a sensor) on which the NIO platform instance is running, in addition to or as an alternative to communicating with an operating system and/or any APIs running on the device using defined OS and API calls.

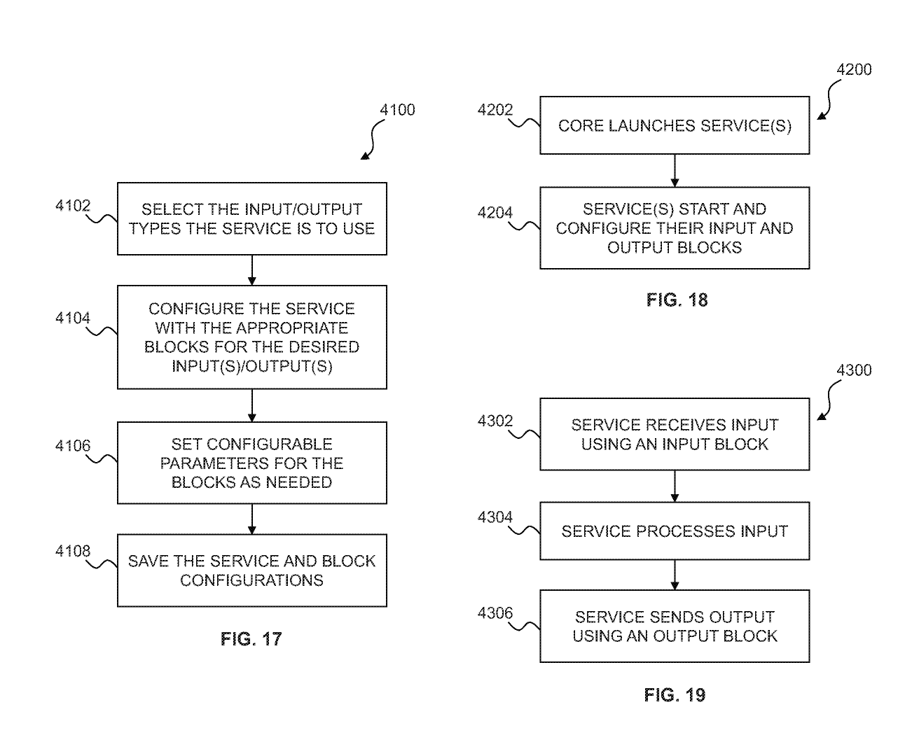

Referring to FIG. 17, a method 4100 illustrates one embodiment of a process that may be executed to configure a service (e.g., the service 230 of FIG. 13) of a NIO platform for communication. As previously described, various blocks may contain task specific instructions for providing particular types of communications. Such blocks may include configurable parameters that can be used to configure a block for use by the particular service 230.

In step 4102, the input(s) and output(s) that the service 230 will be using are selected. As illustrated in previous examples, this may depend on the other services and/or devices with which the service 230 will be communicating, whether the NIO platform running the service 230 is within a communications cluster, and similar factors. In step 4104, the service 230 is configured with the appropriate blocks for the desired input(s) and output(s). In step 4106, configurable parameters within the blocks may be set as needed. In step 4108, the service and block configurations are saved for use by the NIO platform.

Referring to FIG. 18, a method 4200 illustrates one embodiment of a process that may be executed by a NIO platform. In step 4202, the NIO platform's core launches the services as previously described. In step 4204, the services start and configure their input and output blocks for use in communications.

Referring to FIG. 19, a method 4300 illustrates one embodiment of a process that may be executed by a running service (e.g., the service 230 of FIG. 13). As previously described, various blocks may contain task specific instructions for providing particular types of communications. In step 4302, the service 230 receives input using an input block, which handles the input as configured. In step 4304, the service 230 processes the input. In step 4306, the service 230 produces output using an output block, which handles the output as configured. As described previously, the task specific functionality of the input and output blocks and their configurations may be modified to alter the input and output functionality of the service 230.

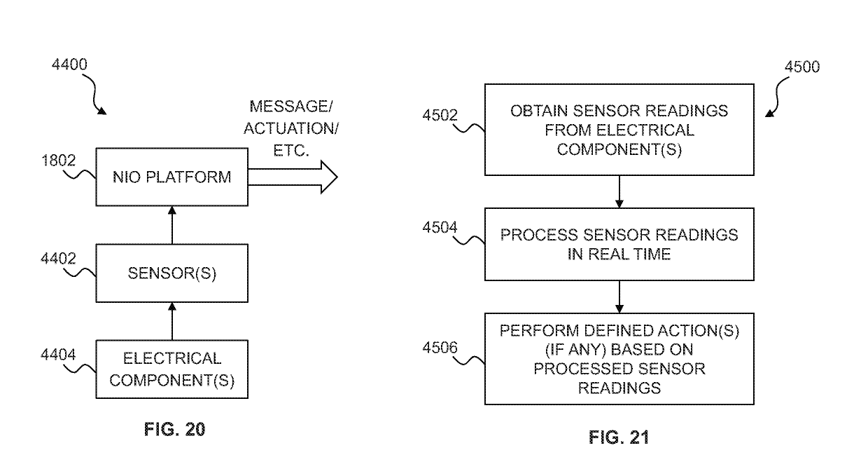

Referring to FIG. 20, one embodiment of an environment 4400 illustrates the NIO platform 1802 of FIG. 18, one or more sensors 4402, and one or more electrical components 4404. As will be described below in greater detail, the NIO platform 1802 is configured to receive inputs from the sensor 4402 that is coupled to the electrical component 4404.

The electrical component 4404 may be any active, passive, or electromechanical discrete device or physical entity that uses, transfers, communicates with, and/or produces electricity in any form, and may be standalone or part of a larger device. Active components include semiconductors (e.g., diodes, transistors, integrated circuits, and optoelectronic devices), display technologies, vacuum tubes, discharge devices, and power sources. Passive components include resistors, capacitors, magnetic (inductive) devices, memristors, networks, transducers, sensors, detectors, antennas, assemblies, modules, and prototyping aids. Electromechanical components include piezoelectric devices (including crystals and resonators), terminals and connectors, cable assemblies, switches, protection devices, and mechanical accessories (e.g., heat sinks and fans). The sensor 4402 is any type of sensor that is capable of sensing the desired characteristic(s) of the electrical component 4404 and producing a signal representing the characteristic(s).

The NIO platform 1802 processes the inputs from the sensor 4402 based on the platform's configuration and produces one or more outputs, which may include messages and/or actuations. The functionality of the NIO platform 1802 may be provided on a single platform (as will be described below with respect to FIG. 14) or may be distributed across multiple platforms (as will be described below with respect to FIG. 19).

Referring to FIG. 21, a method 4500 illustrates one embodiment of a process that may be executed by the NIO platform 1802 of FIG. 20. Alternatively, the method 4500 may be executed by multiple NIO platforms if the functionality has been distributed. In step 4502, the NIO platform 1802 obtains sensor readings from the sensor 4402 about the electrical component 4404. In step 4504, the sensor readings are processed by the NIO platform 1802 based on the particular configuration of the NIO platform. Accordingly, the NIO platform 1802 will have blocks 232 (not shown) capable of receiving input from the sensor 4402 and processing that input. In step 4506, one or more defined actions may be taken based on the processed input. As described in previous embodiments, the receipt, processing, and performance of any actions may occur in real time due to the architecture of the NIO platform 1802.

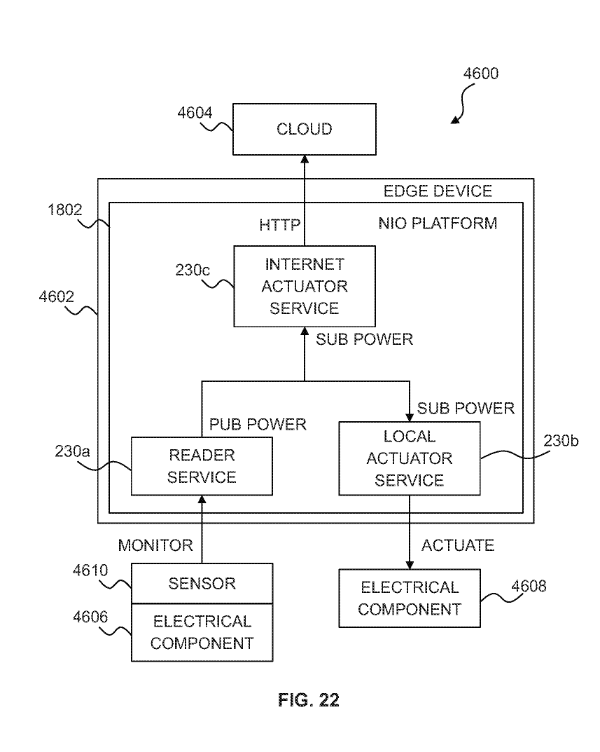

Referring to FIG. 22, one embodiment of a system 4600 illustrates a power monitoring and actuation system using the single NIO platform 1802 of FIG. 20. The NIO platform 1802 is located on an edge device 4602 and also has a communication link that enables the NIO platform 1802 to communicate with the cloud 4604. The NIO platform 1802 is coupled to an electrical component 4606 and an electrical component 4608. The electrical components 4606 and 4608 may be separate components (as shown) or may represent a single component.

For purposes of example, the NIO platform 1802 is shown with a configuration of specific services for implementing the functions illustrated with respect to the method 4500 of FIG. 21. A reader service 230a receives input from the electrical component 4606 via a sensor 4610 and publishes to a channel named “Power.” A local actuator service 230b subscribes to the Power channel to receive input from the reader service 230a. The local actuator service 230b then controls the actuation of the electrical component 4608 based on the received input. An internet actuator service 230c subscribes to the Power channel, and formats and sends information to the cloud 4604 based on the input.

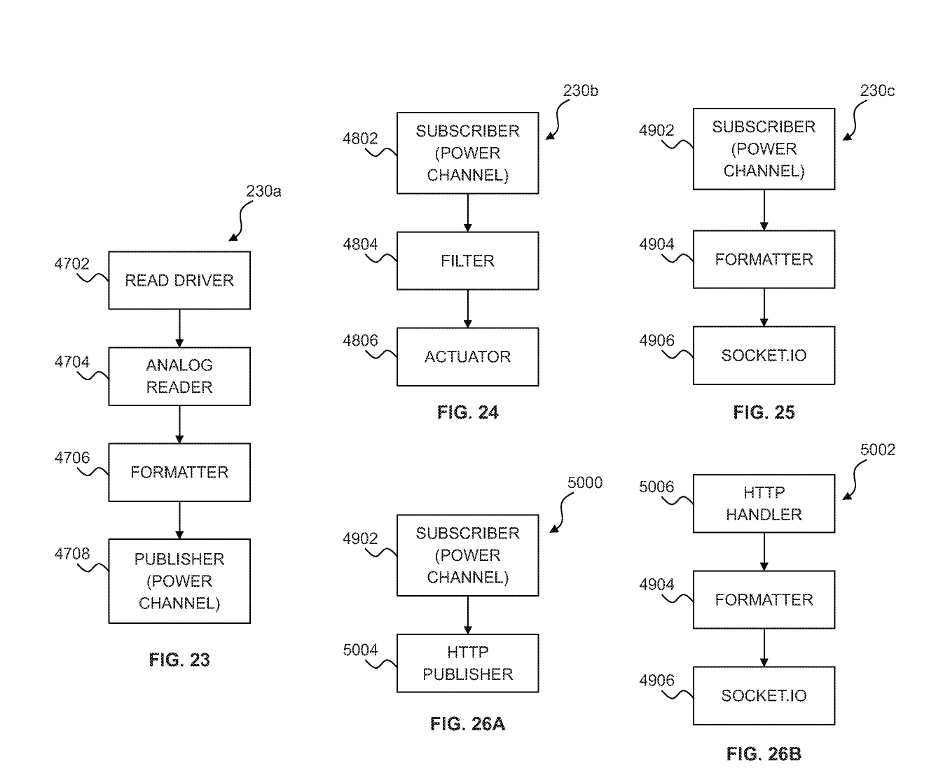

Referring to FIG. 23, one embodiment of the reader service 230a of FIG. 22 is illustrated. In the present example, the reader service 230a includes multiple blocks, including a read driver block 4702, an analog reader block 4704, a formatter block 4706, and a publisher block 4708.

The read driver block 4702, which may be omitted in some embodiments, is a simulator block that drives how frequently the sensor 4610 should be read. For example, the read driver block 4702 may have a parameter that can be set with a time (e.g., 0.1, 0.5, or one second) to trigger a sensor read. The output from the read driver block 4702 is directed to the analog reader block 4704 to trigger the actual read action. The analog reader block 4704 reads one or more values from the sensor 4610 coupled to the electrical component 4606 each time the analog reader block 4704 receives a trigger from the read driver block 4702. The output from the analog reader block 4704 is directed to the formatter block 4706. The formatter block 4706 formats the sensor data obtained by the analog reader block 4704 for use by other services if needed. The output from the formatter block 4706 is directed to the publisher block 4708. The publisher block 4708 publishes the data to the “Power” channel.

Referring to FIG. 24, one embodiment of the local actuator service 230b of FIG. 22 is illustrated. In the present example, the local actuator service 230b includes multiple blocks, including a subscriber block 4802, a filter block 4804, and an actuator block 4806.

The subscriber block 4802 subscribes to the Power channel to receive information from the reader service 230a. The output from the subscriber block 4802 is directed to the filter block 4804. The filter block 4804 determines whether or not an actuation of the electrical component 4608 should be performed based on the received information. It is understood that the logic executed by the filter block 4804 may be more complex than a simple filter and, in some embodiments, may be provided by another service or services. By positioning the actuation logic of the filter block 4804 on the edge device 4602, edge filtering is provided that minimizes the amount of noise transmitted across a network. This edge filtering also minimizes response time as there is no need to account for any network round trip transmission time that might delay an actuation. The output from the filter block 4804 is directed to the actuator block 4806. The actuator block 4806 performs any needed actuation of the electrical component 4608.

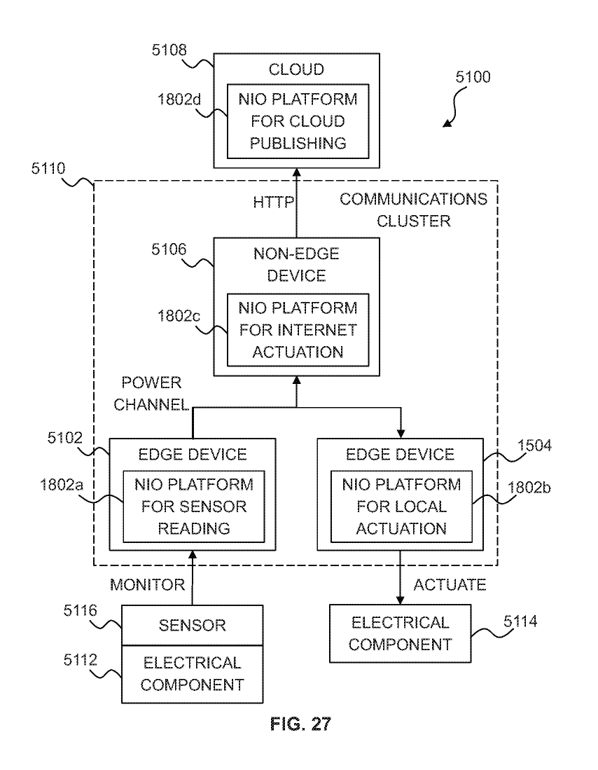

Referring to FIG. 25, one embodiment of the internet actuator service 230c of FIG. 22 is illustrated. In the present example, the internet actuator service 230c includes multiple blocks, including a subscriber block 4902, a formatter block 4904, and a socket.io block 4906.

The subscriber block 4902 subscribes to the Power channel to receive information from the reader service 230a and may be the same basic block as the subscriber block 4802 of the local actuator service 230b. The output from the subscriber block 4902 is directed to the formatter block 4904. The formatter block 4904 may handle formatting of the information as needed. For example, if the information is to be visualized, the formatter block 4904 would handle the formatting needed for visualization. The output from the formatter block 4904 is directed to the socket.io block 4906. The socket.io block 4906 sends the information to a socket.io server (not shown) so that the information can be visualized on a web page. For example, the socket.io block 4906 may send the information directly to the web services 3112 of FIG. 7, which may be running on a socket.io server in the cloud.

Referring to FIG. 27, one embodiment of a system 5100 illustrates a power monitoring and actuation system using multiple NIO platforms 1802a-1802d. The functionality described with respect to the services 230a-230c of FIG. 22 are distributed among the NIO platforms 1802a-1802d, rather than being located on a single NIO platform as described with respect to FIG. 22. It is understood that the functionality may be distributed in many different ways, and the current embodiment is only one possible distribution.

The NIO platforms 1802a-1802d are positioned in a tiered arrangement. More specifically, the NIO platform 1802a is located on an edge device 5102 and is coupled to an electrical component 5112 via a sensor 5116. The NIO platform 1802b is located on an edge device 5104 and is coupled to an electrical component 5114. The electrical components 5112 and 5114 may be separate components (as shown) or may represent a single component. The NIO platform 1802c is located on a non-edge device 5106 and has a communication link that enables the NIO platform 1802c to communicate with the NIO platform 1802d located in the cloud 5108.

For purposes of example, the NIO platform 1802a is configured with the reader service 230a of FIGS. 22 and 23 to read the sensor 5116. The NIO platform 1802b is configured with the local actuator service 230b of FIGS. 22 and 24 to handle the actuation of the electrical component 5114. The NIO platforms 1802c and 1802d each handle part of the internet actuator service 230c of FIGS. 22 and 25, although this may require additional blocks as will be described below.

Communications among the NIO platforms 1802a-1802c are handled by a communications broker and the NIO platforms 1802a-1802c form a single communications cluster 5110. As described previously with respect to FIG. 12, any NIO platform that is configured to use the broker is part of the communications cluster 5110 and can publish and subscribe to channels within that cluster (e.g., the Power channel). Any NIO platforms that are not configured to use the broker are outside of the communications cluster 5110 and cannot publish and subscribe to those channels. Accordingly, the NIO platform 1802d cannot subscribe to the Power channel. With respect to FIG. 27, as only the NIO platform 1802c is handling non-local communications outside of the communications cluster 5110, only the NIO platform 1802c needs communication access to the cloud 5108.

Referring to FIGS. 26A and 26B, one embodiment of the internet actuator service 230c of FIG. 22 is illustrated after being separated between the NIO platform 1802c and the NIO platform 1802d. More specifically, the NIO platform 1802c runs an internet actuator service 5000 (FIG. 26A) and the NIO platform 1802d runs a cloud publishing service 5002 (FIG. 26B).

In the present example, the internet actuator service 5000 includes multiple blocks, including the subscriber block 4902 of FIG. 25 and an HTTP publisher block 5004. As described previously, the subscriber block 4902 subscribes to the Power channel to receive information from the reader service 230a. The output from the subscriber block 4902 is directed to the HTTP publisher block 5004. The HTTP publisher block 5004 is different than the publisher block 4708 and does not use the broker of the communications cluster 5110. The HTTP publisher block 5004 instead sends information out of the communications cluster 5110 via HTTP to the NIO platform 1802d.

The cloud publishing service 5002 includes multiple blocks, including an HTTP handler block 5006, the formatter block 4904 of FIG. 25, and the socket.io block 4906 of FIG. 25. The HTTP handler block 5006 provides an HTTP endpoint to which the internet actuator service 5000 can send data. The output from the HTTP handler block 5006 is directed to the formatter block 4904, which operates with the socket.io block 4906 as previously described.

It is understood that the functionality may be distributed into more or fewer NIO platforms as desired. Furthermore, each NIO platform may be configured with one or more services to handle the particular functions assigned to that NIO platform. Accordingly, a great deal of flexibility is provided.

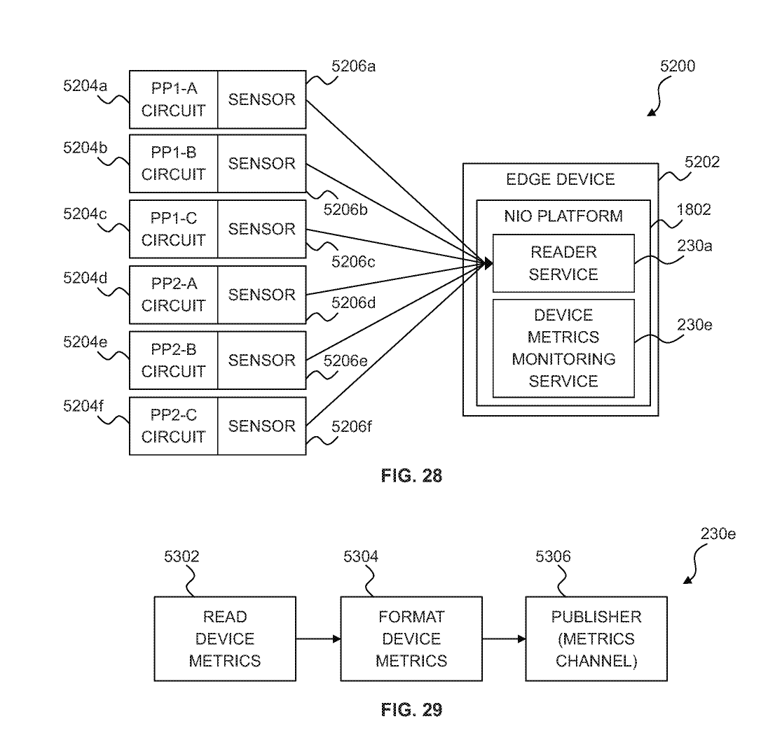

Referring to FIG. 28, another embodiment of a system 5200 illustrates a power monitoring system using a single NIO platform 1802. The NIO platform 1802 is located on an edge device 5202 and is running the reader service 230a of FIG. 22. The NIO platform 1802 may be a standalone monitoring platform as described with respect to FIG. 22, or may be part of a tiered system as described with respect to FIG. 27. It is understood that other services (e.g., the services 230b and 230c of FIG. 22) may also be running on the NIO platform 1802, but only the reader service 230a is illustrated for purposes of the present example.

The NIO platform 1802 is configured to monitor multiple electrical components 5204a-5204f that form two power panels labeled “Power Panel 1” (PP1) and “Power Panel 2” (PP2), each of which has three circuits labeled A, B, and C. Accordingly, the six circuits monitored by the NIO platform are 1-A, 1-B, 1-C, 2-A, 2-B, and 2-C. Each circuit 5204a-5204f is read by a sensor 5206a-5206f, respectively. The sensors 5206a-5206f are read by, or push data to, the reader service 230a.

It is understood that the NIO platform 1802 may be used to monitor the circuits 5204a-5204f even if the circuits 5204a-5204f have different configurations and/or the sensors 5206a-5206f are measuring different characteristics. In such cases, the flexibility of the NIO platform 1802 may be leveraged by modifying the configuration of the service 230a and/or blocks. In some embodiments, depending on the particular circuits 5204a-5204f and/or sensors 5206a-5206f, additional services and/or blocks may be needed to configure the NIO platform 1802 with the desired monitoring functionality.

With additional reference to FIG. 29, one embodiment of the device metrics monitoring service 230e of FIG. 28 is illustrated. In the present example, the device metrics monitoring service 230e includes multiple blocks, including a read device metrics block 5302, a format device metrics block 5304, and a publisher block 5306.

The read device metrics block 5302 reads information from the device 5202 at timed intervals using, for example, an I/O interface provided by the device 5202. The information may include, but is not limited to, information about socket connections, CPU percentage, swap memory, process identifiers, disk I/O statistics, network I/O statistics, disk usage, and virtual memory. The output from the read device metrics block 5302 is directed to the format device metrics block 5304. The format device metrics block 5304 formats the information obtained by the read device metrics block 5302 for use by other services if needed. The output from the format device metrics block 5304 is directed to the publisher block 5306. The publisher block 5306 publishes the data to a “Metrics” channel. This channel may then be subscribed to by another service (e.g., the internet actuator service 230b of FIG. 24 or the internet actuator service 5000 of FIG. 26A) and published.

Referring again to FIG. 28, the NIO platform 1802, either itself or in conjunction with other NIO platforms, produces the information needed to provide a real time display of the current amperage of each of the circuits 5204a-5204f, as well as information on the performance of the device 5202 on which the NIO platform is running. It is understood that the actual display may be generated by a NIO platform or may use additional services, such as the web services 3112 of FIG. 7.

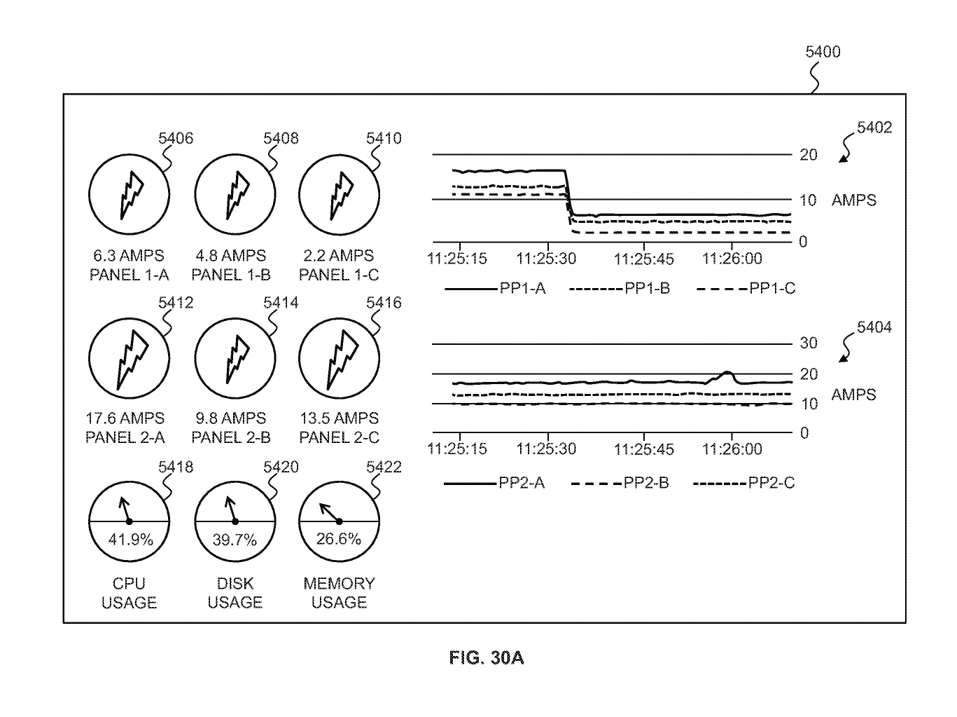

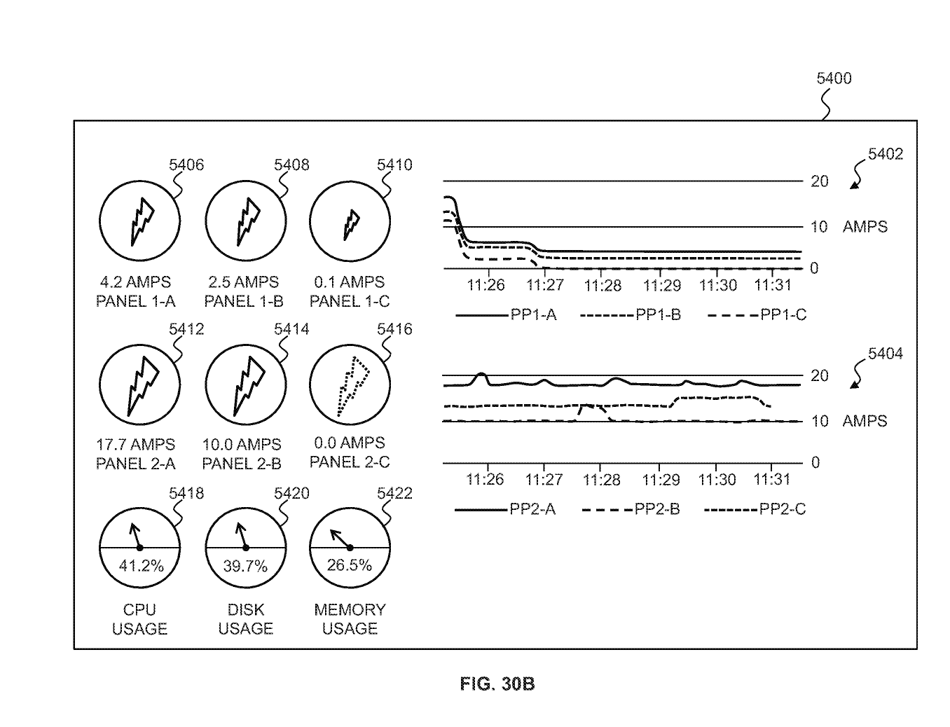

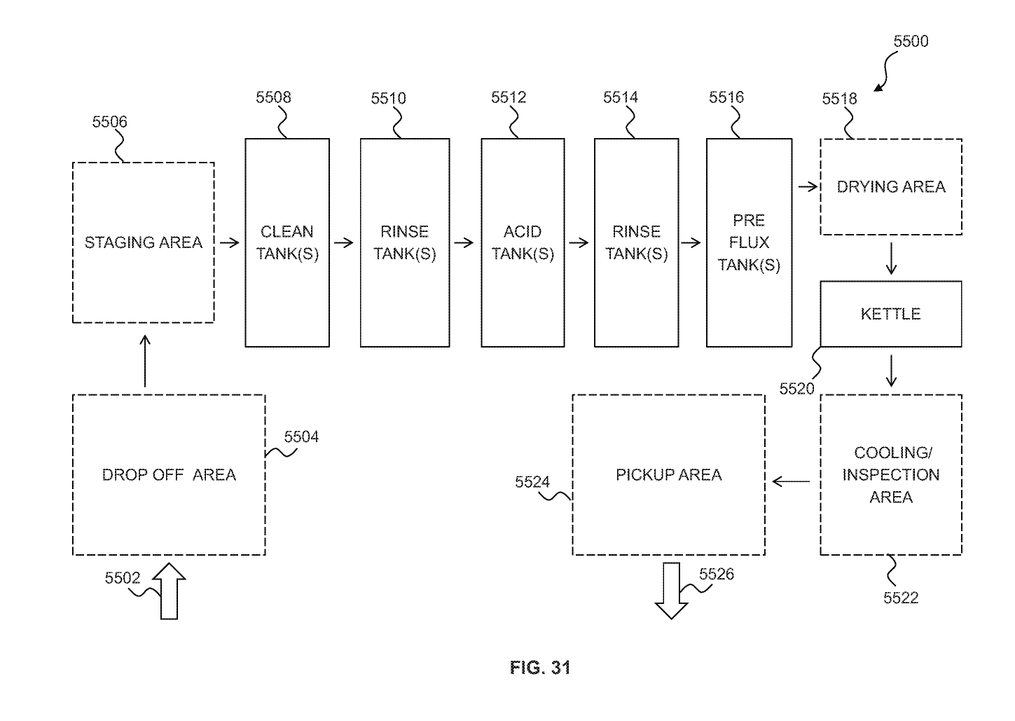

With additional reference to FIGS. 30A and 30B, one embodiment of a GUI 5400 is illustrated with real time information relating to the circuits 5204a-5204f obtained by the reader service 230a of FIG. 28. The GUI 5400 also provides real time information on the performance of the device 5202 using the device usage monitoring service 230e. It is noted that the services 230a and 230e, as well as the blocks within each service, may run asynchronously as described in previous embodiments, and therefore can update the GUI 5400 as desired without interfering with one another.

Referring specifically to FIG. 30A, the GUI 5400 provides two graphs 5402 and 5404, each having an x-axis representing time and a y-axis representing amperage. The graph 5402 illustrates the amperage of the circuits 5204a-5204c (i.e., PP1-A, PP1-B, and PP1-C) as individual lines. The graph 5404 illustrates the amperage of the circuits 5204d-5204f (i.e., PP2-A, PP2-B, and PP2-C) as individual lines. The current amperage of each circuit 5204a-5204f is shown on the far right of each graph 5402 and 5404 with historical data moving to the left. It is noted that the historical data is maintained in the present example by the web services and not by a NIO platform, although a NIO platform may store the historical data if configured to do so.

The current amperage for the circuits 5204a-5204f is also shown by indicators 5406-5416, respectively, and the text accompanying each indicator. For example, indicator 5406 corresponds to Panel 1-A (circuit 5204a) and indicates that the current amperage value is 6.3 amps. This corresponds to the line for PP1-A at the far right on graph 5402. Similarly, indicator 5416 corresponds to Panel 2-C (circuit 5204f) and indicates that the current amperage value is 13.5 amps. This corresponds to the line for PP2-C at the far right on graph 5402. As the graphs 5402 and 5404 illustrate the current amperage in real time, the previously graphed information will shift to the left and may eventually disappear if the graph does not scale over time. Because the monitoring in the present example was started just before 11:25:15 and occurs in real time, there is no data to graph before the start time.

The indicators 5406-5416 may use colors and/or other representations to indicate a particular state. For example, a currently active circuit may have a green indicator, while an inactive circuit may have a red or gray indicator. In addition, the size of a symbol (e.g., a lightning bolt) may scale based on the corresponding amperage, with higher levels of amperage having larger symbols. For example, the 9.8 amps of the indicator 5414 is represented by a visually smaller lightning bolt than the higher 17.6 amps of the indicator 5412. Such visual indications may provide an easily readable overview of the current state of each of the circuits 5204a-5204f.

The GUI 5400 also illustrates three indicators that provide real time performance information on the device 5202. More specifically, an indicator 5418 represents the current CPU usage of the device 5202 as 41.9%. An indicator 5420 represents the current disk usage (e.g., the amount of available disk space being used) of the device 5202 as 39.7%. An indicator 5422 represents the current memory usage of the device 5202 as 26.6%.

Referring specifically to FIG. 30B, the graphs 5402 and 5404 have scaled with respect to time. For example, the current scale is now in one minute increments rather than the fifteen second increments of FIG. 30A. This scaling enables a larger timeframe to be displayed and provides a longer term view of the amperage values for each circuit 5204a-5204f The graphs 5402 and 5404 may also smooth the lines as more data becomes available.

As shown by the indicator 5416, the circuit 5204f is not currently active. It is noted that the indicator is not showing minimal current or even zero current, it is showing that there is no reading at all. The graph 5404 reveals that sensor data was last received for the panel PP2-C from the sensor 5206f at approximately 11:31. The last reading of the circuit 5204f showed approximately thirteen amps. The lack of current sensor data may be due to a malfunction in the circuit 5204f or the sensor 5206f, and/or one or more other problems.

The real time data obtained by the NIO platform 1802 can be used to proactively diagnose problems and, when a problem occurs, to react in real time. For example, the rise in current just after 11:29 and the subsequent fall just before 11:31 may have indicated a developing problem. If the NIO platform 1802 was configured to monitor for such problems, it might have shut down the circuit 5206f before failure occurred or might have shut down one or more devices attached to the circuit to reduce the load. The NIO platform 1802 may also be configured with information regarding the expected load levels to determine if the load level is within bounds during a spike. Alternatively or additionally, a more detailed level of monitoring may be started when a defined threshold is surpassed.

If configured to send alerts, the NIO platform 1802 (or another NIO platform) could respond to this failure in real time by sending a message and/or taking other action. For example, if an actuation response is defined, the NIO platform 1802 could activate an audible or visual alarm.

Referring to FIG. 31, an environment 5500 illustrates one embodiment of an industrial facility within which a NIO platform, such as the NIO platform 1802 of FIG. 18, may be used for purposes such as monitoring (as discussed previously with respect to FIGS. 30A and 30B) and actuation. As is known, industrial facilities may use a variety of equipment from different manufacturers, may perform many different processes, and have differing needs even if the general output of two facilities is similar or identical. For example, geographic differences may result in different available raw materials, costs, types of equipment, layouts, applicable laws and regulations, accounting practices, and so forth. Furthermore, even the facilities of a single company may vary somewhat and companies that run different types of facilities are often forced to use very different software for the different types of facilities, which makes standardization difficult or impossible within the company. However, due to the flexibility provided by the NIO platform 1802, the NIO platform 1802 can be used to provide a standard configurable solution regardless of the needs of any particular industrial facility.

For purposes of example, the environment 5500 represents a galvanizing facility in which metal products are put through a hot dip galvanizing process that coats the products with a layer of zinc or another suitable material. It is understood that the illustrated galvanizing facility is for purposes of example only, and equipment may be modified, added, removed, or rearranged in many different ways. It is further understood that the industrial environment may be directed to many different facilities used for the production of goods and/or services and is not limited to a galvanizing facility.

The NIO platform 1802 may be used in multiple areas of the galvanizing facility, with different instances of the NIO platform 1802 configured as needed to perform various tasks required for the specific area in which a particular instance has been deployed. As described previously, the NIO platforms 1802 may communicate with one another and may be organized in a tiered system with services distributed across the NIO platforms in whatever way is desired. The following description is directed to one embodiment of the galvanizing facility and how the NIO platform may be used in such an environment.

The galvanizing facility has a general operational flow in which products to be galvanized serve as an input as indicated by arrow 5502. A product arrives in a drop off area 5504 and typically remains there until it is moved to a staging area 5506. At the staging area 5506, the product is prepared for the galvanizing process. The preparation may include tagging the product (e.g., attaching a passive or active tag with product information and location tracking capabilities) and hooking the product to a crane (not shown). Large products may be moved individually using chains or wires, and smaller products may be moved in groups using chains, wires, or a mechanism such as a rack to which the smaller products are attached.

The product is then moved by the crane through a series of process tanks, which may include dipping the product in some or all of a clean tank 5508, a rinse tank 5510, an acid tank 5512, a rinse tank 5514, and/or a preflux tank 5516. Each tank 5508-5516 is associated with one or more parameters, such as a fluid level, a temperature, and/or a pH level (e.g., for the acid tank 5516). Burners or other heating elements (not shown) may be located proximate to (e.g., underneath or beside) or within a particular tank 5508-5516, or may be located elsewhere with a heat transfer mechanism to transfer the heat to the tank, for temperature control of the tank's liquid.

Each tank 5508-5516 may also be serviced by a pipe system (not shown) that is used to fill the tank with the appropriate liquid or liquids and to allow the tank to be drained. At each tank 5508-5516, the product generally remains in the tank for a particular period of time before being moved to the next tank. It is understood that multiple tanks may be present for a particular stage (e.g., there may be multiple acid tanks 5512) to enable the process to handle multiple products simultaneously and/or to allow for repeated dipping (e.g., multiple sequential rinse tanks to ensure that the product is thoroughly rinsed).

Once the product has moved through the process tanks 5508-5516, the product may be placed in a drying area 5518 where the pre-flux is allowed to dry. The product is then moved into a kettle 5520. For purposes of example, the kettle 5520 provides a liquid zinc bath that is maintained at a particular target temperature (e.g., between 830 and 840 degrees Fahrenheit) by burners associated with the kettle 5520. The kettle 5520 may also have a vent hood that is used to remove fumes resulting from the zinc bath. The product typically remains in the zinc bath until a particular product temperature is reached and is then removed from the bath and placed in a cooling/inspection area 5522. After the product has cooled and been inspected, the now finished product is moved to a pickup area 5524 and serves as an output as indicated by arrow 5526.

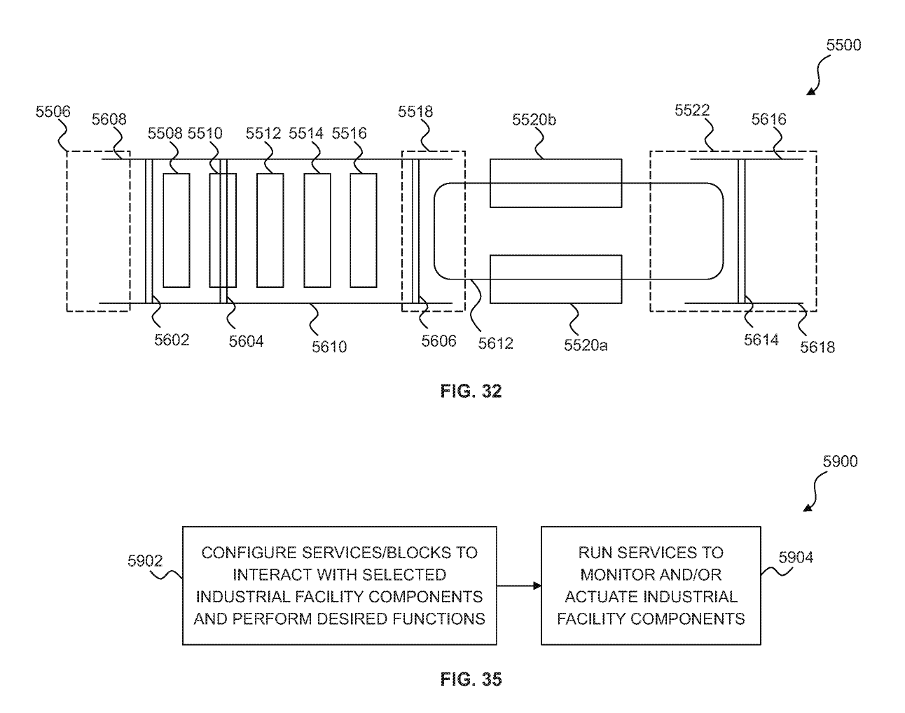

Referring to FIG. 32, another embodiment of the environment 5500 of FIG. 31 illustrates a particular arrangement of the areas and equipment of FIG. 31 and further includes multiple cranes. More specifically, one or more bridge cranes 5602, 5604, and 5606 are positioned on supporting rails 5608 and 5610. The bridge cranes 5602, 5604, and 5606 are used to move products from the staging area 5506, through the process tanks 5508-5516, and to the drying area 5518. As the bridge cranes 5602, 5604, and 5606 are sequential in the present example (e.g., the crane 5602 cannot move past the crane 5604), a product may be transferred from one crane to another by lowering the product into a process tank or to the floor, disconnecting the product from one crane, and coupling the product to the next crane.

A monocrane 5612 is used to move the products from the drying area 5518 into the kettle 5520a or 5520b. A galvanizing facility frequently has one operational kettle, but may be designed to allow the process flow to switch to a second kettle during repairs or replacement of the first kettle. In some facilities, both kettles 5520a and 5520b may be active simultaneously. The monocrane 5612 also moves the products from the kettle 5520a/5520b to the cooling area 5522. In some embodiments, one or more quench tanks (not shown) may be positioned between the kettle 5520a/5520b and the cooling/inspection area 5522.

Another bridge crane 5614 may be positioned on supporting rails 5616 and 5618. The bridge crane 5614 may be used to move products within the cooling/inspection area 5522. Once finished, the products are ready to be moved to the pickup area 5524.

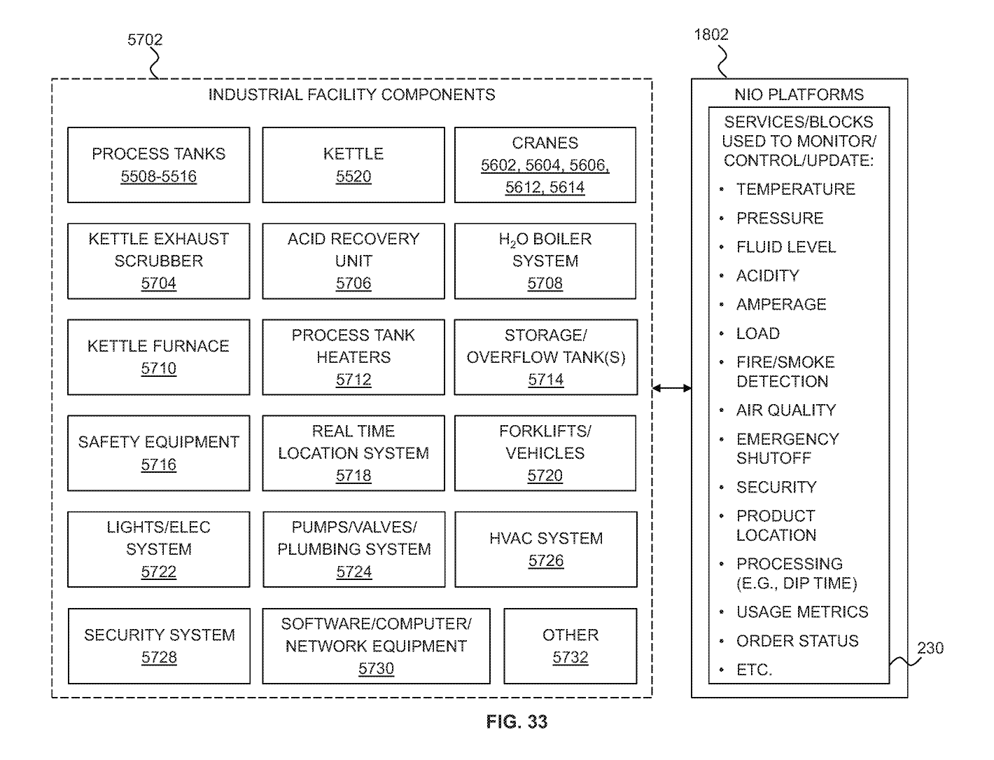

Referring to FIG. 33, one embodiment of the environment 5500 illustrates facility components 5702 and NIO platforms 1802 with services 230. The galvanizing process performed within the environment 5500 may use many different components, including various types of equipment such as process tanks 5508-5516, kettle 5520, cranes 5602, 5604, 5606, 5612, and 5614, a kettle exhaust scrubber 5704, an acid recovery unit 5706, a water boiler system 5708, a kettle furnace 5710, process tank heaters 5712, and storage and overflow tanks 5714. The environment 5500 may also include safety equipment 5716, a real time location system 5718, various forklifts and other vehicles 5720, lights, wiring, transformers, electrical panels, and other electrical system components 5722, pumps, valves, and other plumbing components 5724, a heating, ventilation, and air conditioning (HVAC) system 5726, a security system 5728, software, computers, and network equipment (e.g., gateways, routers, and switches) 5730, and other components 5732.

Each facility component 5702 includes its own operating parameters and operation outside of the parameters may result in lower efficiency or complete failure, which in turn may result in delay across the entire production line and/or improperly galvanized products. Furthermore, the overall environment may be relatively hazardous due to factors such as extremely high temperatures in the kettle 5520, natural gas lines for the burners, open tanks of acid, fumes that can negatively affect air quality, and overhead cranes moving large pieces of metal. Monitoring the facility components 5702 can therefore be a matter of safety as well as galvanizing process efficiency.

The NIO platforms 1802 can be configured to interact with, monitor, and/or control some or all of the facility components 5702. This includes both the components directly involved in the galvanizing process (e.g., the pH level of the acid tank 5512 and the temperature of the zinc bath in the kettle 5520) and components needed within the facility in general (e.g., lights). As shown, the services 230 and their corresponding blocks can be configured to handle many different functions, including temperature, pressure, fluid level, acidity, amperage, crane load, fire and smoke detection, air quality, emergency shutoff, product location, processing steps and actions, usage metrics, order status, and other functions.

The services 230 may be integrated with each other and the facility components 5702 in many different ways to increase visibility and improve efficiency within the environment 5500. For example, an industrial process typically has one or more bottlenecks that limit the overall throughput of the process. In the present example directed to hot dip galvanizing, the kettle 5520 is generally a bottleneck as only a single kettle is usually operational and each product requires a certain amount of time in the kettle's zinc bath.

Complicating the scheduling and control of the process around the bottleneck is the fact that the overall flow may be non-uniform. More specifically, the products to be galvanized may vary significantly in size and shape. This means that the processing time required for a particular product or group of products varies depending on factors such as the size and thickness of the product, the amount of heat available to maintain the temperature of the zinc bath, and similar factors. Furthermore, the operational functionality of the equipment also impacts the process, as a malfunction or failure in equipment such as a crane 5602, 5604, 5606, 5612, or 5614, a process tank 5508-5516, or the kettle 5520 can negatively impact the overall throughput or can stop the process flow completely until the problem is addressed.

The process flow may also be impacted by external factors, such as customer agreements that give priority to certain products, the timing of drop off and pickup for particular orders, and similar issues. Various safety regulations and other legal obligations may also impact the process by specifying worker and equipment safety requirements, reporting requirements, pollution control measures, and similar obligations. Accordingly, there are many different factors that may impact the process flow within a particular industrial environment. An environment that contains multiple facilities may introduce even more complications due to the need to account for and coordinate many different inputs and outputs.

The NIO platform 1802 may be used in multiple areas of the galvanizing facility, with different instances of the NIO platform 1802 configured as needed to perform various tasks required for the specific area in which a particular instance has been deployed. As described previously, the NIO platforms may communicate with one another and may be organized in a tiered system with services distributed across the NIO platforms in whatever way is desired.

By positioning the NIO platform 1802 wherever needed throughout the environment 5500 and configuring each NIO platform instance to communicate with the desired facility components 5702, a single platform solution can be used to provide real time or near real time monitoring and control of the galvanizing facility. For example, parameters associated with the cranes 5602, 5604, 5606, 5612, or 5614, process tanks 5508-5516, and kettle 5520 can be monitored and controlled in real time. Safety equipment 5716 (e.g., cameras and fire/smoke detectors) can also be monitored and actuated. For example, if a fire is detected, alarms may be triggered, notifications may be sent, gas valves may be automatically closed, and other safety procedures may be initiated.

The NIO platform 1802 can also be used to track the movement of a product through the galvanizing process, provide real time updates on progress and/or location, and update an inventory system to show totals such as amount of zinc used, amount of product handled per time unit, and similar information. More general facility information can also monitored and visualized, such as power consumption for the entire facility or for a particular facility component 5702.

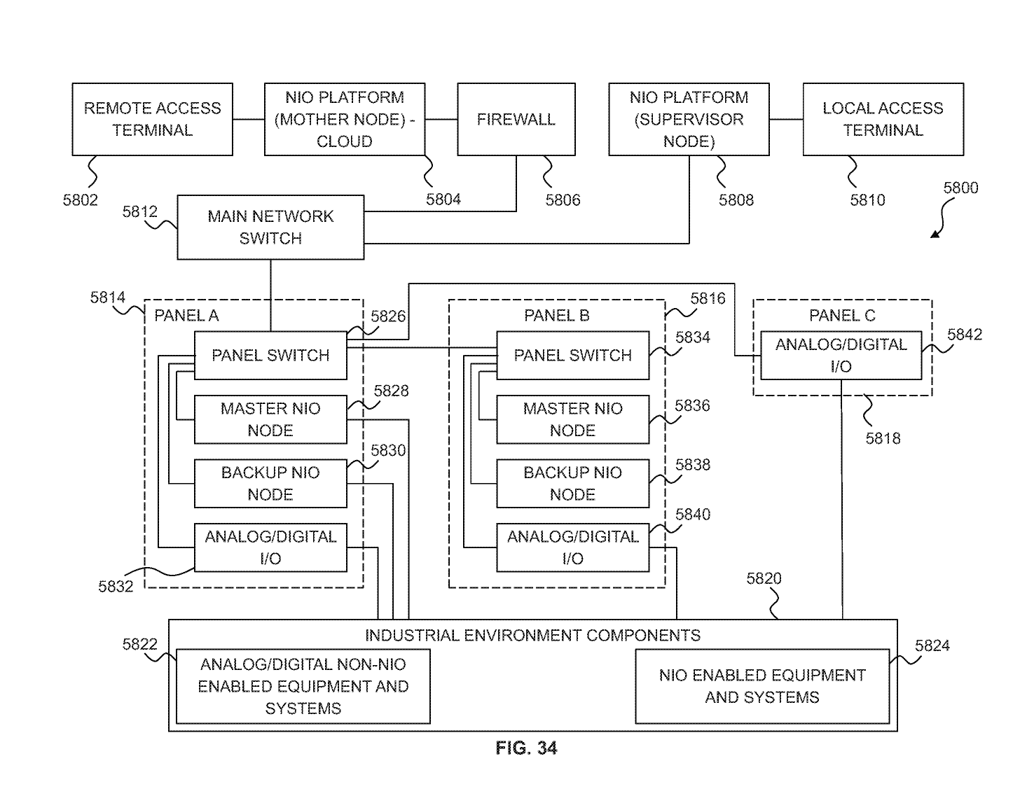

Referring to FIG. 34, one embodiment of a network environment 5800 illustrates how multiple NIO platforms may be distributed within the environment 5500 of FIG. 31. It is understood that the network environment 5800 is only one example of many possible implementations. The environment 5800 includes at least three tiers of NIO platforms with edge nodes, one or more supervisor nodes, and one or more mother nodes as described with respect to FIG. 9.

In the present example, a remote access terminal 5802 and a mother node 5804 are located outside of a firewall 5806 that forms the network boundary of the facility. A supervisor node 5808 and a local access terminal 5810 are located inside the firewall 5806. The firewall 5806 and the supervisor node 5808 connect to a main network switch 5812 that handles communication routing within the facility's internal network.

NIO platforms are positioned within two panels 5814 (Panel A) and 5816 (Panel B), and those NIO platforms may be edge nodes or non-edge nodes, depending on the particular equipment connected to the panel and/or depending on the particular implementation of the network environment. A third panel 5818 (Panel C) is not provided with a NIO platform in the present example. The panels 5814, 5816, and 5818 are coupled to facility components 5820, which may be similar or identical to the facility components 5702 of FIG. 33. The facility components 5820 may include analog and/or digital equipment and systems that are not provided with their own local/embedded NIO platform (e.g., are not NIO-enabled) and/or equipment and systems that are provided with their own local/embedded NIO platform (e.g., are NIO-enabled).

The panel 5814 includes a panel switch 5826, a master NIO node 5828, a backup NIO node 5830, and one or more analog and/or digital I/O components 5832. The panel 5816 includes a panel switch 5834, a master NIO node 5836, a backup NIO node 5838, and one or more analog and/or digital I/O components 5840. The panel 5818 contains one or more analog and/or digital I/O components 5842.

In the present example, the panel switch 5826 of the panel 5814 is coupled to the main network switch 5812, the master NIO node 5828, the backup NIO node 5830, the I/O components 5832, the I/O components 5842, and the panel switch 5834. The master NIO node 5828 may be directly coupled to various facility components 5820 and/or may be coupled to various facility components 5820 via the I/O components 5832. The backup NIO node 5830 may be identical to the master NIO node 5828 in both configuration and connections to the facility components 5820, but is generally not active unless needed. For example, the supervisor node 5808 may monitor the master NIO node 5828 and activate the backup NIO node 5830 if a failure or other fault is detected in the master NIO node 5828.

The panel switch 5834 of the panel 5816 is coupled to the panel switch 5826, the master NIO node 5836, the backup NIO node 5838, and the I/O components 5840. However, unlike the master NIO node 5828 and the backup NIO node 5830 of the panel 5814, the master NIO node 5836 and the backup NIO node 5838 are only coupled to the I/O components 5840 and not directly to the facility components 5820.

The master NIO nodes 5828 and 5836, either alone or in coordination with the supervisor node 5808 and/or mother node 5804, may be configured with services to monitor, actuate, and otherwise interact with and control various processes within the facility. For purposes of simplicity, the master NIO node 5828 will be used in the following example, but it is understood that the services may be distributed across multiple NIO platforms as previously described.

Assume a product is placed in the staging area 5506 of FIG. 31 for processing. A wireless tag with location functionality is affixed to the product and the product is coupled to one of the cranes 5602, 5604, and 5606. The location of the product is sent to the master NIO node 5828, which enables the master NIO node 5828 to tie the tag ID to the product and track the product's location. By tracking the product's location, the product's current place in the galvanizing process can be monitored because the location can be checked against the facility's layout. For example, the product's location can be compared to a set of coordinates for a particular piece of equipment within the facility.

Load cell information from the crane can also sent to the master NIO node 5828, as well other information such as a temperature of the crane's motor box and the amperage being drawn by the crane. This information may be used to monitor the health of the crane, as well as to calculate a pre-galvanized weight of the product before the product is dipped in the process baths or after the product is dipped in the process baths and prior to the zinc bath. Furthermore, this information enables a safety check to be performed, as the crane's information can be monitored to ensure the crane's load does not exceed its rated hoist capacity. If the product is too heavy for the crane, the master NIO node 5828 can trigger an alarm (e.g., an audible and/or visual indicator), automatically shut the crane down, and/or take other safety measures.

As the crane or cranes move the product through the process tanks 5508-5516, the location of the product is reported via the wireless tag. The specifics of each process tank, such as fluid level, temperature, acidity, and/or other information can be monitored and regulated as needed by the master NIO node 5828. If configured to do so, the master NIO node 5828 may also control the crane(s) based on time in tank and/or similar triggers to automate the movement of the product. The product then arrives in the drying area 5518 and is transferred to the monocrane 5612, which dips the product into the zinc bath of the kettle 5520.

In some embodiments, the master NIO node 5828 may monitor a temperature of the product in the kettle 5520 and, when the appropriate temperature is reached, may lift the product from the zinc bath or indicate that the product is ready to be removed from the bath. Traditional galvanizing methods frequently result in a zinc layer that is thicker than needed because it is difficult to tell when the correct thickness has been reached. Because the product is typically left in the zinc bath for longer than necessary to ensure that the zinc layer is sufficiently thick, both processing time and zinc are wasted. Accordingly, the ability to automatically detect when the product's temperature reaches the level indicating that the galvanizing process is complete may minimize processing time and prevent the use of extra zinc.

The product is then placed in the cooling/inspection area 5522 and, once inspected, to the pickup area 5524. The master NIO node 5828 may report the current galvanized weight of the product, which can be used with the pre-galvanized weight to enable calculation of the amount of zinc used to galvanize the product. At this point, the master NIO node 5828 can report to an order/inventory system (e.g., part of the software 5730) that the product has been galvanized.

During the processing, the master NIO node 5828 may be monitoring for fire, smoke, unauthorized access, and other safety and/or security issues. This enables the master NIO node 5828 to react if needed. For example, if a fire is detected, the master NIO node 5828 may turn off one or more gas valves (if natural gas is used), sound an alarm, send alerts, stop all cranes, and/or perform other actions. Each action may include various substeps. For example, if a fire is detected, the master NIO node 5828 may execute a series of actions for each crane depending on a state of the particular crane. This may include lifting all products currently coupled to a crane from the process tanks and zinc bath and/or lowering any currently lifted product to ground level. Due to the configurability of the services 230 on the master NIO node 5828, any step or set of steps can be configured as desired. Furthermore, the services 230 can communicate so that an output of a fire detection service can be used to trigger a crane emergency shutdown service.

In addition, the ability to monitor the facility components 5702 and track each tagged product can be used to identify the facility's throughput and bottlenecks. For example, the product's time in the staging area 5506 (after being tagged), time in each process tank 5508-5516, time in the drying area 5518, time in the kettle 5520, time in the cooling/inspection area 5522, etc., can be monitored and reported on a per tag basis. Equipment usage may also be tracked, such as the time each crane is used or idle, the location of a crane, the amount of time the kettle 5520 is in use (e.g., as determined by monitoring the kettle's doors and/or the location of the monocrane's hoists), and similar factors.

Visualization of the various parameters, product locations, component status, and similar information may be available locally (e.g., via local access terminal 5810 or another interface device, such as a tablet or laptop computer) and remotely (e.g., via the remote access terminal 5802 or another interface device). This enables both current and historical information of the facility to be viewed regardless of the viewer's location. Furthermore, if enabled, parameters may be modified, various facility components may be activated or deactivated, and actuations may be performed via the NIO platforms.

By examining the movement of products and/or the usage of equipment, current stoppages can be addressed more quickly and determinations can be made as to how the process workflow may be improved. For example, if the kettle 5520 is empty for thirty consecutive minutes, one of the facility's main bottlenecks is not even acting as a current bottleneck. The process flow can then be adjusted accordingly. Furthermore, products and groups of products can be prioritized and scheduled to ensure the facility is operating at maximum capacity and to manage priority agreements with customers. Because the NIO platform can be configured to communicate with any desired facility component 5702, process information in real time or near real time, and monitor, actuate, update, and/or send data for visualization in real time or near real time, a current status of the facility can be monitored and control can be exerted using the NIO platform as a single solution regardless of the type of facility and the various processes executed by the facility.

Referring to FIG. 35, one embodiment of a method 5900 illustrates a process that may be executed within the environment 5500 of FIG. 31. For example, the method 5900 may be used with one or more of the mother node 5804, supervisor node 5808, master NIO nodes 5828 and 5836, and/or backup NIO nodes 5830 and 5838 of FIG. 34. In step 5902, various services 230 and blocks 232 are configured to interact with selected facility components 5702 and perform desired functions as described previously. In step 5904, the services are run to monitor and/or actuate various facility components 5702.

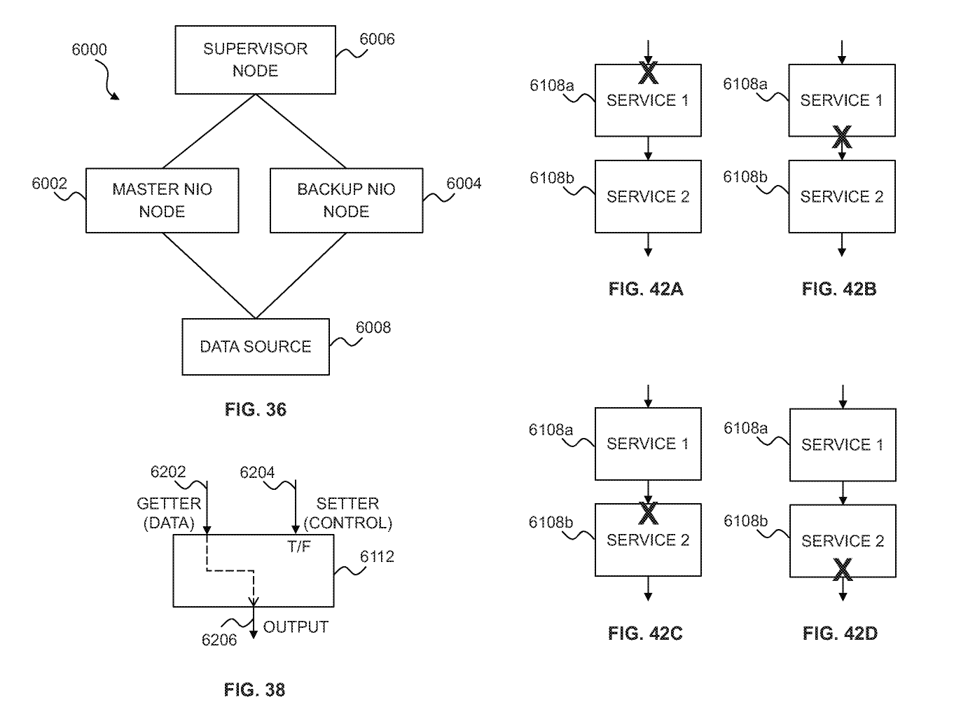

Referring to FIG. 36, one embodiment of an environment 6000 illustrates a master NIO node 6002 (which may be similar or identical to the master NIO node 5828 of FIG. 34) and a backup NIO node 6004 (which may be similar or identical to the backup NIO node 5830). Both the master NIO node 6002 and the backup NIO node 6004 are coupled to a supervisor node 6006 (which may be similar or identical to the supervisor node 5808) and to a data source 6008 (which may be similar or identical to the components 5820 and/or any other data source, whether analog or digital). At any given time, one of the master NIO node 6002 and the backup NIO node 6004 is designated as an active node and the other node is designated as a passive node. As will be described below, the passive node may continue processing information, but the designation of passive prevents certain actions from being taken by the node. For purposes of illustration, the master NIO node 6002 will generally be considered to be the active node in the following description unless other indicated.

In real time processing, incoming data from the data source 6008 must be processed as it is received since the data is not stored in a database or other storage prior to processing. However, while the data is received and processed in real time, a level of persistence may be needed in some cases. For example, state information of an external device may be used by a service running on the master NIO node 6002 and the state may affect how the processing is performed. In another example, persistence may be needed for functions such as monitoring for anomalies in a data stream, where a certain amount of historical data is required for comparison purposes. In yet another example, a service may perform calculations that require both current and historical data, such as maintaining a running average for a particular characteristic of a device.

Accordingly, two possible issues may arise if the master NIO node 6002 performing the real time processing malfunctions or otherwise becomes unavailable. The first issue is that real time data may be lost. While the backup NIO node 6004 may be started and brought online as a replacement, the time delay may result in the permanent loss of data that was sent to the master NIO node 6002 between the master NIO node's failure and the backup NIO node 6004 coming online. It is understood that the data loss depends on such factors as the data rate and the time between the master NIO node's failure and the backup NIO node's activation. In some scenarios, therefore, there may be no data loss at all if the time period between the master NIO node's failure and the backup NIO node's activation is short enough to ensure that the backup NIO node 6004 receives any data that was not received by the master NIO node 6004. The amount of data lost (if any) is affected by the length of this time period and the data rate.

The second issue is that persistence information may be lost, which is an issue that occurs only when such information is used by the master NIO node 6002. In cases where persistence information is used, the backup NIO node 6004 coming online will likely not be an exact replacement of the master NIO node 6002 since the backup NIO node 6004 will not have the needed persistence information required to seamlessly take over the tasks of the master NIO node 6002. Even when the backup NIO node 6004 eventually achieves a full level of persistence information, the baseline will be the newer persistence information of the backup NIO node 6004 and will not include historical information that predates the backup NIO node's activation.

To address these issues, the master NIO node 6002 and the backup NIO node 6004 may be configured to run simultaneously. This simultaneous operation allows both the master NIO node 6002 and the backup NIO node 6004 to remain current in terms of the information being processed. However, if the master NIO node 6002 and the backup NIO node 6004 both operate normally (e.g., if both operate as the active node), there may be a negative impact on performance within the environment 6000 due to issues such as conflicts, race conditions, unnecessary numbers of reads/writes, unnecessary resource usage (e.g., CPU and memory usage), and/or unnecessary bandwidth usage. To prevent such issues from occurring, both NIO nodes should maintain a certain level of real time processing, but only one of the two NIO nodes should produce a particular output and/or obtain a particular input. This may be accomplished as follows.

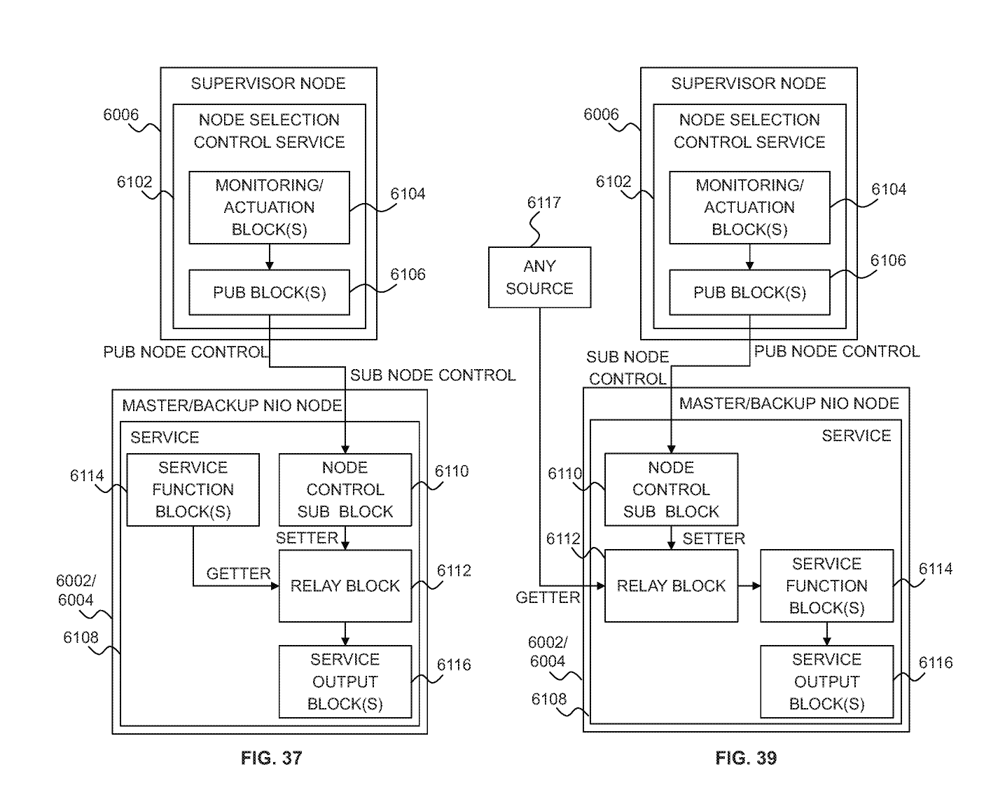

Referring to FIG. 37, in one embodiment, the supervisor node 6006 includes one or more node selection control services 6102 for controlling which of the master NIO node 6002 and backup NIO node 6004 is currently selected as the active node. The node selection control service 6102 publishes to a channel (named NODE CONTROL in the present example) to toggle the functionality of various services on the master NIO node 6002 or the backup NIO node 6004. The node selection control service 6102 may be used to control the internal functions of a single service and may also be used to turn the service on and off. The node selection control service 6102 includes one or more monitoring/actuation blocks 6104 and one or more publication blocks 6106. It is understood that the node selection control service 6102 may not be used exclusively for failover events, but may simply control which of the master NIO node 6002 and backup NIO node 6004 is the active node. Accordingly, the node selection control service 6102 may be used in situations that do not involve failover, such as switching to one of the nodes while the other node is updated or replaced.

In the present example, there are no services running on either the master NIO node 6002 or the backup NIO node 6004 to support the node selection control functionality. Instead, two blocks are added to each service (represented as a generic service 6108) on the master NIO node 6002 and the backup NIO node 6004 that is affected by switching between the two nodes. These two blocks are a subscription block 6110 and a relay block 6112. The subscription block 6110 subscribes to the NODE CONTROL channel (or uses another signal or messaging mechanism selected for this purpose) and the output is passed to the relay block 6112. The relay block 6112 either allows or prevents the service 6108 from publishing information (or taking other output action), allows or prevents the service 6108 from obtaining information, and/or allows or prevents processing at some other point in the service 6108.

These two blocks enable the configuration of how a node selection event is handled on a per service basis, which provides a great deal of flexibility in how the services of the master NIO node 6002 and the backup NIO node 6004 can be set up to handle switching between the two nodes. It is understood that the functionality provided by the two blocks 6110 and 6112 may be combined into a single block or separated into three or more blocks.

With additional reference to FIG. 38, one embodiment of the relay block 6112 is illustrated. As shown, the relay block 6112 includes two inputs: a GETTER input 6202 and a SETTER input 6204. The GETTER input 6202 is a data input that obtains information from the natural processing flow of the service 6108. For example, if the relay block 6112 is inserted into the service 6108 as shown in FIG. 37, the GETTER input 6202 would be the output of the service function blocks 6114. Without the relay block 6112, the output would go directly to the service output blocks 6116. However, with the relay block 6112 inserted as shown, the output of the service function blocks 6114 will only reach the service output blocks 6116 if permitted by the relay block 6112.

The SETTER input 6204 is a control input that sets a state within the relay block 6112 that determines whether the GETTER input 6202 will be allowed to pass through the relay block 6112. For example, the state may have the values of TRUE or FALSE. If the current state (as set by the last SETTER input signal) is TRUE, then the GETTER input 6202 will be allowed to pass through the relay block 6112 to the output 6206. If the current state (as set by the last SETTER input signal) is FALSE, then the GETTER input 6202 will not be allowed to pass through the relay block 6112.

An example of a control signal for the SETTER input 6204 may be in the statement form: {{True if (([[MASTER NODE]] and $active_node==“master”) or (not [[MASTER_NODE]] and $active node==“backup”)) else False}}. In the statement, MASTER_NODE is the boolean environment variable that declares if that node is the master node or not. $active_node is the variable that specifies which node should be active. Each of the NIO nodes 6002 and 6004 assess this statement based on whether it is currently the active node or not, and sets its state to TRUE or FALSE accordingly. In the present example, the SETTER input 6204 is obtained from the node selection control service 6102 by the subscription block 6110 and passed to the relay block 6112.

In some embodiments, the relay block 6112 may be replaced by other mechanisms. For example, a particular block in the service 6108 could be stopped or started based on the passive state or active state of the node on which the block is running. This would prevent the block from processing information and would stop any downstream blocks from receiving information. However, unless addressed, this mechanism may also result in error messages and/or other issues.

Referring again to FIG. 37, the positioning of the relay block 6112 within the service 6108 determines how the service 6108 will operate when the node running the service is in the passive state. As illustrated in FIG. 37, the relay block 6112 can be placed towards the end of the service 6108 after any service function block(s) 6114 and before any publication block(s) 6116. This placement means that the service 6108 will operate normally (e.g., will receive and process data just as it would if the node was active), but will not publish any information. This keeps the service 6108 in sync with the identical service on the other node, but prevents the service 6108 from producing output. State information and/or other persistence information can therefore be maintained by the service 6108 even though the service 6108 is running on the node that is not currently the active node.

Accordingly, the use of the relay block 6112 enables services to be controlled on a per service basis on the master NIO node 6002 and the backup NIO node 6004 using the output of the node selection control service 6102 running on the supervisor node 6006. This enables each service to be configured in a standardized manner without requiring changes to other services or the node selection control service 6102.

Furthermore, in some embodiments, a relay block 6112 may be used in a service, but set to allow throughput regardless of the state passed to it by the node selection control service 6102. For example, the subscription block 6110 may be disabled and the state of the relay block 6112 may be set as desired, or the subscription block 6110 may operate normally and the state of the relay block 6112 may be set as desired and locked to prevent its state from being changed while locked. This enables, among other things, every service to be built with a relay block 6112 (e.g., for consistency in service creation) and then allows the relay block 6112 to be bypassed if not needed.

It is understood that the subscription block 6110 may also be set to obtain state information from channels other than the NODE CONTROL channel. This, particularly when combined with the many ways to position relay block(s) within a service, enables additional flexibility in the control of a particular service by allowing a user to define a specific channel or other message mechanism for use in controlling a relay block in that service.

Referring to FIG. 39, in another embodiment, the relay block 6112 may be placed at the beginning of the service 6108. This placement means that the service 6108 will either receive data and operate normally or not receive data and not operate normally. This may be useful in certain cases. For example, assume the service 6108 is to perform a read on an external device via a serial connection and a write must be performed to the device before the read is performed. Rather than allowing the services on both the master NIO node 6002 and the backup NIO node 6004 to perform the write/read process, the service on the passive node can be prevented from performing the write/read. This reduces the number of times the external device is accessed. One example of this is the use of a serial read block that is one of the service function blocks 6114. The serial read block may be triggered when a signal is input to the serial read block. While the “driving” signal is not part of the service function blocks 6114, the signal is the trigger that the relay block 6112 may prevent from reaching the serial read block. The GETTER input may be from any applicable source 6117 and may be either external or internal to the NIO node on which the relay block 6112 is located (although shown as an external source in FIG. 39). When the passive node is switched to active status, the newly active node can perform the write/read and obtain up to date information. It is noted that in this case the two services are not synchronized, but the nature of the serial connection generally prevents exact synchronization from occurring even if both are actively writing and reading.

In some embodiments, to address the synchronization issue with respect to a serial connection and in other scenarios where such an approach may be useful, a single service may be used to read from the external device and then publish to a channel that both of the services needing the information could subscribe to. This would enable both services to be synced correctly and then each service could publish or not publish the information depending on whether the service is running on the active node or the passive node. For example, this may be accomplished using a combination of the embodiments of FIGS. 37 and 39. In this case, both the master NIO node 6002 and the backup NIO node 6004 would have the service 6108 of FIG. 39 with the write/read functionality, but only the service on the active node would be allowed to perform the write/read. That service could then publish the information to be used by the service 6108 of FIG. 37 on both nodes, which could both process the data normally and either produce or not produce output depending on the node. Accordingly, various combinations of services and relay block positions may be used to achieve different types of desired control.

It is noted that the placement of the relay block 6112 at the beginning of the service 6108 may be used for services that do not need to be in sync. For example, if a service 6108 simply receives data and acts on the current input, the service on the passive node may not need to constantly process incoming data. This may be used if there is no need for historical data in a particular service, because no historical data will be present since any input to the service on the passive node will be blocked. Alternatively, it may be desirable to allow the service 6108 to process data and simply block the output as illustrated with respect to FIG. 37.

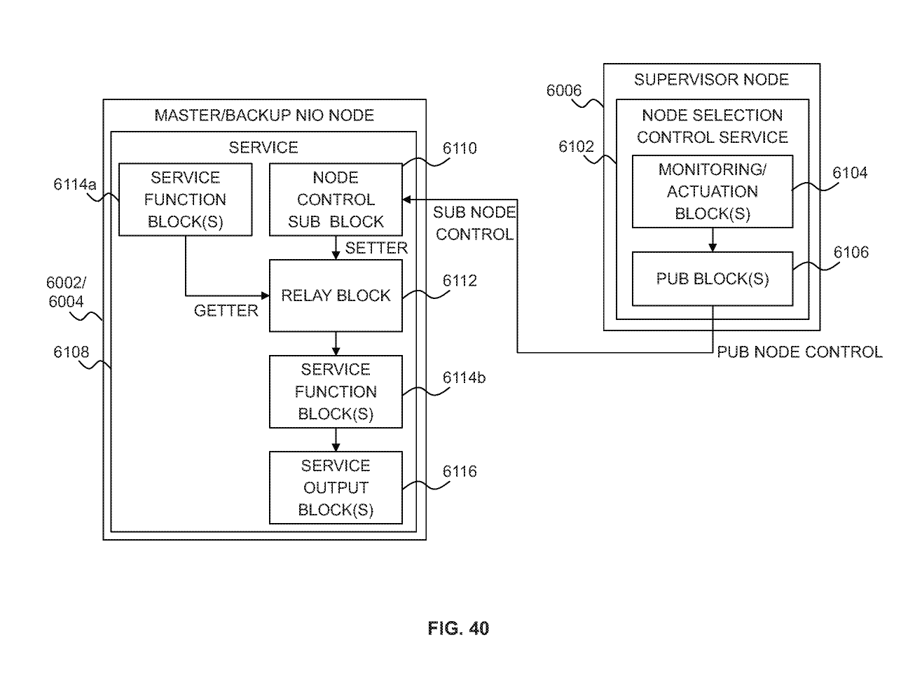

Referring to FIG. 40, in another embodiment, the relay block 6112 may be placed in the service 6108 between service function block(s) 6114a and 6114b. It is understood that FIG. 40 illustrates that the relay block 6112 may be located wherever desired in the service 6108 (e.g., before or after any particular block or blocks), as different services may have different needs in how each service is to operate when on the passive node.

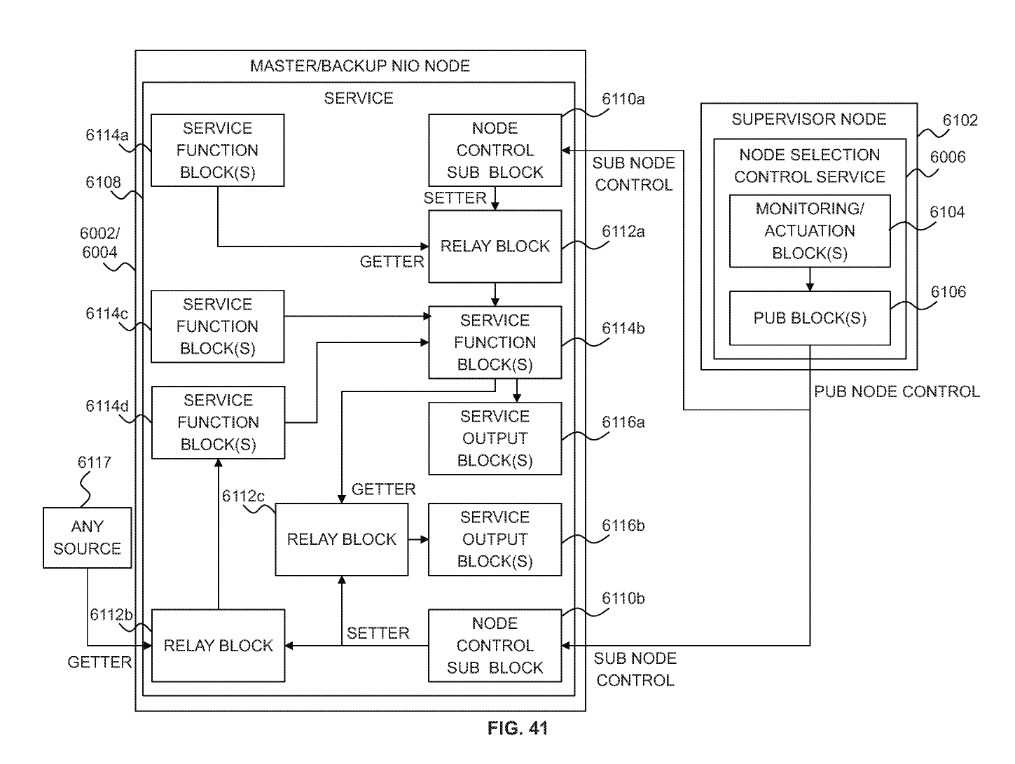

Referring to FIG. 41, in another embodiment, additional blocks have been added to the service 6108 of FIG. 40 to illustrate how a single service may contain different relay blocks that are positioned differently. By using multiple relay blocks 6112, the behavior of the service 6108 may be defined with a higher level of granularity. This may be particularly useful in services with multiple inputs and/or outputs to enable finer control over the various inputs and/or outputs.

In the present example, service function blocks 6114c and 6114d have been added to the service 6108. Neither of the service function block(s) 6114c and 6114d are affected by the relay block 6112a. The service function block(s) 6114c have no associated relay block. Accordingly, the service function block(s) 6114c receive any available input, perform any defined processing, and pass the output to the service function block(s) 6114b. The service function block(s) 6114d are associated with a relay block 6112b that controls whether the service function block(s) 6114d receive any input. The relay block 6112b receives input from a subscription block 6110b, although it is understood that the subscription blocks 6110a and 6110b may be the same block. The relay block 6112b may receive GETTER input from any applicable internal or external source 6117 as described with respect to FIG. 39.

The service output block(s) 6116a have no associated relay block and will output whatever is received from the service function block(s) 6114b. The service output block(s) 6116b are associated with a relay block 6112c that controls whether output from the service function block(s) 6114b is published. The relay block 6112c receives input from the subscription block 6110b, although it is understood that the relay block 6112c may have a separate subscription block.

Accordingly, by the placement and use of one or more relay blocks 6112 within the service 6108, the operation of the service can be defined when the service is running on the passive node. Depending on the level of control desired, a single relay block 6112 may be sufficient or multiple relay blocks 6112 may be used. Larger services may lend themselves more readily to multiple relay blocks, as different inputs and outputs may provide more avenues of control. It is understood that functionality may be distributed across one or more services to minimize the use of relay blocks if desired. For example, functionality may be divided into multiple services or combined into a single service based on, as least in part, the desired use of relay blocks 6112.

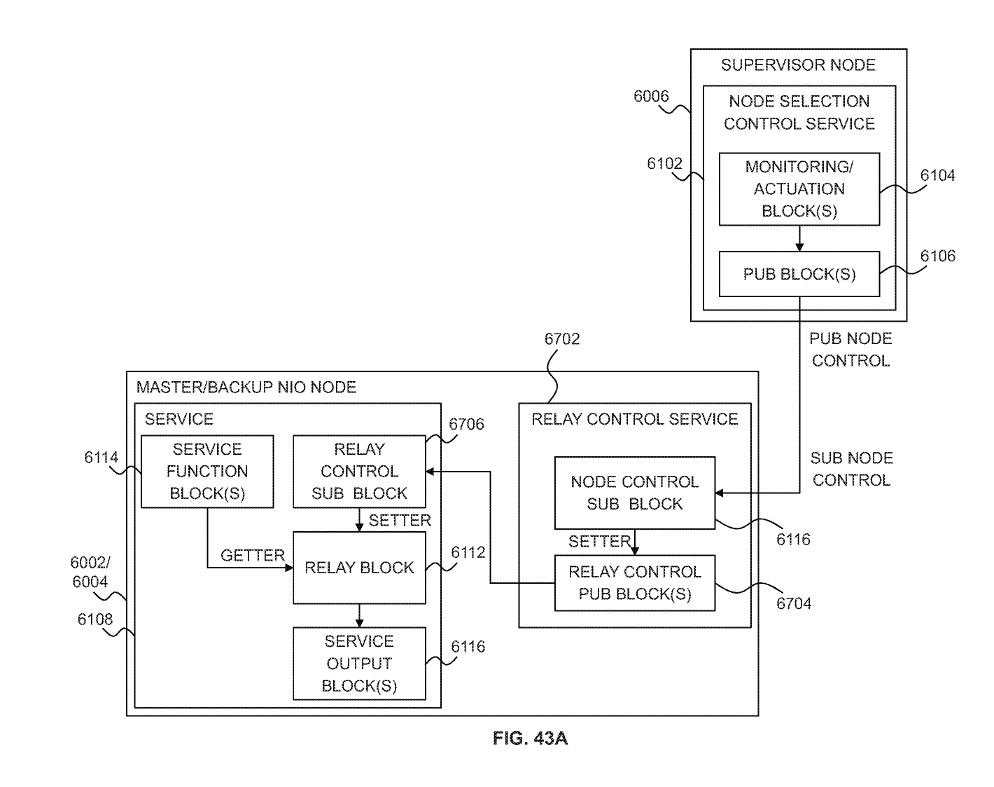

Referring to FIGS. 42A-42D, various embodiments illustrate how the relay block 6112 may be positioned with respect to two services 6108a and 6108b, where the service 6108a produces output that is an input to the service 6108b. As shown, a service may not need the subscription block 6110 and the relay block 6112. For example, if a second service only provides output to the service 6108 of FIG. 37, the second service may not need the blocks 6110 and 6112 because the service 6108 will handle whether or not publication occurs. Furthermore, the second service may need to continue running and passing information to the service 6108 to ensure that the service 6108 gets the information it needs. Similarly, if a second service is fed by the service 6108 of FIG. 39 and only processes data received from the service 6108, the second service may not need the blocks 6110 and 6112 because the service 6108 will either provide data or not provide data to the second service, and the second service will not operate any differently. It is understood that both services 6108a and 6108b may have relay blocks 6112 in other embodiments.

In FIG. 42A, the relay block 6112 (not shown) is positioned to block input to the service 6108a as represented by an “X”. This means the services 6108a and 6108b will receive information based on the state of the relay block 6112 in the service 6108a. Once information enters the service 6108a, it will be processed normally by both of the services 6108a and 6108b.

In FIG. 42B, the relay block 6112 (not shown) is positioned to block output from the service 6108a as represented by an “X”. This means the service 6108b will receive information based on the state of the relay block 6112 in the service 6108a, but enables the service 6108a to receive and process information without the limitation imposed by a relay block (unlike FIG. 42A).

In FIG. 42C, the relay block 6112 (not shown) is positioned to block input to the service 6108b as represented by an “X”. This means the service 6108b will receive information based on the state of the relay block 6112, but enables the service 6108a to receive, process, and output information without the limitation imposed by a relay block (unlike FIGS. 42A and 42B).

In FIG. 42D, the relay block 6112 (not shown) is positioned to block output from the service 6108b as represented by an “X”. This means the service 6108b will receive and process information without the limitation imposed by a relay block 6112 (unlike FIG. 42C), but will only output information based on the state of the relay block. The service 6108a may receive, process, and output information without the limitation imposed by a relay block (like FIG. 42C).

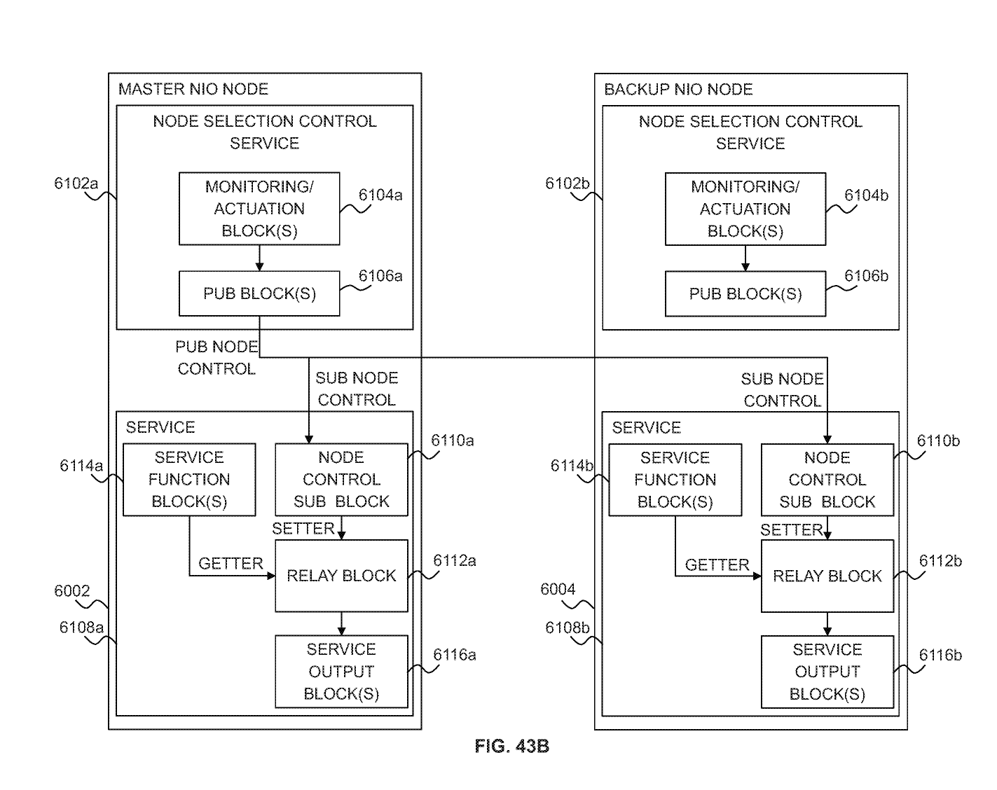

Referring to FIG. 43A, in another embodiment, a relay control service 6702 may be run on both the master NIO node 6002 and the backup NIO node 6004 node. The relay control service 6702 on each node may subscribe to the NODE CONTROL channel and publish the current node state using one or more relay control publication block(s) 6704 that broadcasts to a channel that is used by that node and subscribed to by the node's services. A relay control sub block 6706 may replace the subscription block 6110 of earlier embodiments. In some embodiments, the relay control service 6702 may identify the current state and publish only that state for receipt by the relay control sub block 6706 (e.g., so the services' relay blocks do not have to individually determine whether the state is TRUE or FALSE). In other embodiments, the relay control service 6702 may simply pass on the message from the node selection control service 6102, in which case the services may use a block that is similar or identical to the subscription block 6110 of earlier embodiments to determine whether the state is TRUE or FALSE.

Referring to FIG. 43B, in another embodiment, similar or identical functionality as that provided by the node selection control service 6102 of the supervisor node 6006 of FIG. 36 may be moved to the master NIO node 6002 and the backup NIO node 6004. Using the monitoring block(s) 6104a and 6104b, respectively, the master NIO node 6002 and the backup NIO node 6004 may monitor the status of the other node. For example, the node selection control service 6102a of the master NIO node 6002 may monitor the backup NIO node 6004, and the node selection control service 6102b of the backup NIO node 6004 may monitor the status of the master NIO node 6002. If an event occurs that requires the passive node to become the active node, the active node may notify the passive node to switch to active status (if the active node is able to do so) or the passive node may switch itself to active status (if the active node is unresponsive).

In this embodiment, while both of the node selection control services 6102a and 6102b may be running simultaneously, only the node selection control service on the active node will publish information. It is understood that this may require additional logic in the node selection control services 6102a and 6102b to accommodate different behavior models (e.g., publish or non-publish) when running in the active and passive states. In other embodiments, each of the master NIO node 6002 and the backup NIO node 6004a may run a separate service to monitor the other NIO node, and the node selection control service on the passive node may be started or provided information only if needed. In such embodiments, the monitoring functionality may be removed from the node selection control services 6102a and 6102b and moved to the new monitoring service.

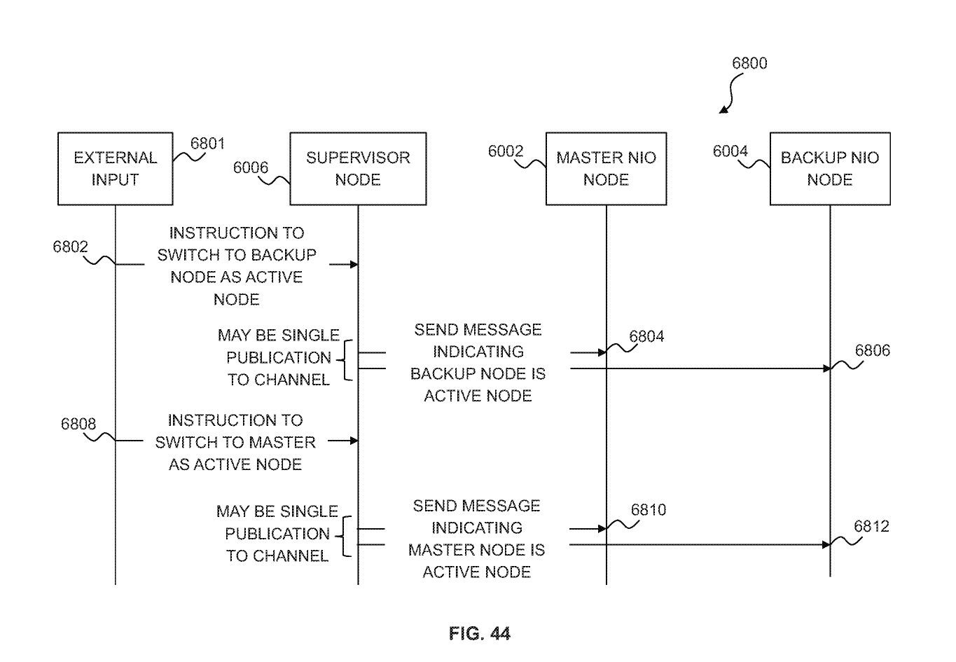

Referring to FIG. 44, one embodiment of a sequence diagram illustrates a process 6800 by which the supervisor node 6006 of FIG. 36 may switch between the master NIO node 6002 and the backup NIO node 6004. There are multiple methods by which switching between the master NIO node 6002 and the backup NIO node 6004 can occur. As shown in FIG. 44, one method is that the active node can be designated via an external input 6801 to the supervisor node 6006 (e.g., through the supervisor node's REST API). This is useful, for example, when updating the master NIO node 6002 and the backup NIO node 6004 because the passive node can be updated, and then the nodes can be switched to allow the other node to be updated.

Accordingly, in step 6802, the supervisor node 6006 receives an external input instruction to switch to the backup NIO node 6004 as the active node. In steps 6804 and 6806 (which may represent a single step), the supervisor node 6006 sends a message to the master NIO node 6002 and the backup NIO node 6004 designating the master NIO node 6002 as the passive node and the backup NIO node 6004 as the active node. As described previously, this may be accomplished by publishing a message to a channel (e.g., the NODE CONTROL channel) to which the subscription blocks 6110 are subscribed. However, it is understood that this may be any type of message and may be sent in various ways using different communication channels and/or protocols. If the supervisor node 6002 oversees different sets of master/backup NIO nodes, the message may include an identifier for the particular nodes being switched and/or may be sent along a channel to which only the nodes of interest are subscribed.

In step 6808, the supervisor node 6006 receives an external input instruction to switch to the master NIO node 6002 as the active node. In steps 6810 and 6812 (which may represent a single step), the supervisor node 6006 sends a message to the master NIO node 6002 and the backup NIO node 6004 designating the master NIO node 6002 as the active node and the backup NIO node 6004 as the passive node.

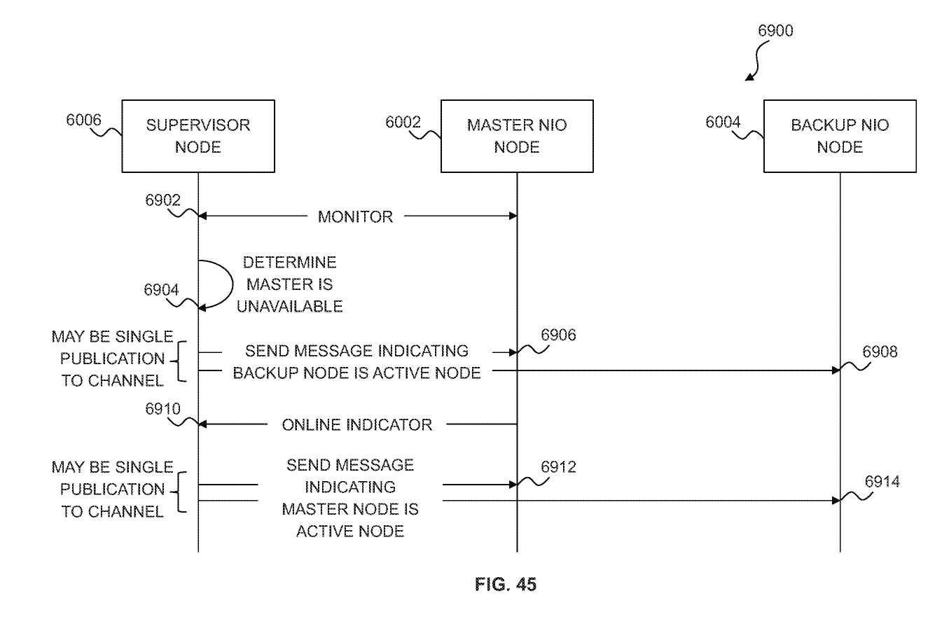

Referring to FIG. 45, in another embodiment, a sequence diagram illustrates a process 6900 by which the supervisor node 6006 of FIG. 36 may switch between the master NIO node 6002 and the backup NIO node 6004. As shown in FIG. 45, the supervisor node 6006 may monitor the active node (e.g., the master NIO node 6002) and switch when the node is determined to be unavailable.

Accordingly, in step 6902, the supervisor node 6006 monitors the master NIO node 6002. For example, the supervisor node 6006 may monitor a channel for a heartbeat of the master NIO node 6002 or may use another method to determine if the master NIO node 6002 is responsive. In step 6904, the supervisor node 6006 determines that the master NIO node 6002 is unavailable (e.g., the heartbeat has stopped).

The unavailability may be determined based on indicators that correspond to one or more monitoring criteria (which may include various threshold levels). If the monitoring indicates that the master NIO node 6002 may be unstable, the determination of unavailability in step 6904 is triggered. For example, an irregular heartbeat may indicate communication problems, hardware operating at full capacity (e.g., without sufficient CPU cycles to consistently maintain the heartbeat), and/or other issues that indicate that the master NIO node 6002 may not be able to adequately perform its functions. If one or more of these indicators meets a defined criterion, the master NIO node 6002 may be determined to be unstable. Accordingly, the determination of step 6904 may be based on various factors that are specific to a particular environment and required operating parameters within that environment.

In steps 6906 and 6908 (which may represent a single step), the supervisor node 6006 sends a message to the master NIO node 6002 and the backup NIO node 6004 designating the master NIO node 6002 as the passive node and the backup NIO node 6004 as the active node. As described previously with respect to FIG. 44, this may be accomplished in various ways. For purposes of example in the present embodiment, the supervisor node 6006 publishes a message to a channel (e.g., the NODE CONTROL channel).

In step 6910, the supervisor node 6906 receives an indicator that the master NIO node 6002 is available. For example, the master NIO node 6002 may publish to a management channel or reestablish the heartbeat. In some embodiments, the backup NIO node 6004 may remain the active node even after the master NIO node 6002 becomes available again. In such embodiments, the master NIO node 6002 may not become the active node until the backup NIO node 6004 becomes unavailable or another event occurs that makes the master NIO node 6002 the active node again. The process 6900 would then begin again with step 6902 being repeated with respect to the backup NIO node 6004.

In the present embodiment, however, the master NIO node 6002 is intended to be the active node whenever the master NIO node 6002 is available. Accordingly, in steps 6912 and 6914 (which may represent a single step), the supervisor node 6006 sends a message designating the master NIO node 6002 as the active node and the backup NIO node 6004 as the passive node. This may occur upon receipt of the message of step 6910 or may occur after a certain amount of time has passed to ensure that the master NIO node 6002 is stable.

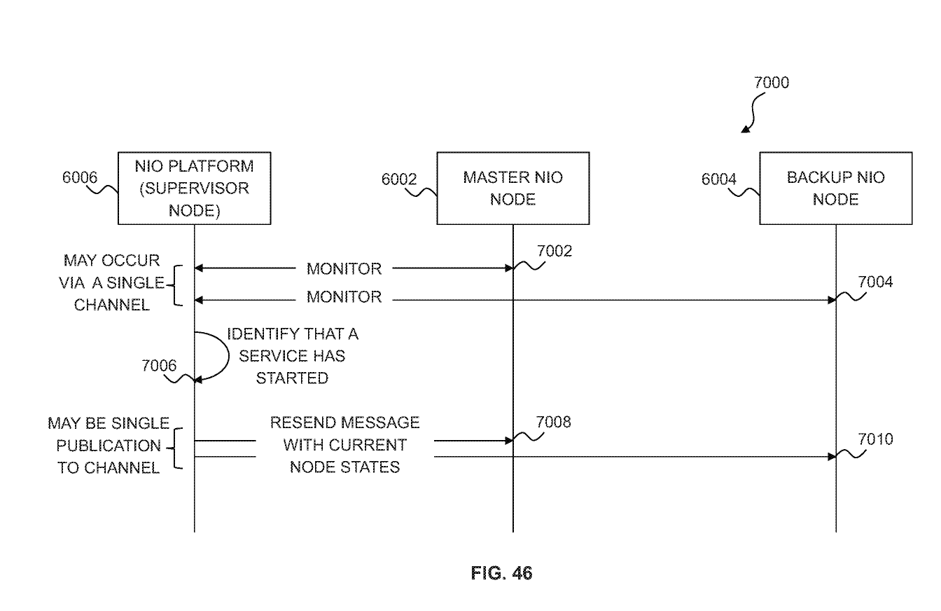

Referring to FIG. 46, in another embodiment, a sequence diagram illustrates a process 7000 by which the supervisor node 6006 of FIG. 36 may republish the node states (e.g., which node is active and which is passive) when a service 6108 is started on either the master NIO node 6002 or the backup NIO node 6004. Because the active and passive states operate on a per service basis through the use of the relay blocks 6112, a service 6108 that is not running when the node status was originally assigned may not have the correct state when the service 6108 is started. For example, the service 6108 may not have been running when the node was switched from passive to active. When the service 6108 is started, the service 6108 may be passive due to the previously stored state of its relay block 6112. To address this, the supervisor node 6006 may republish the active and passive states when it detects that a service 6108 has started on either of the master NIO node 6002 or the backup NIO node 6004.

Accordingly, in steps 7002 and 7004 (which may represent a single step), the startup of a service 6108 may be detected through the management channel or by other means. For example, each service that starts may publish a message to the management channel indicating that the service has started. In step 7006, the supervisor node 6006 identifies that a service 6108 has started.

In steps 7008 and 7010 (which may represent a single step), the supervisor node 6006 sends a message designating the master NIO node 6002 as the active node and the backup NIO node 6004 as the passive node. While this is not changing the designation of either node, it is understood that the message may be the same message used to change the node designations. In that sense, the message is simply a republication of the previous message designating the node states.

In some embodiments, there may be a defined period of time during which this republication does not occur in order to prevent a rapid series of publications when multiple services are starting (e.g., at node startup). For example, the republication may occur only after no service has started for a certain number (e.g., five) of seconds. This ensures that services being started will receive the correct state information, but prevents flooding the channel with redundant messages.

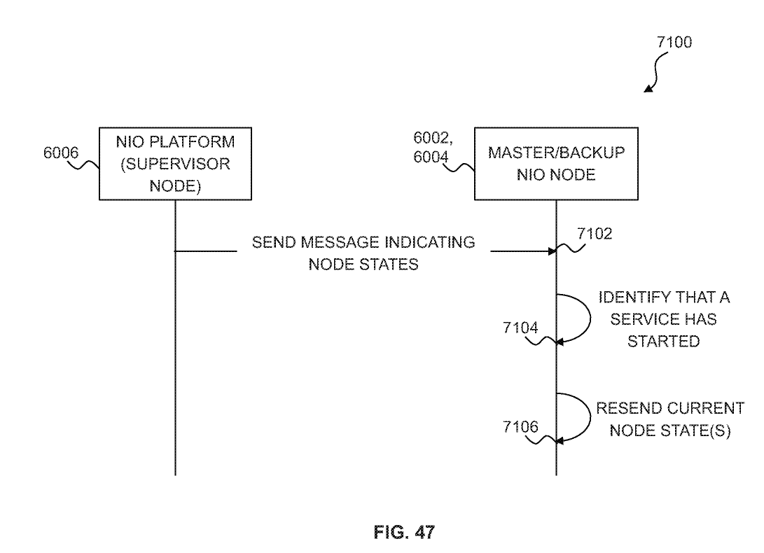

Referring to FIG. 47, in another embodiment, a sequence diagram illustrates a process 7100 by which the master NIO node 6002 or the backup NIO node 6004 of FIG. 36 may republish the node states when a service 6108 is started on the respective node. In this embodiment, the master NIO node 6002 and the backup NIO node 6004 may store the current state and update any services that are started after the state has been received.

Accordingly, in step 7102, the supervisor node 6006 sends the node states to the master NIO node 6002 and the backup NIO node 6004 as previously described. In step 7104, the startup of a service 6108 may be detected by the master NIO node 6002 or the backup NIO node 6004 on which the service has started. In step 7106, the respective master NIO node 6002 or the backup NIO node 6004 resends the current node state to its services.

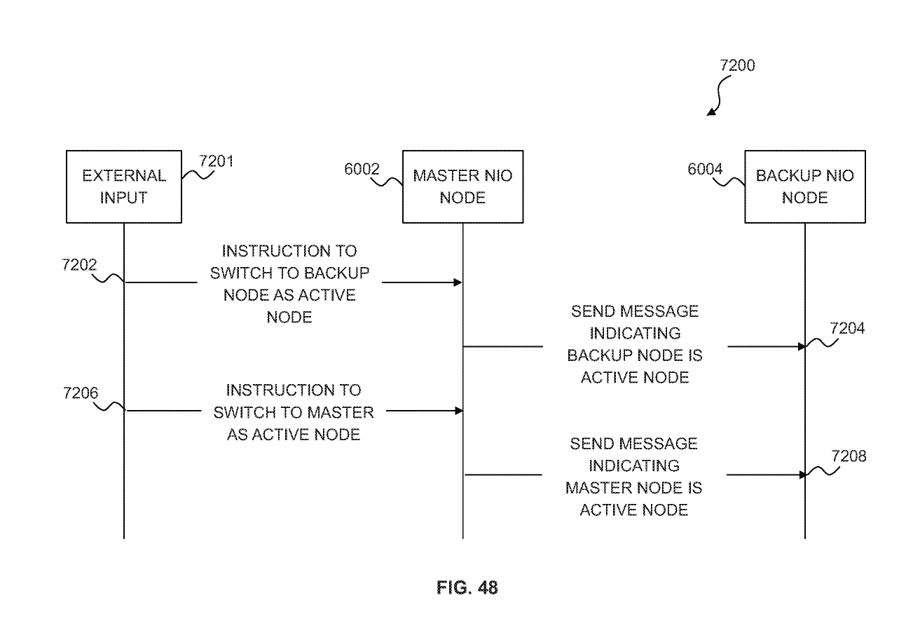

Referring to FIG. 48, in another embodiment, a sequence diagram illustrates a process 7200 by which the master NIO node 6002 and the backup NIO node 6004 of FIG. 43B may switch between active and passive states without a supervisor node. There are multiple methods by which switching between the master NIO node 6002 and the backup NIO node 6004 can occur. As shown in FIG. 48, one method is that the active node can be designated via an external input 7201 to the master NIO node 6002 (e.g., through the master NIO node's REST API). This is useful, for example, when updating the master NIO node 6002 and the backup NIO node 6004 because the passive node can be updated, and then the nodes can be switched to allow the other node to be updated.

In some embodiments, the instruction may always be sent to the master NIO node 6002 (as in the present example) or the backup NIO node 6004, regardless of the node's active or passive state. In other embodiments, the instruction may always be sent to the active node or the passive node, regardless of which of the master NIO node 6002 or the backup NIO node 6004 is currently in that state. In still other embodiments, the instruction may be sent directly to both the master NIO node 6002 and the backup NIO node 6004, in which case signaling between the master NIO node 6002 and the backup NIO node 6004 may not occur or may be ignored.

Accordingly, in step 7202, the master NIO node 6002 receives an external input instruction to switch to the backup NIO node 6004 as the active node. In step 7204, the master NIO node 6002 sends a message to the backup NIO node 6004 designating the master NIO node 6002 as the passive node and the backup NIO node 6004 as the active node. As described previously, this may be accomplished by publishing a message to a channel (e.g., the NODE CONTROL channel) to which the subscription blocks 6110 are subscribed. However, it is understood that this may be any type of message and may be sent in various ways using different communication channels and/or protocols. In step 7206, the master NIO node 6002 receives an external input instruction to switch to the master NIO node 6002 as the active node. In steps 7208, the master NIO node 6002 sends a message to the backup NIO node 6004 designating the master NIO node 6002 as the active node and the backup NIO node 6004 as the passive node.

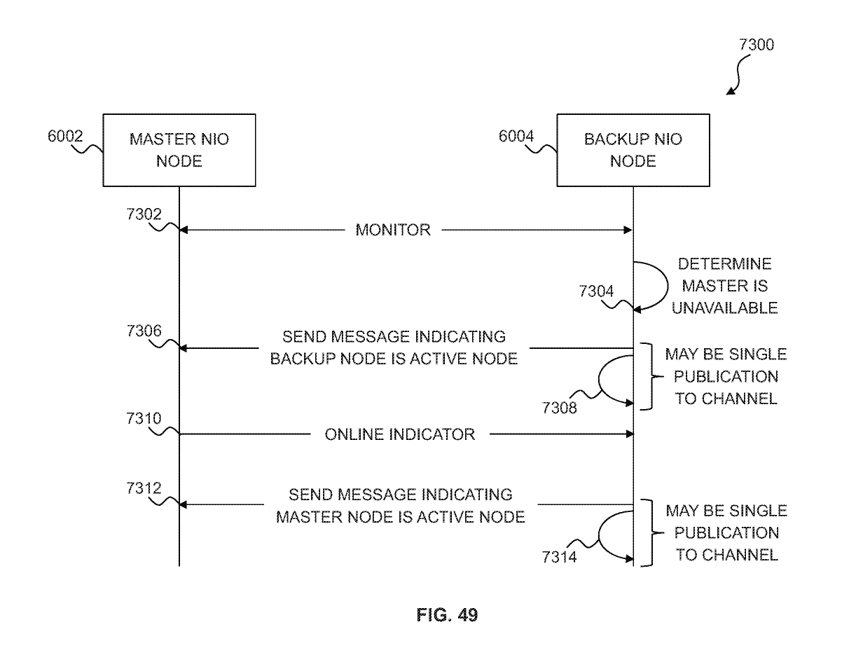

Referring to FIG. 49, in another embodiment, a sequence diagram illustrates a process 6900 by which the master NIO node 6002 and the backup NIO node 6004 of FIG. 43B may switch between active and passive states without a supervisor node. As shown in FIG. 49, the passive node (e.g., the backup NIO node 6004) may monitor the active node (the master NIO node 6002) and the active node may not perform any monitoring. Alternatively, both the active and passive nodes may monitor each other. When the passive node determines that the active node is unavailable, the passive node switches to the active state.

Accordingly, in step 7302, the backup NIO node 6004 monitors the master NIO node 6002. For example, the backup NIO node 6004 may monitor a channel for a heartbeat of the master NIO node 6002 or may use another method to determine if the master NIO node 6002 is responsive. In step 7304, the backup NIO node 6004 determines that the master NIO node 6002 is unavailable as previously described (e.g., the heartbeat has stopped).

In steps 7306 and 7308 (which may represent a single step), the backup NIO node 6004 sends a message to the master NIO node 6002 and itself (e.g., via the NODE CONTROL channel) designating the master NIO node 6002 as the passive node and the backup NIO node 6004 as the active node. It is understood that the message may be published to the channel and the master NIO node 6002 may not receive the message if the master NIO node is offline or otherwise unavailable.

In step 7310, the backup NIO node 6004 receives an indicator that the master NIO node 6002 is available. For example, the master NIO node 6002 may publish to a management channel or reestablish the heartbeat. In some embodiments, the backup NIO node 6004 may remain the active node even after the master NIO node 6002 becomes available again. In such embodiments, the master NIO node 6002 may not become the active node until the backup NIO node 6004 becomes unavailable or another event occurs that makes the master NIO node 6002 the active node again. The process 7300 would then begin again with step 7302 being repeated with the master NIO node 6002 monitoring the backup NIO node 6004.

In the present embodiment, however, the master NIO node 6002 is intended to be the active node whenever the master NIO node 6002 is available. Accordingly, in steps 7312 and 7314 (which may represent a single step), the backup NIO node 6004 sends a message designating the master NIO node 6002 as the active node and the backup NIO node 6004 as the passive node. This may occur upon receipt of the message of step 7310 or may occur after a certain amount of time has passed to ensure that the master NIO node 6002 is stable.

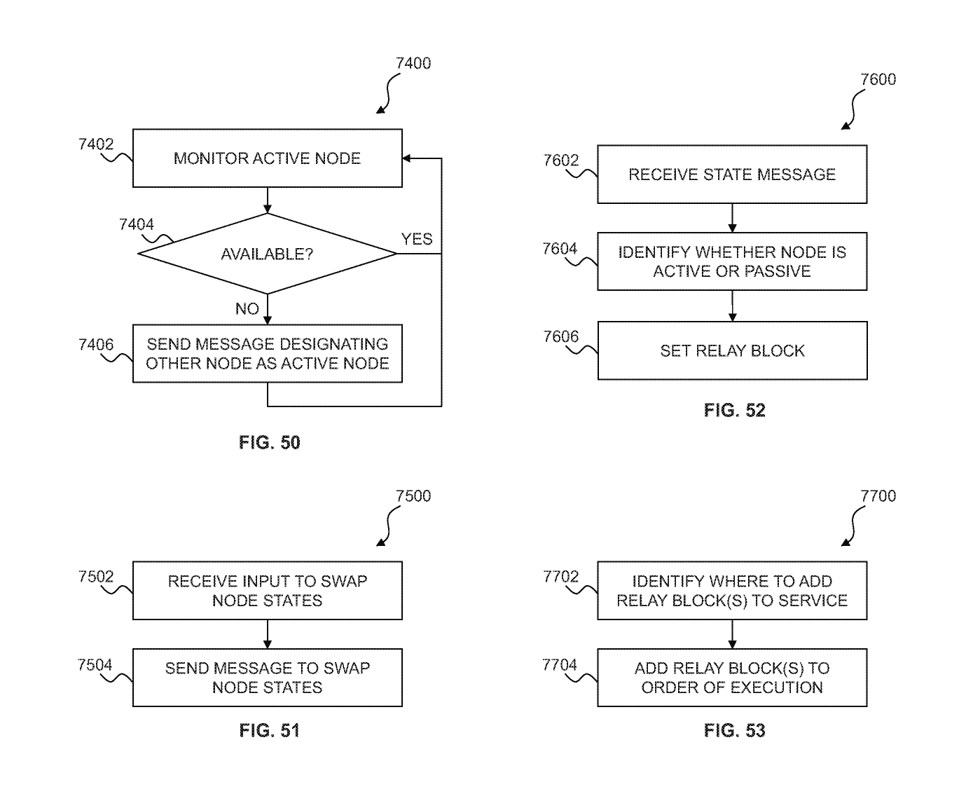

Referring to FIG. 50, a method 7400 illustrates one embodiment of a process that may be executed within the environments of FIGS. 36 and 43B. For example, the method 7400 may be executed by the supervisor node 6006 of FIG. 36 and by the master NIO node 6002 and/or the backup NIO node 6004 of FIG. 43B. In step 7402, the active node is monitored to determine its availability as previously described. In step 7404, a determination is made as to whether the active node is available. If the active node is available, the method 7400 returns to step 7402 and continues monitoring. If the active node is not available, the method 7400 continues to step 7406. In step 7406, a message is sent to designate the passive node as the active node. The method 7400 then returns to step 7402.

Referring to FIG. 51, a method 7500 illustrates one embodiment of a process that may be executed within the environments of FIGS. 36 and 43B. For example, the method 7500 may be executed by the supervisor node 6006 of FIG. 36 and by the master NIO node 6002 and/or the backup NIO node 6004 of FIG. 43B. In step 7502, input is received to switch the node states (e.g., to designate the current passive node as the active node and the current active node as the passive node). In step 7504, a message is sent to swap the node states.

Referring to FIG. 52, a method 7600 illustrates one embodiment of a process that may be executed within the environments of FIGS. 36 and 43B. For example, the method 7600 may be executed by the master NIO node 6002 and the backup NIO node 6004. In step 7602, a state message is received. In step 7604, the message is examined to identify whether the node is to be active or passive. In step 7606, the relay block 6112 is set as identified in step 7604.

Referring to FIG. 53, a method 7700 illustrates one embodiment of a process that may be used to configure a service 6108 for use within the environments of FIGS. 36 and 43B. For example, the method 7600 may be used to configure a service for the master NIO node 6002 and the backup NIO node 6004. In step 7702, a desired location of a relay block 6112 within the service 6108 is identified. As described in previous embodiments, the relay block 6112 may be placed before or after other blocks within the service 6108, and the relay block's location determines the service's behavior when the node running the service 6108 is in the passive state. In step 7704, the relay block 6112 is added to the service's order of execution in the desired position. As the service 6108 is identical for the master NIO node 6002 and the backup NIO node 6004 (with the possible exception of configuration information that is unique for each node), the same location for the relay block 6112 is used for the service 6108 on both the master NIO node 6002 and the backup NIO node 6004.

While the preceding description shows and describes one or more embodiments, it will be understood by those skilled in the art that various changes in form and detail may be made therein without departing from the spirit and scope of the present disclosure. For example, various steps illustrated within a particular flow chart may be combined or further divided. In addition, steps described in one diagram or flow chart may be incorporated into another diagram or flow chart. Furthermore, the described functionality may be provided by hardware and/or software, and may be distributed or combined into a single platform. Additionally, functionality described in a particular example may be achieved in a manner different than that illustrated, but is still encompassed within the present disclosure. Therefore, the claims should be interpreted in a broad manner, consistent with the present disclosure.

For example, in one embodiment, a system for providing redundancy using configurable platforms that perform real time processing includes a first configurable platform and a second configurable platform, each of the first and second configurable platforms having a core that is configured to interact with an operating system of a device on which the respective configurable platform is running, wherein the core of the first configurable platform is configured to run a first service that controls a first plurality of blocks that are organized into an order of execution by the first service for the first configurable platform and the core of the second configurable platform is configured to run a second service that controls a second plurality of blocks that are organized into the order of execution by the second service for the second configurable platform, wherein the first and second services are identical; and a plurality of instructions for receiving, by the first and second configurable platforms, information designating one of the first and second configurable platforms as an active node and the other of the first and second configurable platforms as a passive node; receiving, by the first and second services, identical data from a data source; processing, by at least one of the first and second services, the identical data in real time; and publishing, by only one of the first and second services, a result of the processing, wherein the result is published only by the first service if the first configurable platform is designated as the active node and is published only by the second service if the second configurable platform is designated as the active node.

In some embodiments, the first and second plurality of blocks each include a relay block having a first state that allows the blocks following the relay block in the order of execution to receive information based on the identical data and a second state that does not allow the blocks following the relay block in the order of execution to receive the information.

In some embodiments, the relay block is in the first state if the first or second service to which the relay block corresponds is running on the active node, and is in the second state if the first or second service to which the relay block corresponds is running on the passive node.

In some embodiments, the relay block is positioned as a first executed block in the order of execution.

In some embodiments, the relay block is positioned after any blocks in the order of execution that perform the processing and before any blocks that publish the result.

In some embodiments, each of the first and second plurality of blocks includes a plurality of relay blocks.

In some embodiments, the system further includes a supervisor node, wherein a message designating one of the first and second configurable platforms as the active node and the other of the first and second configurable platforms as the passive node is received from the supervisor node.

In some embodiments, the supervisor node is configured to resend the message if the first or second service is detected as being started after the message is initially sent.

In some embodiments, the supervisor node is configured to monitor the first and second configurable platforms and to swap the designation of active node and passive node if the first or second configurable platform that is currently the active node fails to meet at least one defined monitoring criterion.

In some embodiments, the result is discarded by whichever of the first and second services is running on the passive node.

In some embodiments, the first configurable platform is running on a first device and the second configurable platform is running on a second device.

In some embodiments, the first configurable platform is running on a first device and the second configurable platform is running on the first device.

In another embodiment, a method for providing redundancy using configurable platforms that perform real time processing includes providing a first configurable platform and a second configurable platform, each of the first and second configurable platforms having a core that is configured to interact with an operating system of a device on which the respective configurable platform is running, wherein the core of the first configurable platform is configured to run a first service that controls a first plurality of blocks that are organized into an order of execution by the first service for the first configurable platform and the core of the second configurable platform is configured to run a second service that controls a second plurality of blocks that are organized into the order of execution by the second service for the second configurable platform, wherein the first and second services are identical; receiving, by the first and second configurable platforms, information designating one of the first and second configurable platforms as an active node and the other of the first and second configurable platforms as a passive node; receiving, by the first and second services, identical data from a data source; processing, by at least one of the first and second services, the identical data in real time; and publishing, by only one of the first and second services, a result of the processing, wherein the result is published only by the first service if the first configurable platform is designated as the active node and is published only by the second service if the second configurable platform is designated as the active node.

In some embodiments, providing the first and second configurable platforms includes providing, for each of the first and second plurality of blocks, a relay block having a first state that allows the blocks following the relay block in the order of execution to receive information based on the identical data and a second state that does not allow the blocks following the relay block in the order of execution to receive the information.

In some embodiments, the method further includes setting the relay block to the first state if the first or second service to which the relay block corresponds is running on the active node, and setting the relay block to the second state if the first or second service to which the relay block corresponds is running on the passive node.

In some embodiments, the method further includes positioning the relay block as a first executed block in the order of execution.

In some embodiments, the method further includes positioning the relay block after any blocks in the order of execution that perform the processing and before any blocks that publish the result.

In some embodiments, providing the relay block for each of the first and second plurality of blocks includes providing a plurality of relay blocks for each of the first and second plurality of blocks.

In some embodiments, the method further includes providing a supervisor node; and sending, by the supervisor node, a message to the first and second configurable platforms designating one of the first and second configurable platforms as the active node and the other of the first and second configurable platforms as the passive node.

In some embodiments, the method further includes resending, by the supervisor node, the message if the first or second service is detected as being started after the message is initially sent.

In some embodiments, the method further includes monitoring, by the supervisor node, the first and second configurable platforms using at least one monitoring criterion; and swapping, by the supervisor node, the designation of active node and passive node if the first or second configurable platform that is currently the active node fails to meet the monitoring criterion.

In some embodiments, the method further includes discarding, by whichever of the first and second services is running on the passive node, the result.

In another embodiment, a configurable platform for use in a system for real time processing includes a core that is configured to interact with an operating system of a device on which the configurable platform is running; at least a first service that is run by the core; and a plurality of blocks that are configured to be run by the first service using a defined order of execution of the blocks, wherein the plurality of blocks includes at least one relay block that can switch between a first state and a second state, wherein the first state allows the blocks following the relay block in the order of execution to receive information to be processed and the second state does not allow the blocks following the relay block in the order of execution to receive information to be processed.

In some embodiments, the configurable platform further includes a plurality of services including the first service, wherein each of the plurality of services can be configured with at least one corresponding relay block to modify a behavior of each of the plurality of services on a per service basis depending on whether the configurable platform is designated as an active node or as a passive node.

In some embodiments, the relay block is positioned as a first executed block in the order of execution.

In some embodiments, the relay block is positioned after any blocks in the order of execution that perform processing and before any blocks that publish a result for the first service.

In some embodiments, the configurable platform further includes instructions for execution by the configurable platform for receiving a message to set the relay block to the first state or the second state.

In some embodiments, the message is received from one of a supervisor node and a second configurable platform that is running a second service that is identical to the first service.

In some embodiments, the configurable platform further includes instructions for execution by the configurable platform for monitoring a second configurable platform that is running a second service that is identical to the first service, wherein the second configurable platform is designated as an active node and the configurable platform is designated as a passive node, and wherein the monitoring uses at least one monitoring criterion; determining that the second configurable platform fails to meet the monitoring criterion; sending a message to designate the second configurable platform as the passive node and the configurable platform as the active node; and setting the relay block to the first state.

In some embodiments, the configurable platform further includes instructions for determining that the second configurable platform now satisfies the monitoring criterion; sending a second message to designate the second configurable platform as the active node and the configurable platform as the passive node; and setting the relay block to the second state.

In another embodiment, a method for controlling the execution of blocks in a configurable platform includes providing a configurable platform having a core that is configured to interact with an operating system of a device on which the configurable platform is running, at least a first service that is run by the core, and a plurality of blocks that are configured to be run by the first service using a defined order of execution of the blocks, wherein the plurality of blocks includes at least one relay block that can switch between a first state and a second state; setting, by the configurable platform, the relay block to the first state if a first event occurs, wherein the first state allows the blocks following the relay block in the order of execution to receive information to be processed; and setting, by the configurable platform, the relay block to the second state if a second event occurs, wherein the second state does not allow the blocks following the relay block in the order of execution to receive information to be processed.

In some embodiments, the method includes positioning the relay block as a first executed block in the order of execution.

In some embodiments, the method includes positioning the relay block after any blocks in the order of execution that perform processing and before any blocks that publish a result for the first service.

In some embodiments, the method includes receiving a message to set the relay block to the first state or the second state.

In some embodiments, the message is received from one of a supervisor node and a second configurable platform that is running a second service that is identical to the first service.

In some embodiments, the method includes monitoring a second configurable platform that is running a second service that is identical to the first service, wherein the second configurable platform is designated as an active node and the configurable platform is designated as a passive node, and wherein the monitoring uses at least one monitoring criterion; determining that the second configurable platform fails to meet the monitoring criterion; sending a message to designate the second configurable platform as the passive node and the configurable platform as the active node; and setting the relay block to the first state.

In some embodiments, the method includes determining that the second configurable platform now satisfies the monitoring criterion; sending a second message to designate the second configurable platform as the active node and the configurable platform as the passive node; and setting the relay block to the second state.

In some embodiments, the first event designates the configurable platform as one of a passive node and an active node, and the second event designates the configurable platform as the passive node or the active node that is opposite that designated by the first event.

In another embodiment, a device includes a processor; a memory coupled to the processor; and a plurality of instructions for execution by the processor for a core that is configured to interact with an operating system of a device on which the configurable platform is running; at least a first service that is run by the core; and a plurality of blocks that are configured to be run by the first service using a defined order of execution of the blocks, wherein the plurality of blocks includes at least one relay block that can switch between a first state and a second state, wherein the first state allows the blocks following the relay block in the order of execution to receive information to be processed and the second state does not allow the blocks following the relay block in the order of execution to receive information to be processed.

In another embodiment, a device includes a processor; a memory coupled to the processor; and a plurality of instructions for execution by the processor for a configurable platform having a core that is configured to interact with an operating system of a device on which the configurable platform is running, at least a first service that is run by the core, and a plurality of blocks that are configured to be run by the first service using a defined order of execution of the blocks, wherein the plurality of blocks includes at least one relay block that can switch between a first state and a second state; setting, by the configurable platform, the relay block to the first state if a first event occurs, wherein the first state allows the blocks following the relay block in the order of execution to receive information to be processed; and setting, by the configurable platform, the relay block to the second state if a second event occurs, wherein the second state does not allow the blocks following the relay block in the order of execution to receive information to be processed.

What is claimed is:

1. A system for providing redundancy using configurable platforms that perform real time processing, the system comprising:
a first configurable platform and a second configurable platform, each of the first and second configurable platforms having a core that is configured to interact with an operating system of a device on which the respective configurable platform is running, wherein the core of the first configurable platform is configured to run a first service that controls a first plurality of blocks that are organized into an order of execution by the first service for the first configurable platform and the core of the second configurable platform is configured to run a second service that controls a second plurality of blocks that are organized into the order of execution by the second service for the second configurable platform, wherein the first and second services are identical; and
a plurality of instructions for
receiving, by the first and second configurable platforms, information designating one of the first and second configurable platforms as an active node and the other of the first and second configurable platforms as a passive node;
receiving, by the first and second services, identical data from a data source;
processing, by at least one of the first and second services, the identical data in real time; and
publishing, by only one of the first and second services, a result of the processing, wherein the result is published only by the first service if the first configurable platform is designated as the active node and is published only by the second service if the second configurable platform is designated as the active node,
wherein the first and second plurality of blocks each include a relay block having a first state that allows the blocks following the relay block in the order of execution to receive information based on the identical data and a second state that does not allow the blocks following the relay block in the order of execution to receive the information, wherein the relay block is in the first state if the first or second service to which the relay block corresponds is running on the active node and is in the second state if the first or second service to which the relay block corresponds is running on the passive node.

2. The system of claim 1 wherein the relay block is positioned as a first executed block in the order of execution.

3. The system of claim 1 wherein the relay block is positioned after any blocks in the order of execution that perform the processing and before any blocks that publish the result.

4. The system of claim 1 wherein each of the first and second plurality of blocks includes a plurality of relay blocks.

5. The system of claim 1 further comprising a supervisor node, wherein a message designating one of the first and second configurable platforms as the active node and the other of the first and second configurable platforms as the passive node is received from the supervisor node.

6. The system of claim 5 wherein the supervisor node is configured to resend the message if the first or second service is detected as being started after the message is initially sent.

7. The system of claim 5 wherein the supervisor node is configured to monitor the first and second configurable platforms and to swap the designation of active node and passive node if the first or second configurable platform that is currently the active node fails to meet at least one defined monitoring criterion.

8. The system of claim 1 wherein the result is discarded by whichever of the first and second services is running on the passive node.

9. The system of claim 1 wherein the first configurable platform is running on a first device and the second configurable platform is running on a second device.

10. The system of claim 1 wherein the first configurable platform is running on a first device and the second configurable platform is running on the first device.

11. A method for providing redundancy using configurable platforms that perform real time processing, the method comprising:
providing a first configurable platform and a second configurable platform, each of the first and second configurable platforms having a core that is configured to interact with an operating system of a device on which the respective configurable platform is running, wherein the core of the first configurable platform is configured to run a first service that controls a first plurality of blocks that are organized into an order of execution by the first service for the first configurable platform and the core of the second configurable platform is configured to run a second service that controls a second plurality of blocks that are organized into the order of execution by the second service for the second configurable platform, wherein the first and second services are identical;
receiving, by the first and second configurable platforms, information designating one of the first and second configurable platforms as an active node and the other of the first and second configurable platforms as a passive node;
receiving, by the first and second services, identical data from a data source; processing, by at least one of the first and second services, the identical data in real time; and
publishing, by only one of the first and second services, a result of the processing, wherein the result is published only by the first service if the first configurable platform is designated as the active node and is published only by the second service if the second configurable platform is designated as the active node.

12. The method of claim 11 wherein providing the first and second configurable platforms includes providing, for each of the first and second plurality of blocks, a relay block having a first state that allows the blocks following the relay block in the order of execution to receive information based on the identical data and a second state that does not allow the blocks following the relay block in the order of execution to receive the information; and further includes
setting the relay block to the first state if the first or second service to which the relay block corresponds is running on the active node, and setting the relay block to the second state if the first or second service to which the relay block corresponds is running on the passive node.

13. The method of claim 11 further including positioning the relay block as a first executed block in the order of execution.

14. The method of claim 11 further including positioning the relay block after any blocks in the order of execution that perform the processing and before any blocks that publish the result.

15. A device comprising:
a processor;
a memory coupled to the processor; and
a plurality of instructions for execution by the processor for a configurable platform having a core that is configured to interact with an operating system of the device, the configurable platform including
at least a first service that is run by the core; and
a plurality of blocks that are configured to be run by the first service using a defined order of execution of the blocks, wherein the plurality of blocks includes at least one relay block that can switch between a first state and a second state, wherein the first state allows the blocks following the relay block in the order of execution to receive information to be processed and the second state does not allow the blocks following the relay block in the order of execution to receive information to be processed.

16. The device of claim 15 wherein the configurable platform further includes a plurality of services including the first service, wherein each of the plurality of services can be configured with at least one corresponding relay block to modify a behavior of each of the plurality of services on a per service basis depending on whether the configurable platform is designated as an active node or as a passive node.

17. The device of claim 15 wherein the relay block is positioned as a first executed block in the order of execution.

18. The device of claim 15 wherein the relay block is positioned after any blocks in the order of execution that perform processing and before any blocks that publish a result for the first service.

19. The device of claim 15 wherein the configurable platform further includes instructions for execution by the configurable platform for receiving a message to set the relay block to the first state or the second state, wherein the message is received from one of a supervisor node and a second configurable platform that is running a second service that is identical to the first service.

20. The device of claim 15 wherein the configurable platform further includes instructions for execution by the configurable platform for:
monitoring a second configurable platform that is running a second service that is identical to the first service, wherein the second configurable platform is designated as an active node and the configurable platform is designated as a passive node, and wherein the monitoring uses at least one monitoring criterion;
determining that the second configurable platform fails to meet the monitoring criterion;
sending a message to designate the second configurable platform as the passive node and the configurable platform as the active node; and
setting the relay block to the first state.
